(19) United States
(12) Patent Application Publication
(10) Pub. No.: US 2005/0212626 A1
(43) Pub. Date: Sep. 29, 2005

(54) High frequency reaction processing system

(76) Inventor: Toshiyuki Takamatsu, Yachiyo-shi (JP)

Correspondence Address: Mitchell P Brook;Luce Forward Hamilton & Scipps, 11988 El Camino Real, Suite 200, San Diego, CA, 92130, US

(21) Appl. No.: 10/513,427

(22) PCT Filed: May 6, 2003
(86) PCT No.: PCT/JP03/05662

§ 371 Date: Nov. 2, 2004

(30) Foreign Application Priority Data
May 7, 2002 (JP) 2002-167850

(51) Int. Cl. H01P 1/20; H01P 3/12; H05B 6/64

(52) U.S. Cl. 333/212; 219/756

(57) ABSTRACT

A high frequency reaction processing system comprising an outer container (40) made of a dielictric material and having two end faces, which can close the inner cavity, one or more high frequency wave coupling portion (42) disposed at arbitrary position on the outer surface of the outer container (40), one or more inner container (41) made of a dielectric material and having two end faces, which can closeg the inner cavity, disposed at a position for receiving a high frequency wave guided through the high frequency wave coupling portion (42) without touching the inner side face of the outer container (40), and a covering portion (43) made of a conductive material, for covering the outer surface of the outer container except for the area occupied with the high frequency wave coupling portion (42) and sustaining the potential at a level equal to the ground potential of a waveguide line.

### FIELD OF THE INVENTION

This invention relates to a high frequency reaction processing system for efficiently guiding high power and high frequency wave into a load with large capacity without generating many reflected waves in a processing region, and reaction processing of an object by high frequency wave.

### BACKGROUND ART

In prior arts of high frequency reaction processing systems, an end face of a high frequency wave termination load forms an end face of a cavity-resonance waveguide. A section of the load perpendicular to the load functions as an end of a high frequency wave.

For example, in an apparatus stated in Japanese Non-examined Publication 8-236298, a disk-shaped member transmissive for a high frequency wave is located in a cylindrical container made of conductive material on the waveguide-side of a plane perpendicular to the axis of the tube at the position approximately n/2 times of a wavelength of a guided high frequency wave away from the waveguide-side end face of the cylindrical container to the axis of the container. An region on one side of the high frequency wave transmissive member opposite to the waveguide is vacuumed for reaction processing, microwaves that guided into the region generate high frequency wave plasma gas discharge (shown in FIG. 1). Resonance technology of cylindrical cavity in the field of high frequency resonance circuits is applied to this apparatus. It enables to generate high-dense plasma by increasing the energy efficiently.

Some of prior high frequency reaction processing systems generate electric fields with large area under dielectric transmission surfaces by guiding high frequency waves from waveguides into dielectric transmission surfaces and widely transmitting the waves in all the dielectric transmission surfaces. Thus, they increase areas projected plasma generating regions.

For example, in an apparatus stated in Japanese Non-examined Patent Publication 62-5600 or 62-99481, a microwave is guided through a dielectric transmission surface and a transmissive window into a vacuumed cylindrical container in a waveguide for reaction processing and forms a vacuumed region for reaction processing. Plasma gas is generated in the vacuumed cylindrical container for reaction processing. The dielectric transmission surface is located parallel to and on the end face, which is plate-shaped and perpendicular to the axis of the container (shown in FIG. 2). The transmissive windows are located under the dielectric transmission surface with mutually faced with an appropriate distance and perpendicular to the axis of the container. In the apparatus, high frequency wave spreads in the dielectric transmission surface. The high frequency waves form electric fields which leak toward the downside of the dielectric transmission surface. They are transmitted into the cylindrical container for reaction processing through the transmissive window. Thus plasma gas is generated uniformly along the radial direction of the container with large area.

Some prior high frequency reaction processing systems are high-powered by connecting loads to microwave 3D circuits with plural oscillators, because a power of a magnetron oscillator is limited for a microwave band.

For example, there is a technology to supply much electric power to a load in using microwave, that some high frequency oscillators and a 3D circuit waveguide are connected to a load. It is possible to supply much electric power in a single waveguide of an apparatus but impractical in use because a high power magnetron or a special power supply necessary for the apparatus is hardly available in market. The technology is generally used as an effective method in the field of microwave driers and so on. (“Industrial Microwave Application Technology” authored by Chokichiro Shibata, published by Denki Shoin in 1993)

In other prior high frequency reaction processing systems, impedance matching technologies on supplying power from high frequency oscillators to loads and technologies against high frequency waves reflected on loads are generally adopted. Such apparatuses comprise isolators and impedance matching devices in waveguides in order to absorb waves reflected on coupling portions or loads to the oscillator side of the waveguides and prevent reflected waves from reaching the high frequency oscillators.

For example, some apparatuses, which comprise isolators and impedance matching devices in waveguides in order to absorb waves reflected on coupling portions or loads to the oscillator-side of the waveguides and prevent the reflected waves from reaching the oscillators, are introduced as impedance matching technologies on supplying power from high frequency oscillators to loads and technologies against high frequency waves reflected on loads. (shown in FIG. 3 “Industrial Microwave Application Technology” authored by Chokichiro Shibata, published by Denki Shoin in 1993) Such a structure is applied to most microwave reaction processing systems as a standard of a waveguide high frequency 3D circuit.

In other prior high frequency reaction processing systems, there is a high frequency plasma apparatus absorbing waves with all phases from a high frequency oscillator in a plasma load. The apparatus protects the oscillator from high frequency waves reflected on the load. An isolator and an impedance matching device are removed to simplify a high frequency 3D circuit, reduce costs and produce a waveguide without energy loss. The apparatus uses ionized gas plasma with dielectric character as variable impedance.

For example, the applicant of this application disclosed a processing apparatus, in which the plasma load can absorb electromagnetic wave with all phases generated by a high frequency oscillator in Japan application number 2000-559714 (international application number PCT/JP 99/03650). The apparatus protects the oscillator from high frequency waves reflected on a load. An isolator and an impedance matching device are removed to simplify a high frequency 3D circuit. Cost is reduced and a waveguide without energy loss is produced. The apparatus uses ionized gas plasma with dielectric character as variable impedance. The apparatus is applicable to a situation with sharp changes of the load impedance such as a start of plasma discharge. The high frequency waveguide is able to be shortened as short as possible. Stable plasma discharge can be caused with the art.

In other prior high frequency reaction processing systems, there are apparatuses using multimode cavity resonators such as a microwave oven (shown in FIG. 4).

Such an apparatus spreads electromagnetic wave with a wave reflected stirrer fan or rotates an object on a turntable to heat it uniformly.

In other prior high frequency reaction processing systems, there are microwave heating apparatuses with single-mode resonators, which are often used to sinter ceramics (shown in FIG. 5).

In heating an object with low dielectric loss, it is difficult to heat with the apparatus with a multimode resonator though the electric field in the cavity is comparatively uniform because the input energy is dispersed into each mode. The apparatus shown in FIG. 5 is used with an object on the maximum point of the electric field to concentrate input energy for a treatment. It is often used in sintering at high temperatures.

In other prior high frequency reaction processing systems, there is an apparatus which guides high frequency waves from a waveguide to a dielectric transmission surface, widely travels high frequency waves in the dielectric transmission surface and forms a electric field with large area under the dielectric transmission surface to treat an object uniformly after treating it on a heating plate.

For example, an apparatus stated in Japanese Non-examined Patent Publication 2000-150135 irradiates microwaves to its dielectric member and forms surface waves to heat an object with a heating plate (shown in FIG. 6). It enables to uniformly heat the object with large area.

In other prior high frequency reaction processing systems, there is a liquid heating apparatus which is compact and produced with low cost and prevents generation of standing waves and efficiently supplies energy to a load.

For example, an apparatus disclosed in Japanese Non-examined Patent Publication 10-333329 has an unreflective-termination-shaped block on or close to a liquid heating portion in a region opposite to the direction in which microwaves travel (shown in FIG. 7). In the apparatus, waves that reflected on the load don't reach a high frequency oscillator, and isolators or the impedance matching devices are removed to simplify the waveguide high frequency 3D circuit, reduce costs and efficiently heat liquid without reflection.

### DISCLOSURE OF THE INVENTION

It is an object of the present invention to provide a high frequency reaction processing system, which is produced at low cost and enables to efficiently generate uniform plasma with much supplied power as an essential system to generate large plasma.

The object of the present invention in detail is to produce a system without anti-reflection devices such as an isolator and a matching device in a waveguide 3D circuit by preventing reflection on the high frequency wave coupling portion with using high frequency waves like microwaves and equaling a load following the high frequency wave coupling portion to a non-reflective termination circuit.

A prior art shown in FIG. 8 adopts a impedance matching method to supply power to a variable impedance load as well as an electric discharge apparatus of ionized gas plasma and other standard methods against reflection of waves. FIG. 8 shows a progressive microwave and a reflected wave, and functions of an isolator and an impedance matching device. FIG. 9 shows a structure as a lumped constant equivalent circuit. FIG. 10 shows an equivalent circuit without an isolator that a boundary plane of plasma is regarded as a termination plane of high frequency wave in FIG. 9. FIG. 11 shows an equivalent circuit in the case plasma isn't generated.

In a plasma load portion, a voltage high enough to discharge ionized gas at the termination of the circuit at the first stage is needed to generate plasma from a non-plasma state. It is better to use a series resonance circuit for high voltage in high frequency circuit. In the circuit of the present invention, however, it is concluded by the inventor that a resonance point must be detected by changing variable L or C in a circuit of a matching device in order to make the termination resonant in FIG. 11. Moreover, it shows that reflected waves return to an oscillator in matching period for resonance and that an isolator circuit is necessary.

Moreover, shown in FIG. 10, it is also concluded by the inventor that an automatic function matching circuit, which can always follow the change, is needed if an impedance shift occurs at a plasma load, which is a variable impedance though it was formed as an inverted L type impedance matching circuit just after it is generated.

Namely, an isolator and a matching device with auto-tuning function are needed to reliably use an apparatus with a prior structure in practice. In the case, a practical size of a microwave 3D circuit, a transmission surface, increases. There is a problem that costs sharply increase. It is a factor to refrain from using microwaves. An apparatus enlarges if electric power is supplied with plural oscillators in the prior art.

A state of progressive and reflected wave in the case that much power is supplied by guiding high frequency waves through two waveguides to a plasma load in an electric power supplying method with separated plural oscillators or a standard prior art against reflected wave such as impedance matching is adopted, and functions of portions of a microwave 3D circuit to a state of waves in a prior microwave electric discharge apparatus of ionized gas plasma are shown in FIG. 12. FIG. 13 shows a structure of the system of the present invention as a lumped constant equivalent circuit. FIG. 14 is a diagram that shows an equivalent circuit in the case that a boundary plane of plasma is regarded as a termination plane of a high frequency wave.

A matching device and a whole region of a plasma load 26, each is shared by separate two high frequency waveguides shown in FIG. 12. The circuits of the both sides are coupled and interfered with each other on impedance matching with each of matching devices as is shown in a circuit of FIG. 14. Thus, it is found by the inventor that shifts of generated plasma occur and that instability including non-uniformity of the electric field is increased as the result. In examining the art shown in FIG. 8, it is found by the inventor that a plasma load itself needs to be formed as a non-reflective termination structure, which enables to absorb waves with all phases traveling from the high frequency oscillator. Moreover, it is found by the inventor that the prior apparatus cannot form a plasma load with a shape, which suits the electric field large enough to generate a large volume of plasma at the high frequency wave coupling portion, and that the prior art cannot resolve the problem that reflected waves are generated at a high frequency wave coupling portion.

The high frequency reaction processing system of the present invention comprises an outer container made of dielectric material, formed so that two end faces can close a cavity and one or more inner containers made of dielectric material, formed so that two end faces can close a cavity and located without contacting the inner face of the outer container at a position to receive high frequency waves traveling through a high frequency wave coupling portion and one or more high frequency wave coupling portion located at optional position on the outer face of the outer container and a covering portion made of conductive material and covering the outer face of the outer container except the area covered with the high frequency wave coupling portion and kept a potential eaqual to the ground potential of a high frequency waveguide, and processes reaction in the cavity of the inner container.

As is described above, the outer container is made of dielectric material in the high frequency reaction processing system of the present invention. The inner container is made of dielectric material and located inside the outer container. The high frequency wave coupling portion is located on the outer face of the outer container. A conductive covering portion covers the outer surface of the outer plane except the area covered with the high frequency wave coupling portion and is kept a potential equal to the ground potential.

Thus, many intense points of the electric field are able to be generated in a reaction processing region inside the inner container, because a conductive material covers the outer surface of the outer plane except the area covered with the high frequency wave coupling portion and is kept an electric potential equal to the ground potential.

Moreover, the high frequency wave coupling portion is located on the cylindrical or spherical side face. The cylindrical or spherical dielectric container is formed as a looped transmission surface of the high frequency wave. Thus, the large area of the infinitely long dielectric transmission surface is formed to travel the electromagnetic wave into the direction of the infinitely long dielectric transmission surface through the waveguide of the high frequency waves.

Thus, the infinitely long dielectric transmission surface is able to be formed. It is able to prevent guided high frequency waves from interfering each other and to amplify resonance in the same transmission surface by tuning the positions of the high frequency wave coupling portions. Consequently, reflection constant of the whole system can be reduced with the condition of the resonance.

Moreover, much electric power is able to be supplied, since the method that electric power is supplied from plural high frequency wave coupling portions into the single load, is adopted to increase electric power for supply as much as possible.

Moreover, high frequency waves travel into the dielectric transmission surface through the waveguide. Thus, a uniform and large plane of the electric field is able to be generated in the reaction processing region in the inner container as dielectric transmission surface. The high frequency reaction processing system is able to uniformly supply much electric power.

Moreover, if the high frequency reaction processing system is a plasma generating system, an electron density of the ionized gas plasma in the inner container increases with the supplied electric power increasing and the character of a border plane of ionized gas plasma becomes close to the one of conductor. Then, the electromagnetic wave reflected in the region which is closed with looped infinitely long dielectric transmission surface and the border plane of the ionized gas plasma. Thus, the invention enables to increase the area, in which the electromagnetic wave travels and generate electric field over a large area.

It is necessary to bias a voltage high enough to separate ionized gas to the termination of the circuit in order to generate plasma from non-plasma state in the plasma load portion. As a result of adopting the structure stated above, a resonance circuit is formed. A high voltage is generated and it is becomes easy to trigger plasma generation on the side of the termination. Moreover, a stable circuit is able to be formed, since the high frequency wave coupling portion and dielectric transmission surface are formed as equivalent as a circuit-type matching device and the load circuit is separated away from the oscillating portion. Consequently, the structure of the circuit is durable against reflected waves returning to the oscillator and able to increase electric power supplied to the load.

### BRIEF DESCRIPTION OF THE DRAWING

FIG. 1 is a schematic sectional view of a discharge portion structure of a prior microwave discharge apparatus adding magnetic field resonated in the tube.

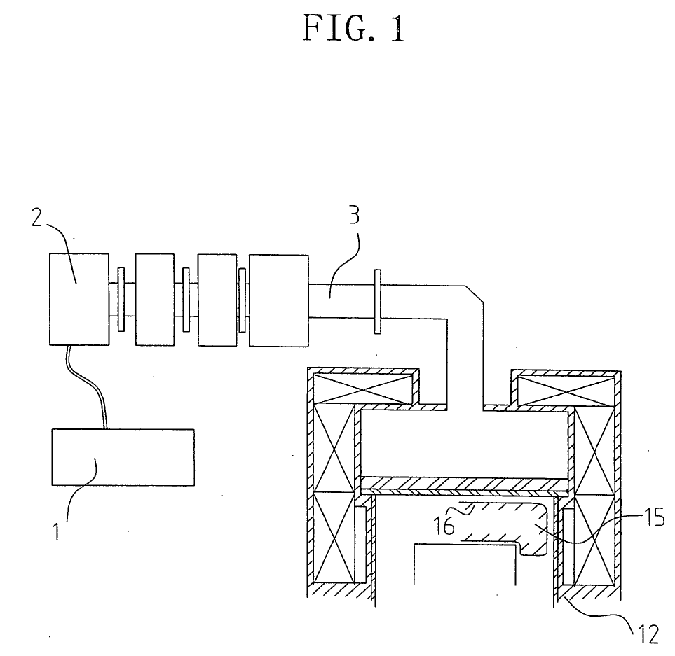

FIG. 2 is a schematic sectional view of a discharge portion structure of a prior microwave discharge apparatus transmitting surface wave on a finitely long dielectric transmission surface.

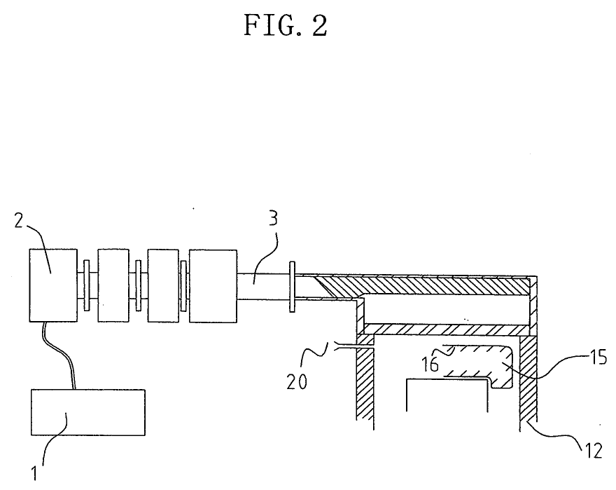

FIG. 3 is a schematic sectional view of a discharge portion structure of a prior microwave discharge apparatus with a tube applicator located traversing H plane.

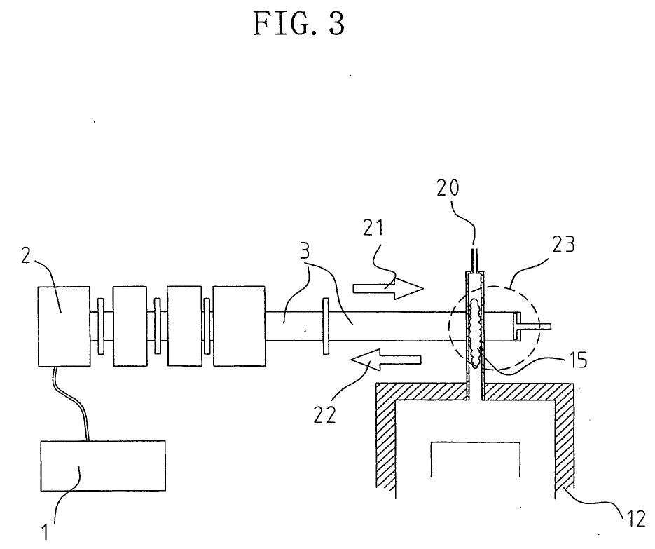

FIG. 4 is a schematic sectional view of a discharge portion structure of a prior microwave discharge apparatus with the multi-mode cavity resonating method.

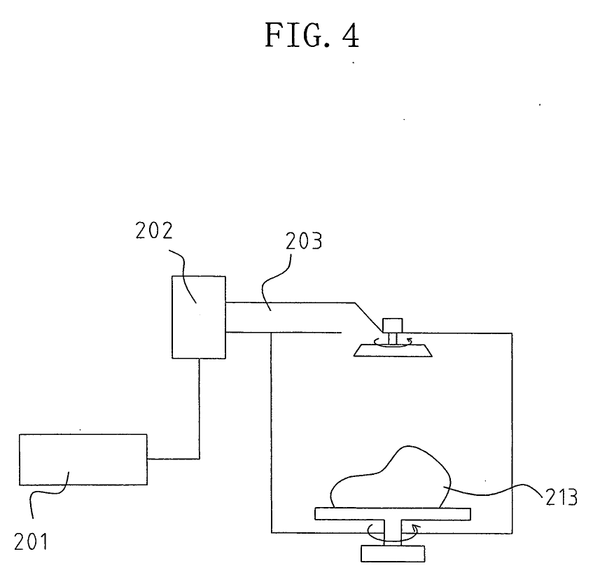

FIG. 5 is a schematic sectional view of a discharge portion structure of a prior microwave discharge apparatus with the single-mode cavity resonating method.

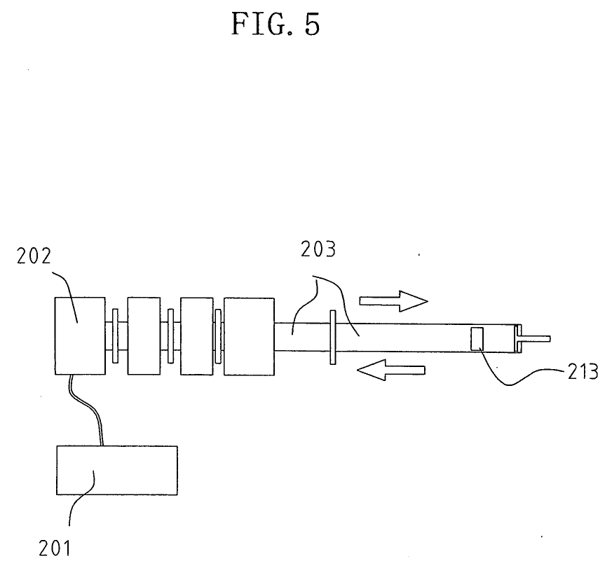

FIG. 6 is a schematic sectional view of a discharge portion structure of a prior microwave heating reaction apparatus transmitting surface waves on a finite dielectric transmission surface.

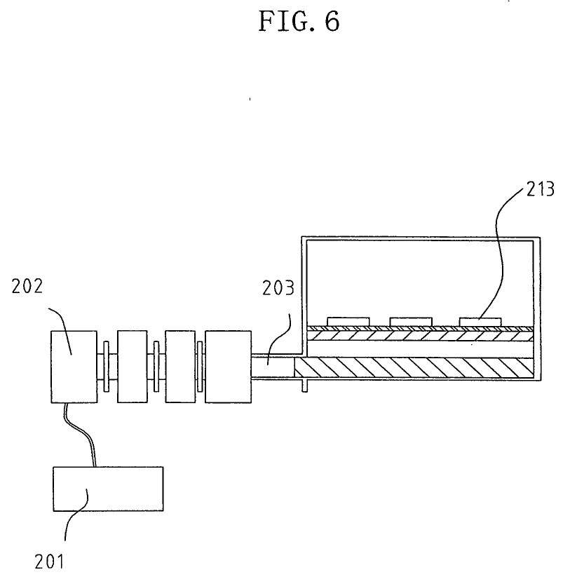

FIG. 7 is a schematic sectional view of a discharge portion structure of a prior non-reflection microwave liquid heating reaction apparatus.

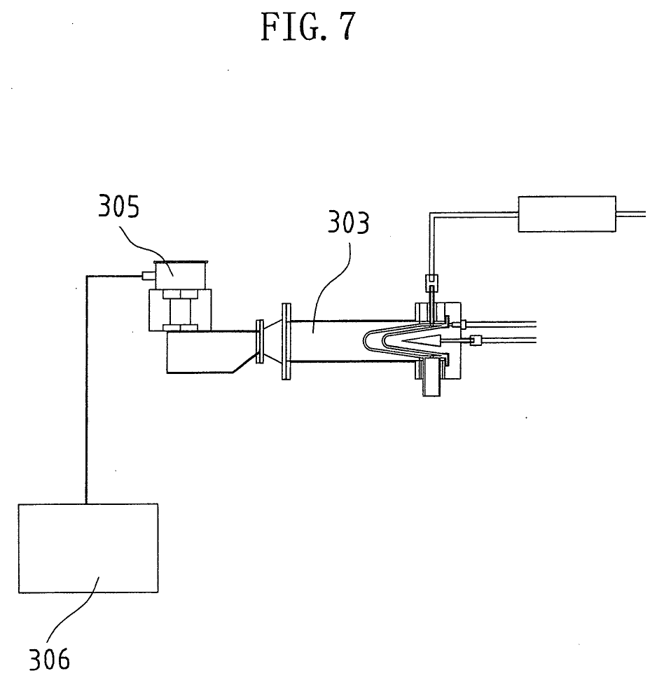

FIG. 8 is a diagram that shows a state of progressing and reflected microwave, functions of an isolator and an impedance matching device in a prior microwave discharge apparatus with a tube applicator located traversing H plane.

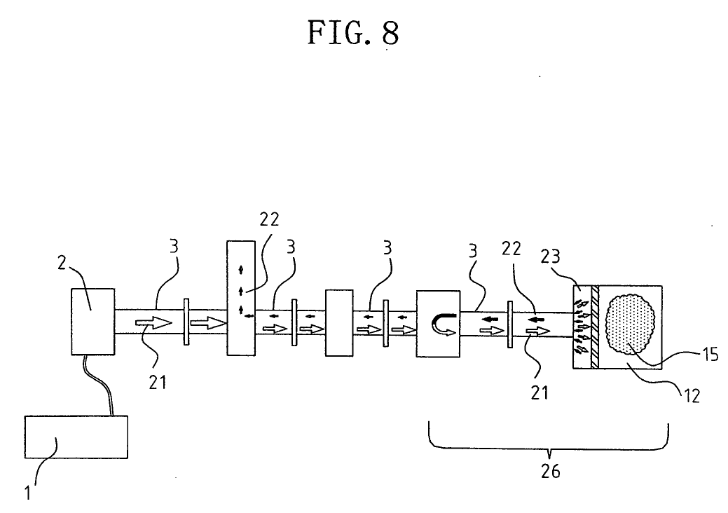

FIG. 9 is a diagram that shows a structure of a 3D circuit transmitting microwaves as a lumped constant equivalent circuit in a prior microwave discharge apparatus.

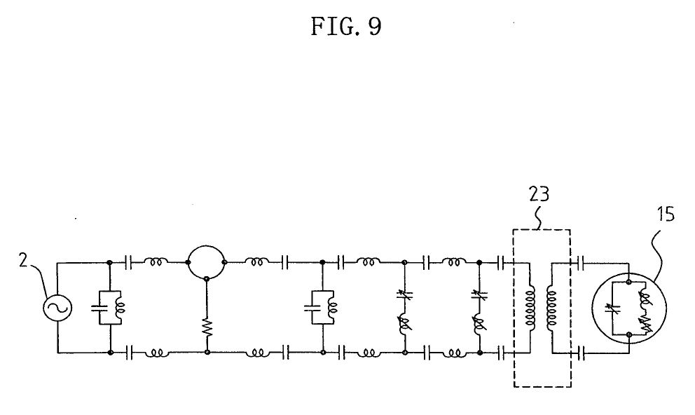

FIG. 10 is a diagram that shows a structure of a 3D circuit transmitting microwave in a prior microwave discharge apparatus as a lumped constant equivalent circuit in the case that a boundary plane of plasma is regarded as a termination plane of a high frequency wave and an isolator is removed.

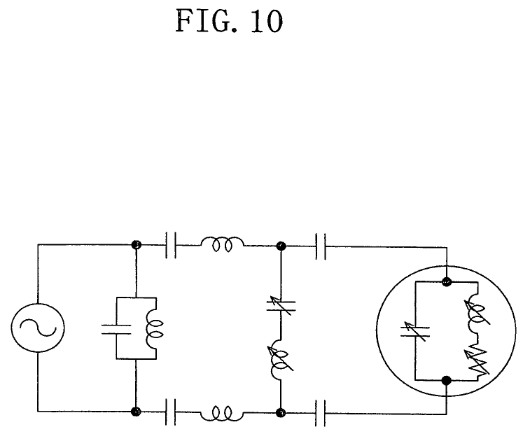

FIG. 11 is a diagram that shows a structure of a 3D circuit transmitting microwave in a prior microwave discharge apparatus as a lumped constant equivalent circuit in the case a plasma discharge is not generated and an isolator is removed.

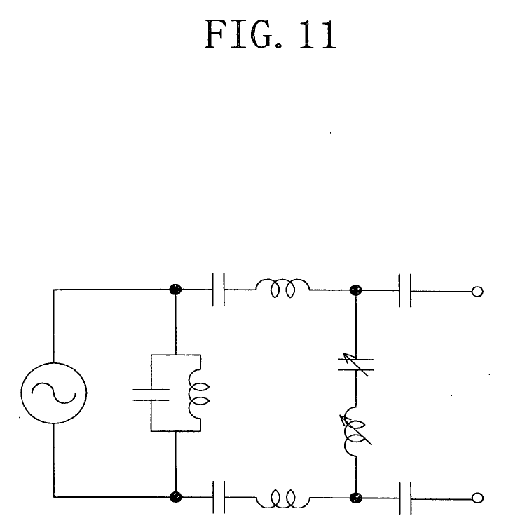

FIG. 12 is a diagram that shows a state of progressing and reflected microwave, functions of portions of a 3D circuit acting the microwave in the case that much power is supplied by guiding high frequency waves through two waveguides to a plasma load in an electric power supplying method with separated plural oscillators in a prior microwave electric discharge apparatus.

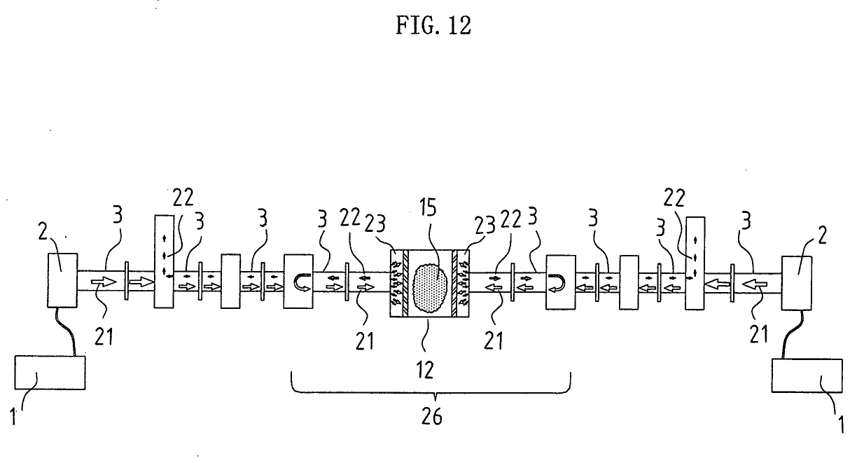

FIG. 13 is a diagram that shows a structure of a 3D circuit as a lumped constant equivalent circuit in the case that much power is supplied by guiding high frequency waves through two waveguides to a plasma load in a prior microwave discharge apparatus.

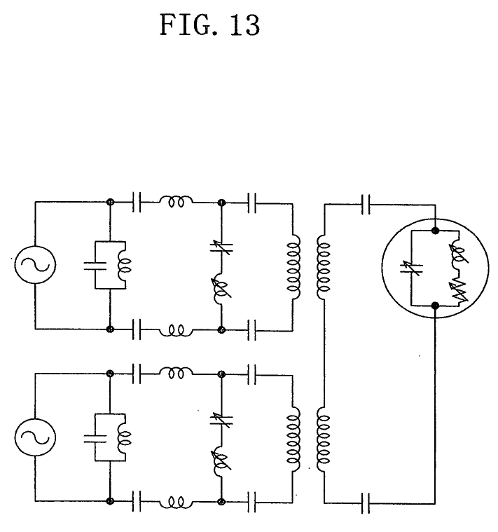

FIG. 14 is a diagram that shows a structure of a 3D circuit as a lumped constant equivalent circuit in the case that much power is supplied by guiding high frequency waves through two waveguides to a plasma load and a boundary plane of plasma is regarded as a termination plane of a high frequency wave in a prior microwave discharge apparatus.

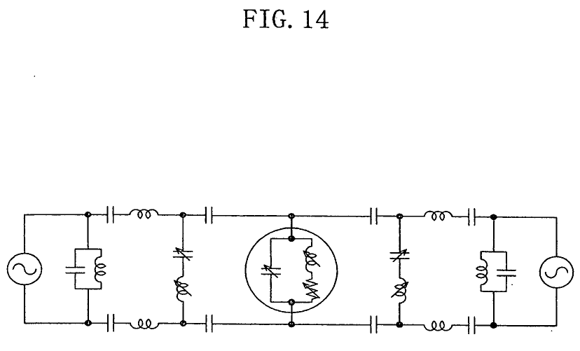

FIG. 15 is a diagram that shows an example of a 3D model with three axes which defines a structure of a microwave reaction processing system of the present invention.

FIG. 16 is a perspective diagram that shows an inside of a 3D model with three axes which defines a structure of a microwave reaction processing system of the present invention (shown in FIG. 15).

FIG. 17 is a schematic sectional view of a structure of a microwave reaction processing system of the present invention.

FIG. 18 is a diagram that shows a structure of a 3D circuit for transmitting microwaves as a lumped constant equivalent circuit in a structure of a system of the present invention.

FIG. 19 is a diagram that shows a structure of a 3D circuit as a lumped constant equivalent circuit in the case that a boundary plane of plasma is regarded as a termination plane of a high frequency wave in a structure of a system of the present invention.

FIG. 20 is a diagram that shows a structure of a microwave transmission 3D circuit as a lumped constant equivalent circuit in the case that much power is supplied by guiding high frequency waves through two waveguides to a plasma load in a system of the present invention.

FIG. 21 is a diagram that shows a structure of a 3D circuit as a lumped constant equivalent circuit in the case that much power is supplied by guiding high frequency waves through two waveguides to a same load and a conductive wall of a processing container is regarded as a termination plane of a high frequency wave in a system of the present invention.

FIG. 22 is a diagram that shows an example of a 3D model with three axes which defines a structure of an electric discharge system of the present invention.

FIG. 23 is a perspective diagram that shows s inside of s 3D model with three axes which defines a structure of an electric discharge system of the present invention (shown in FIG. 22).

FIG. 24 is a diagram that shows an example of a 3D model with three axes which defines a structure of an electric discharge system of the present invention.

FIG. 25 is a perspective diagram that shows an inside of a 3D model with three axes which defines a structure of an electric discharge system of the present invention (shown in FIG. 24).

FIG. 26 is a schematic sectional view of a structure of a discharge portion of a microwave discharge system of the present invention.

FIG. 27 is a diagram that shows a structure of a 3D circuit for transmitting a microwave as a lumped constant equivalent circuit in a structure of a system of the present invention.

FIG. 28 is a diagram that shows a structure of a 3D circuit as a lumped constant equivalent circuit in the case that a boundary plane of plasma is regarded as a termination plane of high frequency wave in a structure of a system of the present invention.

FIG. 29 is a diagram that shows a structure of a 3D circuit for transmitting microwave as a lumped constant equivalent circuit in a structure of a system of the present invention in the case that plasma discharge is not causeed.

FIG. 30 is a diagram that shows an equivalent circuit of a general high frequency dielectric resonance circuit.

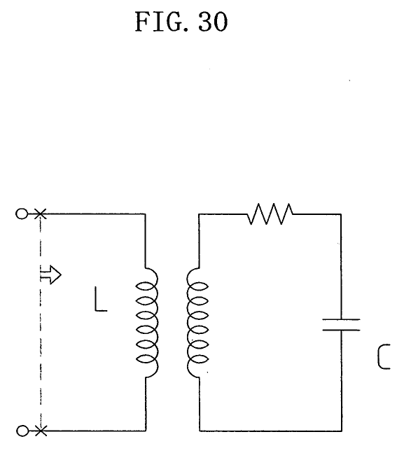

FIG. 31 is a diagram that shows an equivalent circuit of a general high frequency wave coupling circuit type matching circuit.

FIG. 32 is a diagram that shows a state of progressing and reflected microwave, functions of portions of a 3D circuit operating the microwave in the case that much power is supplied by guiding high frequency waves through two waveguides to a plasma load in an electric power supplying method with separated plural oscillators in the microwave electric discharge system of the present invention.

FIG. 33 is a diagram that shows a structure of a 3D circuit as a lumped constant equivalent circuit in the case that much power is supplied by guiding high frequency waves through two waveguides to a plasma load in a microwave discharge system of the present invention.

FIG. 34 is a diagram that shows a structure of a 3D circuit as a lumped constant equivalent circuit in the case that much power is supplied by guiding high frequency waves through two waveguides to a plasma load and a boundary plane of plasma is regarded as a termination plane of high frequency wave in a microwave discharge system of the present invention.

FIG. 35 is a diagram that shows an equivalent circuit of a high frequency wave coupling portion in a cavity resonator which is located in a general waveguide.

FIG. 36 shows a vertical sectional view and a horizontal sectional view on y1-y2 of a discharge portion of a high frequency wave ionized gas plasma generating system in the first example of the present invention.

FIG. 37 shows a vertical sectional view and a horizontal sectional view on y1-y2 of a discharge portion of a high frequency wave ionized gas plasma generating system in the second example of the present invention.

FIG. 38 shows a vertical sectional view and a horizontal sectional view on y1-y2 of a discharge portion of a high frequency wave ionized gas plasma generating system in the third example of the present invention.

FIG. 39 shows a vertical sectional view and a horizontal sectional view on y1-y2 of a discharge portion of a high frequency wave ionized gas plasma generating system in a modification of the first example of the present invention.

FIG. 40 shows a vertical sectional view and a horizontal sectional view on y1-y2 of a discharge portion of a high frequency wave ionized gas plasma generating system in a modification of the first example of the present invention.

FIG. 41 shows a vertical sectional view and a horizontal sectional view on y1-y2 of a discharge portion of a high frequency wave ionized gas plasma generating system in a modification of the first example of the present invention.

FIG. 42 shows a vertical sectional view and a horizontal sectional view on y1-y2 of a discharge portion of a high frequency wave ionized gas plasma generating system in a modification of the first example of the present invention.

FIG. 43 shows a vertical sectional view and a horizontal sectional view on y1-y2 of a discharge portion of a high frequency wave ionized gas plasma generating system in a modification of the example shown in FIG. 42.

FIG. 44 shows a vertical sectional view and a horizontal sectional view on y1-y2 of a discharge portion of a high frequency wave ionized gas plasma generating system in a modification of the first example of the present invention.

FIG. 45 shows a vertical sectional view and a horizontal sectional view on y1-y2 of a discharge portion of a high frequency wave ionized gas plasma generating system in a modification of the first example of the present invention.

FIG. 46 shows a vertical sectional view and a horizontal sectional view on y1-y2 of a discharge portion of a high frequency wave ionized gas plasma generating system in a modification of the first example of the present invention.

FIG. 47 shows a vertical sectional view and a horizontal sectional view on y1-y2 of a discharge portion of a high frequency wave ionized gas plasma generating system in a modification of the first example of the present invention.

FIG. 48 shows a vertical sectional view and a horizontal sectional view on y1-y2 of a discharge portion of a high frequency wave ionized gas plasma generating system in a modification of the first example of the present invention.

FIG. 49 shows a vertical sectional view and a horizontal sectional view on y1-y2 of a discharge portion of a high frequency wave ionized gas plasma generating system in a modification of the first example of the present invention.

FIG. 50 shows a vertical sectional view and a horizontal sectional view on y1-y2 of a discharge portion of a high frequency wave ionized gas plasma generating system in a modification of the first example of the present invention.

FIG. 51 shows a vertical sectional view and a horizontal sectional view on y1-y2 of a discharge portion of a high frequency wave ionized gas plasma generating system in a modification of the first example of the present invention.

FIG. 52 shows a vertical sectional view and a horizontal sectional view on y1-y2 of a discharge portion of a high frequency wave ionized gas plasma generating system in a modification of the first example of the present invention.

FIG. 53 shows a vertical sectional view and a horizontal sectional view on y1-y2 of a reaction processing portion in the fourth example of the present invention.

FIG. 54 shows a vertical sectional view and a horizontal sectional view on y1-y2 of a reaction processing portion in the fifth example of the present invention.

FIG. 55 shows a vertical sectional view and a horizontal sectional view on y1-y2 of a reaction processing portion in the sixth example of the present invention.

FIG. 56 shows a vertical sectional view and a horizontal sectional view on y1-y2 of a reaction processing portion in a modification shown in FIG. 42.

FIG. 57 shows a vertical sectional view and a horizontal sectional view on y1-y2 of a reaction processing portion in a modification of the sixth example of the present invention.

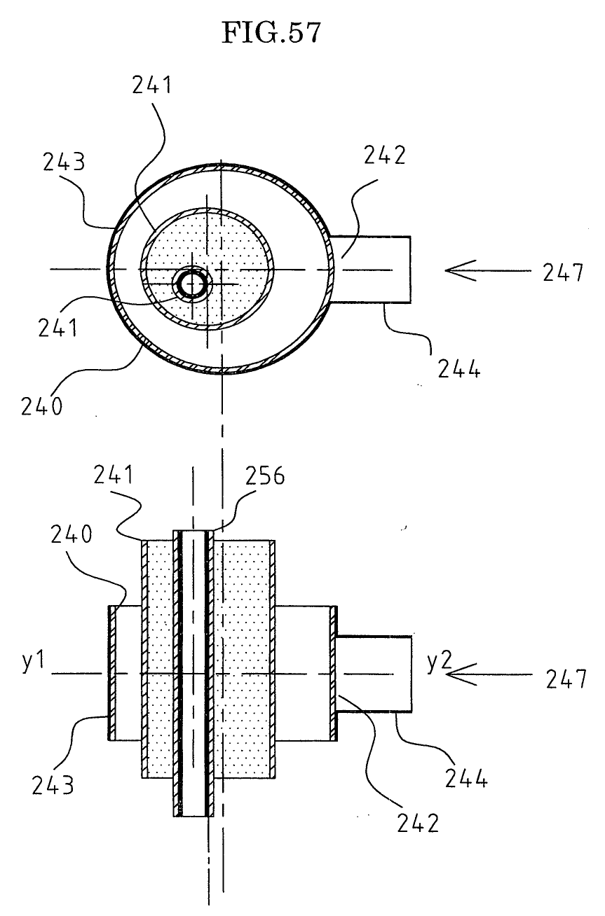

FIG. 58 shows a vertical sectional view and a horizontal sectional view on y1-y2 of a reaction processing portion in a modification of the fourth example of the present invention.

FIG. 59 shows a vertical sectional view and a horizontal sectional view on y1-y2 of a reaction processing portion in a modification of the fourth example of the present invention.

FIG. 60 shows a vertical sectional view and a horizontal sectional view on y1-y2 of a reaction processing portion in a modification of the fourth example of the present invention.

FIG. 61 shows a vertical sectional view and a horizontal sectional view on y1-y2 of a reaction processing portion in a modification of the fourth example of the present invention.

FIG. 62 shows a schematic sectional view and a diagram of a structure of a microwave reaction processing system of the present invention.

FIG. 63 shows a vertical sectional view and a horizontal sectional view on y1-y2 of a reaction processing portion in the seventh example of the present invention.

FIG. 64 shows a vertical sectional view and a horizontal sectional view on y1-y2 of a reaction processing portion in the eighth example of the present invention.

FIG. 65 shows a vertical sectional view and a horizontal sectional view on y1-y2 of a reaction processing portion in the ninth example of the present invention.

FIG. 66 shows a vertical sectional view and a horizontal sectional view on y1-y2 of a reaction processing portion in the tenth example of the present invention.

FIG. 67 shows a vertical sectional view and a horizontal sectional view on y1-y2 of a reaction processing portion in a modification of the tenth example of the present invention.

FIG. 68 is a schematic diagram of a structure that represents a method of wastewater processing and a wastewater processing system in the eleventh example of the present invention.

FIG. 69 shows a vertical sectional view and a horizontal sectional view on y1-y2 of a wastewater processing portion in a modification of the eleventh example of the present invention.

FIG. 70 is a schematic diagram of a structure that shows a method of wastewater processing and a wastewater processing system in a modification of eleventh example of the present invention.

FIG. 71 is a schematic diagram of a structure that shows a method of wastewater processing and a wastewater processing system in a modification of eleventh example of the present invention.

### BEST MODE OF CARRYING OUT THE INVENTION

The embodiment of the present invention will be described below with reference to the accompanying drawings.

Specific structures of the systems for solving the problems will be described with reference to the accompanying drawings.

It is effective for generation of electric field with uniform and large area in the processing region to form an electric field with a large area below the dielectric transmission surface by guiding high frequency waves from the waveguide into the dielectric transmission surface and widely propagating high frequency waves in the dielectric transmission surface. However, as long as the dielectric transmission surface is a finite dielectric transmission surface which has a termination, uncertain standing waves are formed by reflections on the termination. Thus, according to a shape, a thickness or others of the finite dielectric transmission surface, locations of an isolator and an impedance matching device circuit are necessary.

Moreover, if the electric power supplying method with separated plural oscillators, with which electric power is supplied through plural high frequency wave coupling portions to a single same load for large power supply, is adopted, because the distances between the high frequency wave coupling portions and the load are different and standing waves formed by reflections on the terminations are also different, it is necessary to control standing waves formed by reflections with automatic impedance matching devices that can respectively follow impedance changes on all the transmission surfaces. Consequently, the system becomes expensive and large because the high frequency wave transmission surfaces need waveguides. Thus, the design of the system becomes restricted and the system becomes inefficient by transmission losses.

In the present invention, by forming a dielectric transmission surface looped, the transmission surface in the equivalent circuit becomes infinitely long and high frequency waves return on the looped surface. A transmission surface resonance occurs and reflectances decrease by designing the length of the looped transmission line integer times ¼ of the wavelength.

The resonance condition of the transmission surface is satisfied by designing the resonance transmission surface integer times of the ½ wavelength. However, the peak position of the electric field is ¼ of the wavelength different according to whether TM mode or TE mode is adopted for the guided waves. Therefore, the length of the transmission line is designed integer times ¼ of the wavelength.

If the length of the transmission line is integer times ¼ of the wavelength and the line is looped, the system functions as a ¼ wavelength impedance transformer. Therefore, the system functions as a matching device by inserting parallel or series reactance on the load-side and reflections to the oscillation circuit is able to be reduced.

If plural high frequency wave coupling portions are located on the single dielectric transmission surface, interferences of guided high frequency waves are able to be prevented and resonance is able to be intensified on the same transmission surface by tuning positions of the high frequency wave coupling portions. Consequently, a reflectance of the whole system is able to be reduced in some resonance states.

For the purpose to form an infinitely long dielectric transmission surface with large area, the transmission surface can be composed of cylindrical or spherical dielectric container. For the purpose, it is enough to locate high frequency wave coupling portions on the side face of the cylindrical or spherical container and form the container as a looped high frequency wave transmission surface. It is also enough to locate high frequency wave coupling portions making electromagnetic waves travel through the waveguide into the infinitely long dielectric transmission surface.

Moreover, a side face of the infinitely long dielectric transmission surface is covered with a conductive material with the ground potential of the high frequency oscillator and a processing region as resistance at the position integer times ¼ of the wavelength away from the face of the transmission surface is formed on the opposite side of the transmission surface with the ground potential. Thus, many intense points of electric field are generated in the processing region and energy is able to be efficiently concentrated to the load.

Moreover, since the distance from the infinitely long dielectric transmission surface to the load is integer times ¼ of the wavelength, the structure itself is able to function as an impedance transformer type matching device to reduce a reflectance of the whole system.

If the load region is formed odd times ¼ of the wavelength away from the side face of the transmission surface opposite to the ground-potential-side as described above, the structure is equivalent to a parallel resonance circuit with respect to the resonance of the transmission surface. Consequently, much electric power is easily supplied and an absorbing efficiency of the load increases.

Since a border plane of the conductive material is formed on the inside of the processing region, electromagnetic waves reflect and travel in the processing region for non-conductive material closed between looped infinitely long dielectric transmission surface and the face of the conductive material. Thus, the region in which electromagnetic waves travel increases and the electric field is able to be generated in a large area.

Thus, if the system is composed as described below, the condition described above is satisfied. Namely, the system has a cylindrical or spherical dielectric face as a transmission surface. The high frequency wave coupling portion is located on the cylindrical plane or spherical face and the infinitely long dielectric transmission surface is formed loop-shaped so that the dielectric transmission surface can be equivalent to an infinitely long transmission surface. Moreover, the length of the loop is at least satisfied to be integer times ¼ of the wavelength of the guided high frequency wave and the outside area of the container except the high frequency wave coupling portion is covered with conductive material, which is an infinitely long dielectric transmission surface to keep the area with the ground potential of the guided high frequency wave. The object container with at least a portion of plane located ¼ of the wavelength of the guided high frequency wave from the border plane between the conductive material plane and the infinitely long dielectric transmission surface. A conductive plane can be formed in the object container, if it is necessary.

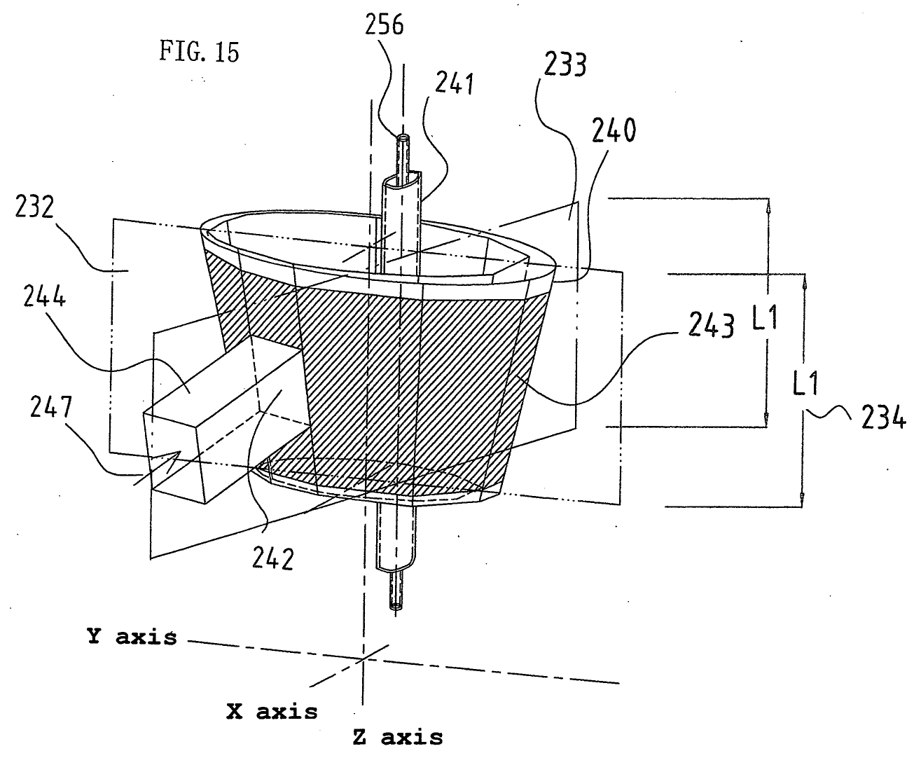

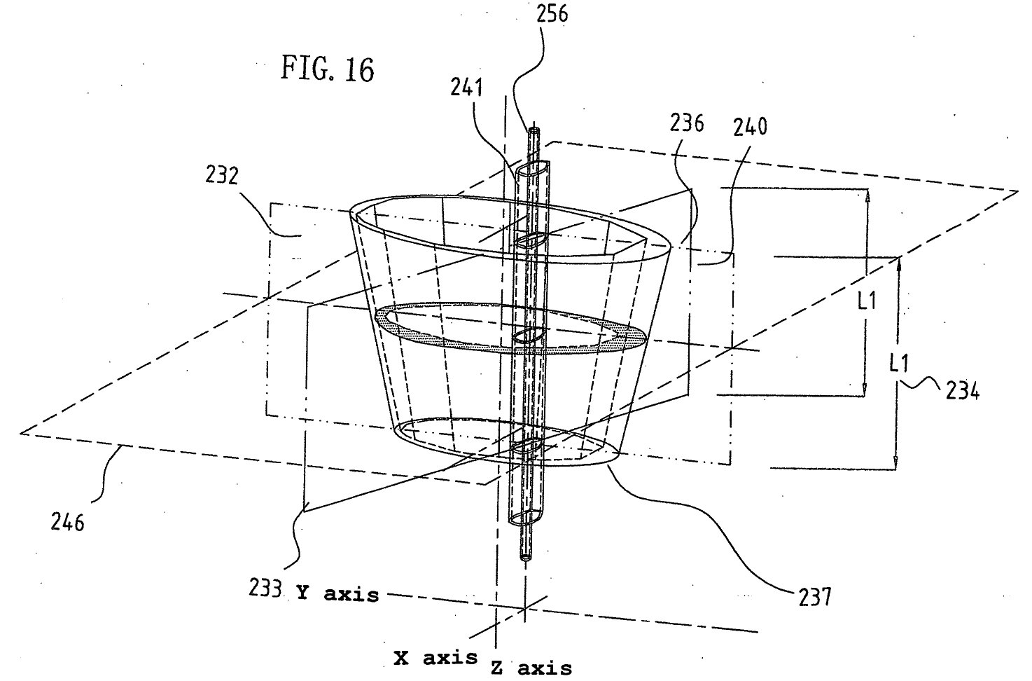

FIG. 15 is a diagram that shows an example of a 3D model with three axes which defines a structure of the system of the present invention and FIG. 16 is a perspective diagram of the inside of the 3D model shown in FIG. 15. Signs or numbers in the figures is described with “ ” in order to be distinguished from other signs.

A high frequency wave coupling portion “242” coupled with a waveguide is located at an optional position on an outer side face of an outer container Va “240”. High frequency waves 247” guided through the waveguide travel in the dielectric material of the dielectric outer container Va “240”, a dielectric transmission surface. The outer container Va “240” is symmetrical with respect to a symmetry axis plane Sz1 “232” and has a cavity. A outer outline of a section crossed by a plane Sx1 “246”, which is perpendicular to a plane Sz1 and crosses the high frequency wave coupling portion “242”, is continuous curve. The outer container can be closed with two end planes (a1 “236” and a2 “237”). The distance between the planes is L1 “234” along Z axis. L1 is a length of the axis connecting one end plane with the other.

The high frequency wave is guided with the electromagnetic mode that electromagnetic wave travels at least along the inner outline of section crossed by the plane Sx1 “246” in neighbor of the coupling portions. The outer container Va “240” is formed so that a length of the looped inner outline could be at least integer times ¼ of the wavelength of the high frequency wave.

The outer face of the outer container Va “240” except the high frequency wave coupling portion is covered with conductive material “243” with a potential same as a high frequency wave transmission surface of each potential.

In the high frequency wave coupling portion “242”, the structure of the system spreads the electric field of the electromagnetic wave guided through the waveguide along the face of the dielectric material, not perpendicular to the face, by tuning the connecting angle between the waveguide and the plane of the outer container Va “240”, the face itself of the outer container Va “240” or the shape of the dielectric material connecting with the outer container Va “240”. The structure also efficiently guides electromagnetic waves into the dielectric transmission surface and prevents reflections at the high frequency wave coupling portion by being selected a proper electromagnetic mode.

An inner container Vb “241”, an enclosure of an object, is symmetrical with respect to a plane Sz2 “233” including the line parallel to Z axis of the plane Sz1 or the plane Sz1. The inner container can be closed with two planes respectively including at least end planes (a1 and a2), between which distance along Z axis is L1.

The inner container is made of dielectric material. The inner container Vb “241” is inserted in the outer container Va “240” without contacting the inner face of the outer container. The inner container must have a section crossed by the plane Sx1 “246”. In, at least, a portion of the section, the distance between the outer outline of the section of the outer container Va “240” and the inner outline of the section of the inner container Vb “241” is integer times ¼ of the wavelength of the guided high frequency wave.

Two or more inner containers Vb “241” can be inserted in the outer container Va “240” to form plural processing regions without duplication of their cavities. In the inner container Vb “241”, an inner container Vc can be located. The inner container Vc can be closed with two planes including end planes (a1 and a2), between which distance along Z axis is L1.

A conductive plane is formed on, at least, one of an outer side face or inner side face of an inner container Vc “256”, which forms a processing region for object and the system causes reflections of the waves of the leaked electric field from the dielectric outer container Va “240” as a dielectric transmission surface. Thus, the wave reflects and travels between the conductive plane and a conductive material “243”. The reaction process is able to be carried out by the wave traveling through the processing region.

In the case that the inner container Vc “256” is dielectric, the inner container Vc “256” can be vacuumed and discharge plasma can be produced in the inner container Vc to cause the same effect described above. Thus, the border plane of the discharge plasma can be used equivalent to the conductive material “243”.

Each energy source for heating and cooling can be located in the inner container Vc, which forms a processing region for object, and used for a sub reaction source in the processing region outside the inner container Vc.

The outer container Va “240” and the inner container Vb “241” can have multi layer composed of different dielectric materials for a wall. If the dielectric materials are properly selected, the electromagnetic waves spread along the face of the dielectric material and the region of the electric field is able to be enlarged, since the reflections of the electromagnetic waves occur between the dielectric layers.

The inner side face of the outer container Va or the outer side face of the inner container Vb is made uneven-shaped or rough by grinding. Thus, the electromagnetic waves spread along the face of the dielectric layer and the plane of the electric field is enlarged.

The wall face of the inner container Vb “241”, which forms a processing region, is cooled and the temperature in a process is able to be controlled by a gas cooling or a liquid cooling with low-dielectric-constant liquid in a non-processing region between the outer container Va “240” and the inner container Vb “241”.

In the case that, a plane closing the inner container Vb or the region between the inner container Vb and the inner container Vc composing the processing region, traversing Z axis, is a conductive plane and a distance along Z axis is integer times ¼ of the wavelength of the guided high frequency wave, a cavity resonator is able to be formed and resonance is able to be most suited by tuning a size and a shape of the inner container Vb and Vc.

A processing rate is able to be increased by forming the magnetic field along Z axis in the processing region by a permanent magnet or an electromagnet.

An electric current density is able to be increased by forming the magnetic field with a permanent magnet or an electromagnet along Z axis in the microwave electric field portion that is generated in the inner container Vb.

A preventing-reflection structure of the microwave reaction processing system and an impedance matching structure described above are explained below according to the figures.

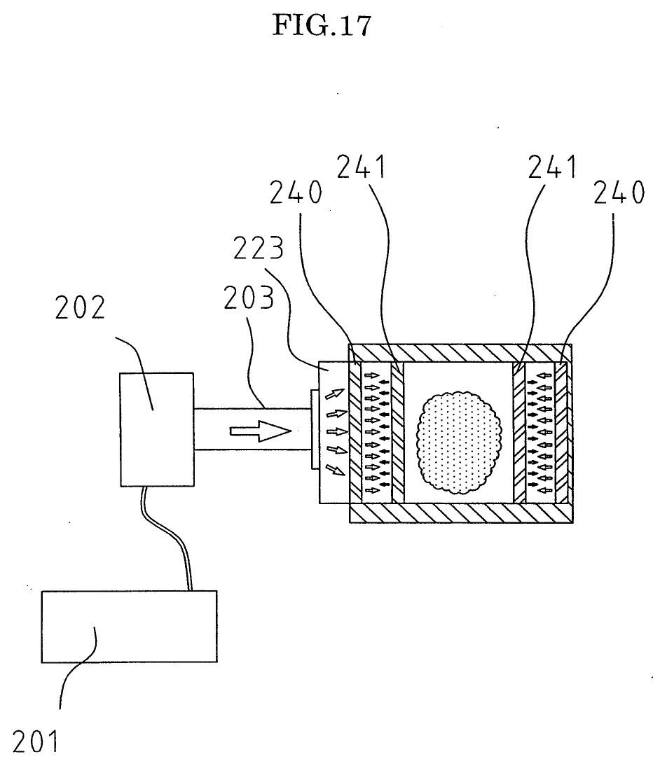

FIG. 17 is a schematic diagram of a structure of a system described above including the high frequency wave transmission system.

A high frequency oscillator “202” includes a magnetron and oscillates high frequency waves by a high voltage power supply “201”. Electromagnetic waves travel through a rectangular waveguide “203” and are guided to the dielectric outer container Va “240”, a dielectric transmission surface, at a high frequency wave coupling portion “223”. The outer side face of the outer container Va except the high frequency wave coupling portion is covered with a conductive material, which has the ground potential eaqual to the waveguide. Thus, the guided electromagnetic waves spread and travel along the side face of the outer container Va “240”, an infinitely long dielectric transmission surface, and the leaked electric field is generated in the container by the surface waves.

The surface waves are guided into a region between the dielectric outer container Va “240” and the inner container Vb “241” as a side wall of the processing container. Thus, a standing wave is generated by a high frequency progressing wave “221” and a reflected wave “222”. The surface waves are also guided into the dielectric inner container Vbn “241” and the energy of the wave is absorbed by object that is a load.

Shown in FIG. 17, the magnetron oscillator do not have any damage even without impedance matching devices on the waveguide in the present invention, because the whole system keeps matching against the load and no reflected wave exists in the waveguide “203”.

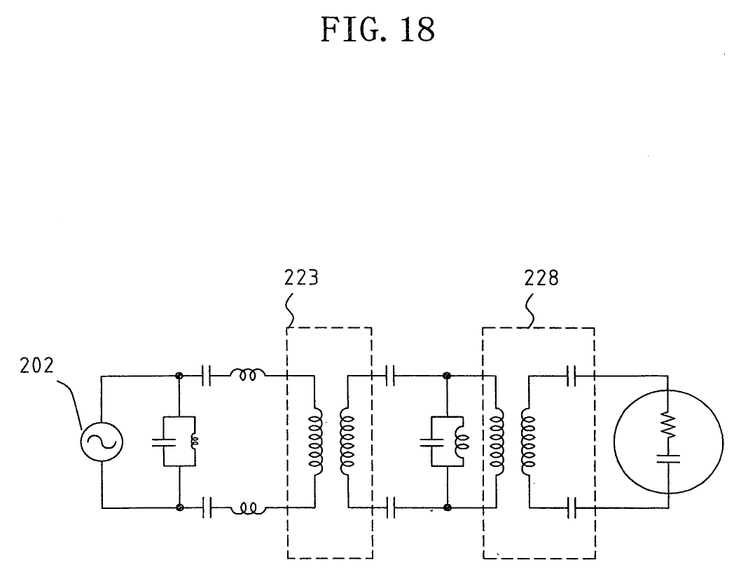

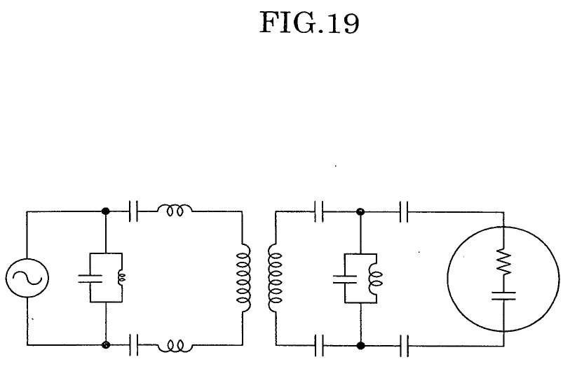

FIG. 18 is a diagram that shows the structure shown in FIG. 17 as a lumped constant equivalent circuit. FIG. 19 is a diagram that shows a schematic equivalent circuit in the case that the conductive face of the container is regarded as a termination plane.

Shown in FIG. 18, the system is a double coupling resonance circuit in which two general dielectric resonance circuits are coupled and a resonator connects with an input line and an output line. A ¼ wavelength impedance transformer type matching circuit is formed between the circuit region “223” representing the high frequency wave coupling portion and a circuit region “228” representing the inner container Vb coupling portion.

In a double coupling resonance circuit, if a Q value on the input connecting line is ½ of a Q value on the output connecting line, there is no reflection (“Microwave Technology” authorized by Fumiaki Okada, published by Gakkensha in 1993). Therefore, non-reflection state is achieved by composing the system most suitable. Shown in FIG. 18, a resonance circuit “219” is located on the termination-side of the processing load portion and an energy efficiency of the system is high. A circuit equivalent to a coupling circuit type matching device shown in FIG. 19 with a high frequency wave coupling portion and dielectric transmission surface is composed and the load circuit is separated from the oscillating portion. That shows the system is applicable to situations that the load changes.

Moreover, shown in FIG. 19, a transformed n-type matching device is formed by a coupling matching circuit and a ¼ wavelength impedance transformer type matching circuit. The structure of the circuit covers a wide matching range. Since a ¼ wavelength impedance transformer type matching circuit functions as a parallel resonance circuit for the load, The system has the circuit system that enables to easily increase an electric current at the load and an efficiency of the electric power.

Namely, the circuit system is durable to the return of the reflected waves to the oscillator in supplying electric power and enables to supply much electric power to the load.

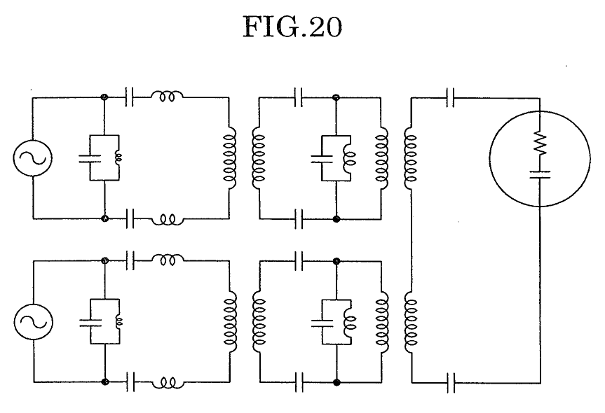

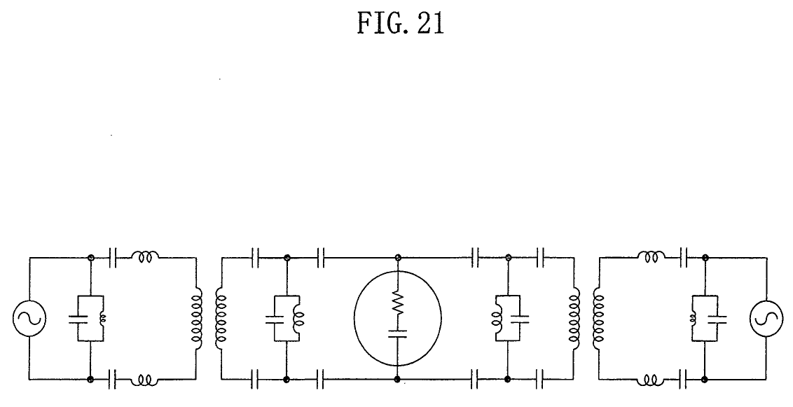

FIG. 20 is a diagram that shows a lumped constant equivalent circuit in the case that much power is supplied by guiding high frequency waves through two waveguides to a plasma load. FIG. 21 is a schematic diagram that shows an equivalent circuit in the case that the conductive face of the processing container is regarded as a termination plane of high frequency waves.

Shown in FIG. 20, the load is jointly connected the two individual high frequency wave transmission waveguides. Shown in FIG. 21, the region of the load portion is separated from both oscillators by coupling circuit type matching circuit. The whole load portion ahead of the coupling circuit functions as a parallel resonance circuit. The structure shows that the system is equivalent to a cavity resonator circuit, which connects to a transmission surface and exchanges the primary side and the secondary side, and that the system has no mutual interference between the oscillators and the load if power is supplied with the plural waveguides.

By composing the whole load as a parallel resonance circuit described above, it becomes easy to increase an electric current at the termination load. Thus, the efficiency of the power consumption at the load increases and much electric power is able to be supplied.

Adapting the structure described above, the high frequency reaction system satisfies the conditions on both ability of an apparatus and a high frequency wave transmission of the circuit without contradiction. On the waveguide of the system, an isolator, an impedance matching device circuit etc is not needed to supply electric power to a single same load without mutual interference on the circuit through the plural high frequency wave coupling portion, increase supplied power optionally, and uniformly generate an electric field with large area in the reaction processing region. Thus, the microwave reaction system has low transmission loss and high efficiency of power consumption at the load with a small size. The system is also composed at low cost and applied to a large volume processing.

The high frequency reaction processing system, a plasma generating system of the first embodiment, is explained below according to the figures.

In the system, the cylindrical or spherical dielectric transmission surface is composed. The high frequency wave coupling portion is located on the cylindrical or spherical plane in order to make the dielectric transmission surface equivalent to an infinitely long line. A length of the looped line is at least integer times ¼ of the wavelength of the guided high frequency wave. Moreover, the outside region of the container, which is the infinitely long dielectric transmission surface, except the high frequency wave coupling portion is covered with a conductive material. The discharged gas plasma vacuum container is composed of dielectric material and is also a vacuum container, which has, at least, a portion of the face ¼ of the wavelength of the guided high frequency wave away from the border plane between the conductive plane and the infinitely long dielectric transmission surface.

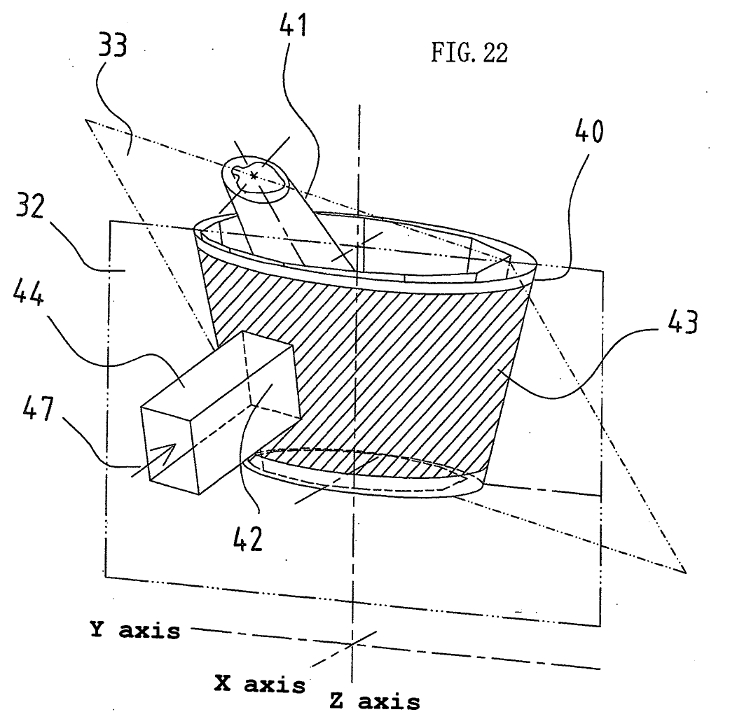

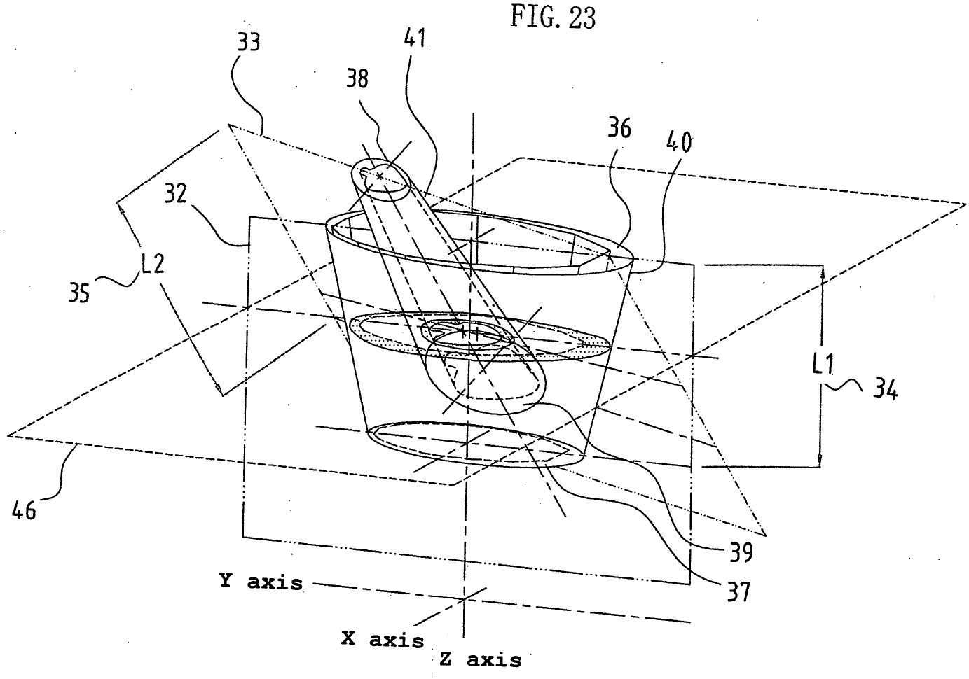

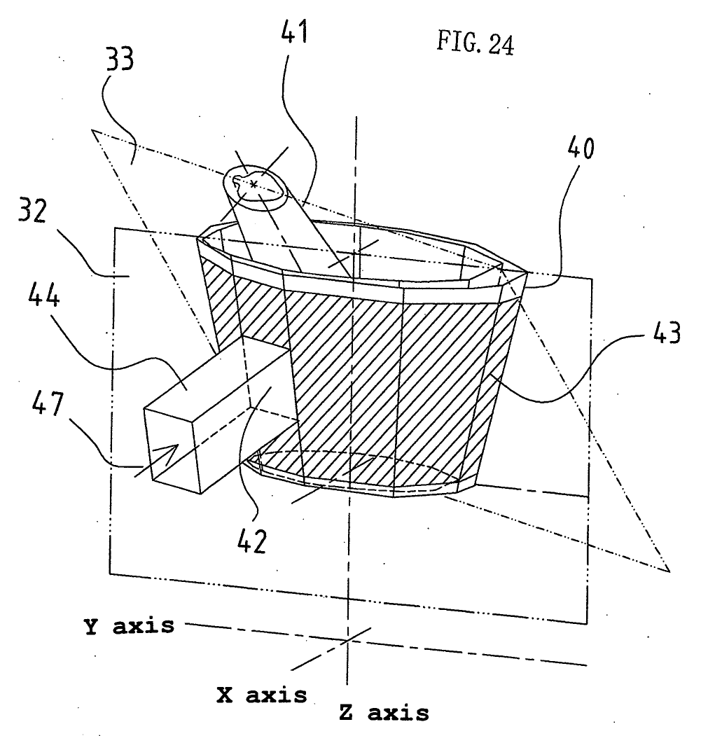

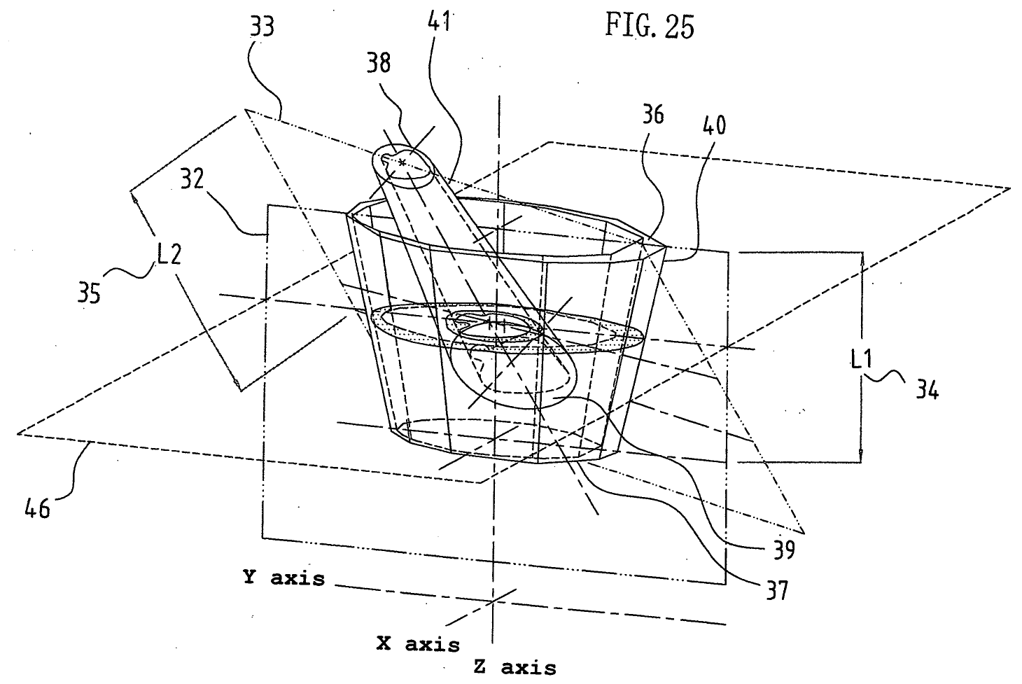

FIG. 22 is a diagram that shows a 3D model with three axes which defines a structure of an electric discharge system of the present invention. FIG. 23 is a perspective diagram of a 3D model shown in FIG. 22. FIG. 24 and FIG. 25 are perspective diagrams that show models modified a portion in the shape shown in FIG. 22. Signs or numbers in the figures is described with “ ” in order to be distinguished from other signs.

One or more high frequency wave coupling portion “42” is located at optional position on the outer side face of an outer container Va “40” described below and high frequency waves “47” guided through the waveguide are propagated into the dielectric outer container Va “40”. The outer container Va “40” is symmetrical with respect to a symmetry axis plane Sz1 “32” and has a cavity. The outer container Va “40” can be ellipse-column-shaped or oval-shaped etc. Thus, the electromagnetic wave is able to easily travel along the circumference of the outer container. Moreover, an outline on the section of the outer container Va “40”, which is crossed by a plane Sx1 “46” crossing the high frequency wave coupling portion “42” and perpendicular to a plane Sz1, is continuous curve. Moreover, the cavity of the outer container Va “40” can be closed with two end planes or end points (a1 “36” and a2 “37”). A distance between one end and the other along Z axis is L1. The outer container is made of dielectric material. L1 is a length of the axis connecting one end of the outer container with the other.

The high frequency wave is guided with the electromagnetic mode, in which electromagnetic wave travels, at least, along the inner outline of the section crossed by the plane Sx1 “46” in neighbor of the coupling portion. The outer container Va “40” is composed so that a length of the inner outline closed as a loop is, at least, integer times ¼ of the wavelength of the guided high frequency wave.

Moreover, the outer face of the outer container Va “40” except the high frequency wave coupling portion is covered with a conductive material “43”, which has a potential eaqual to the ground potential of the waveguide.

The high frequency wave coupling portion “42” has the structure described below. Namely, the structure of the system spreads the electric field of the electromagnetic field of the electromagnetic wave from the waveguide along the face of the dielectric material, not perpendicular to the face, by tuning a connecting angle between the waveguide and the face of the outer container Va “40”, the face itself of the outer container Va “40” or the shape of the dielectric material connecting with the outer container Va “40”. The structure also efficiently guides electromagnetic waves into the dielectric transmission surface and prevents reflections at the high frequency wave coupling portions by being selected a proper electromagnetic mode.

An inner container Vbn (n is integer) “41”, an ionized gas plasma generating region, can be vacuumed and closed with two end planes or end points (b1 “38” and b2 “39”). A distance between one end and the other is L2 along Z axis. The inner container Vbn “41” is also symmetrical with respect to one or more symmetrical axis plane Sz2 “33” and made of dielectric material. L2 is a length of the axis connecting one end of the inner container with the other.

The inner container Vbn (n is integer) “41” is inserted in the outer container Va “40” without touching the inside face of the outer container. The inner container Vbn must have the section crossed by the plane Sx1 “46”. Moreover, the distance between the outer outline of the outer container Vz “40” section and the inner outline of the inner container Vbn “41” section, at least, in a portion of the section is integer times ¼ of the wavelength of the guided high frequency wave.

Since the distance between the outer side face of the outer container and the inner side face of the inner container is constant, electromagnetic waves are able to easily travel along the circumference direction of the tube.

Two or more inner containers Vbn “41” can be located in the outer container Va “40” so that cavities could not duplicate mutually and plural ionized gas plasma generating regions could be formed therein. Two or more inner containers Vbn “41” can be located multiply without touching each other. In the case, a region between the inside face of an inner container Vbn1 and the outside face of an inner container Vbn2 can be vacuumed and be an ionized gas plasma generating region.

FIG. 24 and FIG. 25 are diagrams that show the systems, of which outer side faces of the outer containers Va “40” are composed of plates. The outer container Va “40” can be spherical.

The outer container Va “40” and the inner container Vb “41” have multi layers composed of different dielectric materials. If the dielectric materials are properly selected, the electromagnetic waves spread along the plane of the dielectric material and the region of the electric field is able to be enlarged, since reflection of electromagnetic waves occur between the dielectric layers.

The inner side face of the outer container Va or the outer side face of the inner container Vbn is made uneven-shaped or rough by grinding. Thus, electromagnetic waves spread along the face of the dielectric layer and a plane of the electric field is enlarged.

Gas cooling or liquid cooling with a low dielectric constant liquid is carried out in the region between the outer container Va “40”, which is not the ionized gas plasma generating region, and the inner container Vbn “41”, an inside region of the most inside inner container Vbn in the case that two or more inner containers Vbn “41” are inserted multiply without touching mutually, or a region between the inner containers Vbn, which is not ionized gas plasma generating region and not vacuumed. Thus, the wall face of the inner container Vbn “41”, which is a ionized gas plasma generating region, is able to be cooled. Moreover, recombination of active species, which forms plasma, is able to be prevented on the wall face. Plasma processing is able to be efficient.

A cavity resonator is able to be composed and resonance of the ionized gas plasma generated in the inner container Vbn is able to be best suited by tuning the size and the shape of the inner container Vbn, if all the conditions described below is satisfied. One of the conditions is that a1 “36” and a2 “37” of the outer container Va “40”, and b1 “38” and b2 “39” of the inner container Vbn are conductive planes. Another is that the both of a1 and b1 are on a common plane. Another is that the both of a2 and b2 are also on another common plane. Another is that L1 “34” is same as L2 “35”, which is distance along Z axis. Another is that L1(=L2), which is a distance along Z axis, is integer times ¼ of the wavelength of the guided high frequency wave.

In the case, a plasma density is able to increase more by composing the system to form magnetic field along Z axis in the ionized gas plasma generated in the inner container Vbn by a permanent magnet or an electromagnet and generating electron cyclotron state.

The reflected wave preventing system and the impedance matching system in the high frequency wave ionized plasma gas discharge system described above are explained below according to the figures.

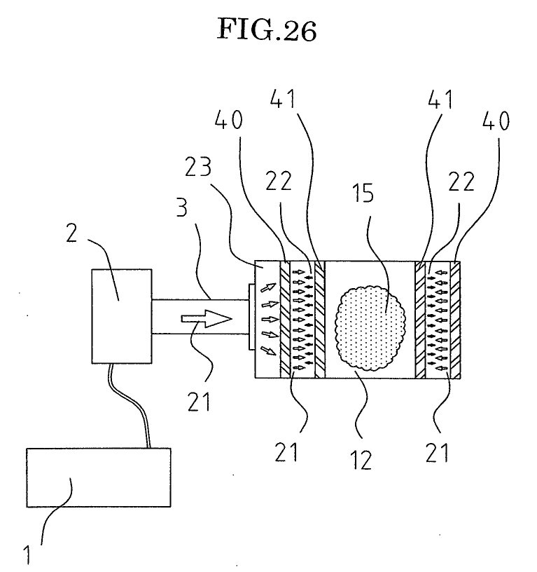

FIG. 26 is a schematic diagram of a structure of a system including a high frequency wave transmission system.

A high frequency oscillator “2” includes a magnetron and oscillates high frequency waves by a high voltage generator “1”. A electromagnetic wave travels through a rectangular waveguide “3” and is guided to the dielectric outer container Va “40”, a dielectric transmission surface, through a high frequency wave coupling portion “23”. The outer side face of the outer container Va except the high frequency wave coupling portion is covered with conductive material, which has the ground potential same as the waveguide. Thus, the guided electromagnetic waves spread along the side face of the outer container Va “40”, an infinitely long dielectric transmission surface, and the leaked electric field is generated inside of the container by the surface wave.

The surface wave described above is guided into the region between the dielectric outer container Va “40” and the inner container Vb “41” as a side wall of the vacuum container “12”. Thus, the standing wave is generated by a high frequency progressing wave “21” and a reflected wave “22”. The surface wave is guided into the dielectric inner container Vbn “41”, which is vacuumed and injected process gas, to generate the ionized gas plasma load “15” and the energy of the wave is absorbed by an object, a load.

Shown in FIG. 26, an impedance matching device is not located on the waveguide in the structure. Nevertheless, the ionized gas plasma is able to be generated and the magnetron oscillator does not have a trouble because the whole system is composed as being matched with a plasma load and there is no reflected wave in the waveguide “3”.

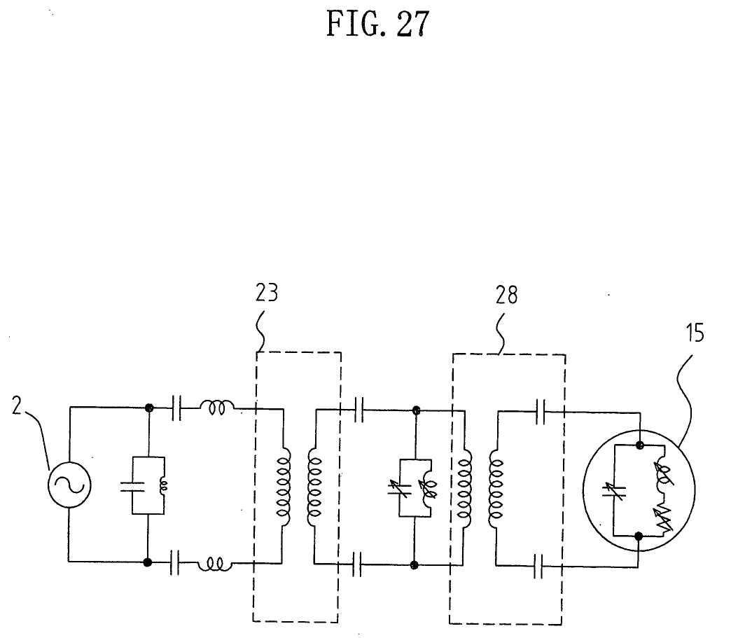

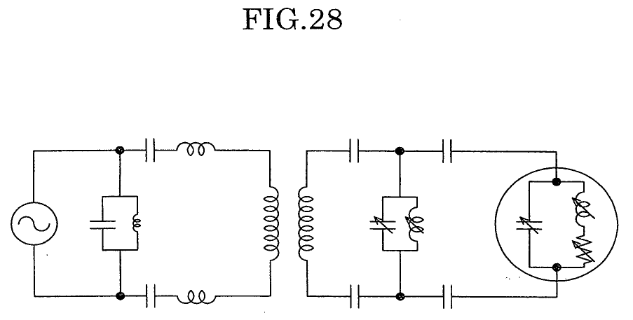

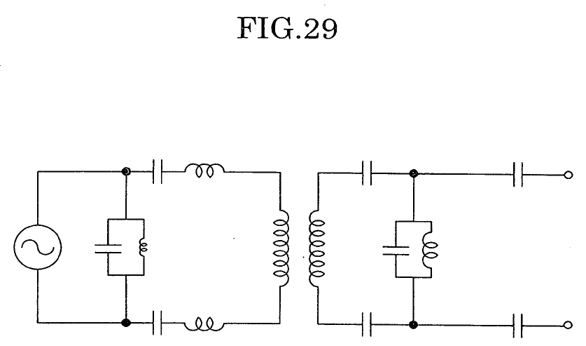

FIG. 27 is a diagram that shows the structure shown in FIG. 26 as a lumped constant equivalent circuit. FIG. 28 shows an equivalent circuit in the case that a border plane of plasma is regarded as a termination plane of high frequency wave in FIG. 27. FIG. 29 shows an equivalent circuit in the case that plasma is not generated.

Shown in FIG. 27, the system is a double coupling resonance circuit in which two general dielectric resonance circuits are coupled and a resonator connects with an input line and an output line. A ¼ wavelength impedance transformer type matching circuit is formed between a circuit region “23” representing the high frequency wave coupling portion and a circuit region “28” representing the inner container Vbn coupling portion.

In the double coupling resonance circuits, if a Q value on the input connecting line is ½ of a Q value on the output connecting line, there is no reflection (“Microwave Technology” authorized by Fumiaki Okada, published by Gakkensha in 1993). Therefore, non-reflection state is achieved by composing the system most suitable.

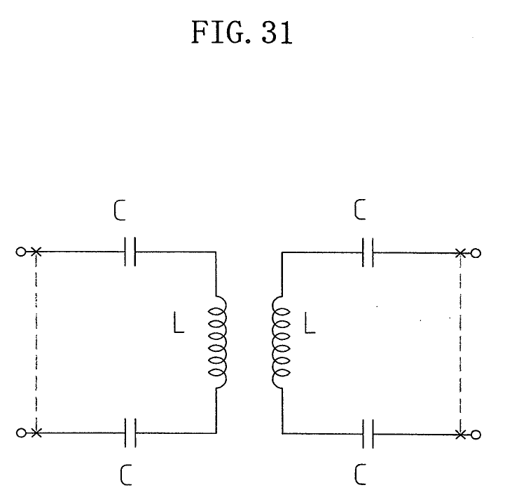

It is necessary to bias voltage high enough to separate ionized gas toward the termination of the circuit in order to generate plasma from non-plasma state in the plasma load portion. Shown in FIG. 29, the resonance circuit is located on the termination-side of the processing load portion and the energy efficiency of the system is high. A circuit equivalent to a coupling circuit type matching device shown in FIG. 31 is composed of the high frequency wave coupling portion and the dielectric transmission surface and the load circuit is separated from the oscillating region. That shows the system is durable in the situation that the load changes.

Moreover, shown in FIG. 28, a transformed n-type matching device is formed with a coupling matching circuit and a ¼ wavelength impedance transformer type matching circuit after the plasma load is generated. The structure of the circuit covers a wide matching range. Since a ¼ wavelength impedance transformer type matching circuit becomes variable impedance circuit which changes in respect to generation of the plasma load and functions as a parallel resonance circuit, the circuit system enables to easily increase electric current at the load. Then the circuit system enables to follow the change of the impedance if it occurs at the plasma load and increase the electric power efficiency.

From the beginning of power supply to the plasma generation, the circuit system enables to instantly and easily generate plasma at the load and be durable against return of a reflected wave to the oscillator at the instance of the plasma generation. Then the circuit system enables to follow the change of the load impedance in response to the generation of the plasma load and supply much electric power to the load.

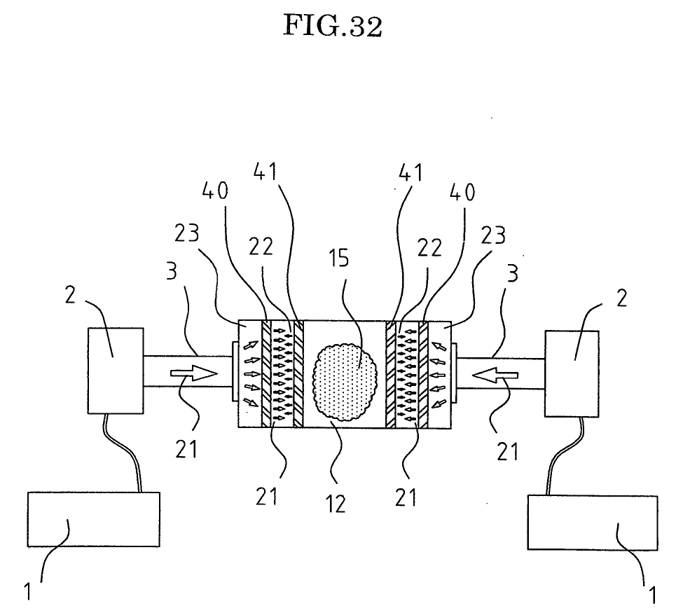

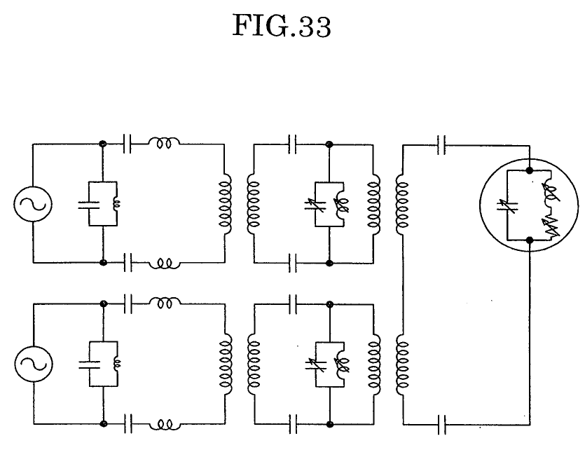

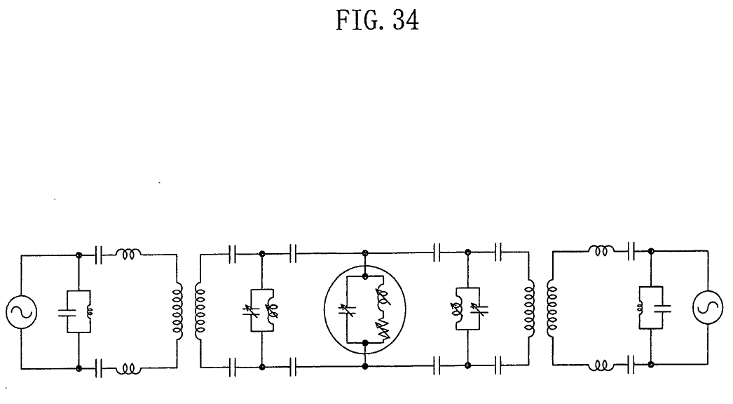

FIG. 32 shows a state of progressing and reflected microwave, a microwave 3D circuit operating the microwaves in the case that much power is supplied by guiding high frequency waves through two waveguides to a plasma load in an electric power supplying method with separated plural oscillators in the microwave electric discharge system of the present invention. FIG. 33 is a diagram that shows the structure as a lumped constant equivalent circuit. FIG. 34 is a diagram that shows the structure as an equivalent circuit in the case that a boundary plane of plasma is regarded as a termination plane of high frequency wave.

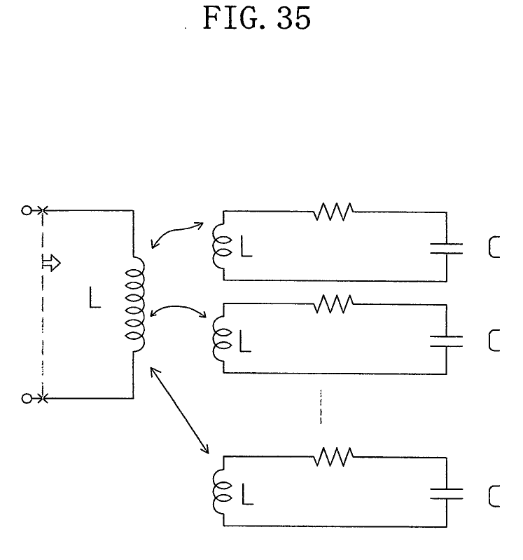

Shown in FIG. 34, the load is jointly connected the two individual high frequency wave transmission waveguides. Shown in FIG. 34, the region of the load portion is separated from both oscillators by acoupling circuit type matching circuits even at the instance of the ionized gas plasma generation. The whole load portion ahead of the coupling circuit functions as parallel resonance circuit. The structure shows that the system is equivalent to a cavity resonator circuit, which connects to a transmission surface shown in FIG. 35 and exchanges the primary side and the secondary side, and that the system has no mutual interference between the oscillators and the load if power is supplied with the plural waveguides.

Since the whole load functions as a parallel resonance circuit described above, it is easy to increase the electric current at the termination load. Consequently, an efficiency of the power consumption at the termination plasma load increases and much electric power is able to be supplied.

Adapting the structure described above, the high frequency reaction system satisfies the conditions on ability of an apparatus and a high frequency wave transmission of the circuit without contradiction. On the waveguide of the system, an isolator or an impedance matching device circuit etc is not needed to supply electric power to a single same load without mutual interference on the circuit through the plural high frequency wave coupling portions, increase supplied power optionally, and uniformly generate the electric field with large area in the reaction processing region. Thus, the microwave reaction system has low transmission loss and high efficiency of power consumption at the load with a small size. The system is also composed at low cost and applied to a large volume processing.

As a specific example of the first embodiment, the first example to the third one and modifications of them are explained below.

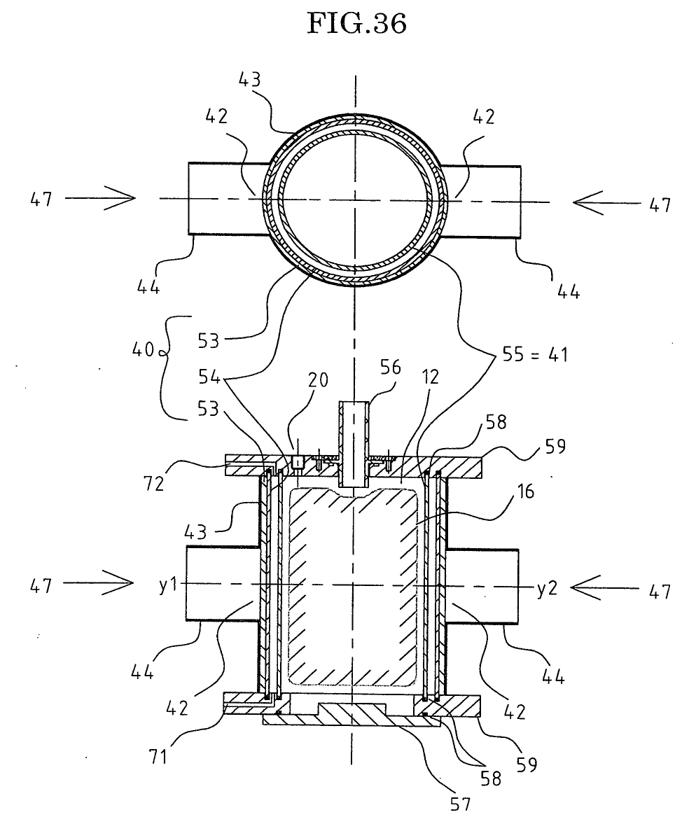

FIG. 36 shows a vertical sectional view and a horizontal sectional view on y1-y2 of a discharge portion of a high frequency wave ionized gas plasma generating system in the first example of the present invention.

Shown in FIG. 36, the high frequency waves “47” are oscillated from two microwave oscillators and respectively guided through waveguides “44” into a processing vacuum container “12” as a discharge portion of the system of the present invention. The processing vacuum container “12” is composed of a cylindrical inner container quartz tube “55” as the dielectric inner container Vbn “41”, aluminum vacuum container walls “59” in the upper and down sides and an aluminum door sample stage “57”. The vacuum container “12” is sealed with an O-ring “58”. A vacuum exhaust port “56” for vacuum ventilation is located on the vacuum container wall “59”. Gas for plasma is led through a processing gas passage “20” with controlling of the flow.

The process to the generation of the plasma with the system is explained below. After a sample is placed on the door sample stage “57” in the atmospheric pressure, the door sample stage “57” is raised and the downside vacuum container wall “59” is sealed with an O-ring. The vacuum container “12” is vacuumed and the process gas is led through the process gas passage “20”. High frequency wave ionized gas plasma with a plasma border plane “16” is generated in the vacuum container “20” by guiding high frequency waves traveling along the high frequency wave traveling direction “47”.

A high frequency wave transmission waveguide “44” is connected with the outer side face of the dielectric outer container Va “40”. The dielectric outer container Va “40” is formed with a quartz tube “54”, of which side face is covered with a fluorine rosin film layer “53”. The outer side face of the fluorine rosin film layer “53” except the portion connected with a high frequency wave transmission waveguide “44” is covered with the covering conductive material “43” that is made of aluminum and keeps same potential as the high frequency wave transmission waveguide “44”. Moreover, the covering conductive material “43” is electrically connected with the aluminum vacuum container walls “59”.

In this example, the dielectric inner container Vbn “41” is coaxially located in the dielectric outer container Va “40” so that the distance between the inner side face of the dielectric inner container Vbn “41” and the outer side face of the fluorine rosin membrane layer “53” of the dielectric outer container Va “40” should be ¼ of the wavelength of the guided high frequency wave.

On the purpose to cool the dielectric outer container Va “40” and the dielectric inner container Vbn “41”, gas or liquid with a low dielectric constant flows into the region between the dielectric outer container Va “40” and the dielectric inner container Vbn “41” from a cooling medium leading passage “71” and flows out through a cooling medium exhausting passage “72” on the vacuum container upper side wall “59”.

The high frequency wave coupling portion “42” connects the high frequency wave transmission waveguide “44” with the dielectric outer container Va “40”. The high frequency wave “47” travels through the high frequency wave coupling portion “42” on the dielectric outer container Va “40”, a transmission surface. Commonly, the direction of the electric field depends on the electromagnetic wave mode of the high frequency wave “47”. An infinitely long dielectric transmission surface is formed and the electromagnetic wave travels on the side face of the tube along the looped line by tuning the electric field with TM11 mode so that the electromagnetic wave could travel along the circumference direction of the cylindrical dielectric outer container Va “40” in this example.

The length of the inner outline of the horizontal section of the dielectric outer container Va “40” is integer times ¼ of the wavelength of the guided high frequency wave. Thus the high frequency wave “47”, which travels along the circumference direction of the dielectric outer container Va “40” as a dielectric transmission surface, causes transmission surface resonance. The outer side face of the dielectric outer container Va “40” is covered with the covering conductive material “43”. Thus, the electromagnetic wave cannot leak outside and surface waves forming the leaked electric field are generated in a wide range along a radius direction of the dielectric outer container Va “40”. The covering conductive material “43” keeps the ground potential. Thus, many intense points of the electric field are on a loop in a wide range at every ¼ of the wavelength of the guided surface wave.

The inner side face of the dielectric inner container Vbn “41”, which forms the wall of the vacuum container “12”, is at the intense point of the electric field. Thus, ionized gas plasma is able to be easily generated in the vacuum container “12” instantly after the high frequency wave “47” is guided.

The plasma border plane “16” is formed in dielectric inner container Vbn “41” in response to a generation of ionized gas plasma. Since the ionized gas plasma itself has variable impedance, a portion of the surface wave is absorbed and the outer portion is reflected on the plasma border plane “16”. The reflected wave travels mutually in the dielectric outer container Va “40” covered with the covering conductive material “43” and the region formed by the plasma border plane “16”. The impedance of the high frequency wave transmission surface in this region changes with following the impedance of the ionized gas plasma. This region forms a ¼ wavelength impedance transformer matching circuit. Thus, the circuit causes a resonance following the ionized gas plasma. Consequently, the impedance matching is caused between the transmission surface and the plasma load. Finally, the energy of electromagnetic wave is efficiently absorbed to the plasma load.

A plasma density increases with increase of the supplied power and the plasma border plane “16” begins to have a conductive character. Though reflection standing waves increases on the ¼ wavelength impedance transformer transmission surface, the capacity of the transmission surface increases and the whole system forms parallel resonance circuit. Thus, the electric current to the plasma load increases by increase of the reflection standing wave and an efficiency of the plasma ionization increases.

Thus, reflected waves cannot return to the high frequency wave transmission waveguide “44”, the system is in non-reflection state in viewing the load from the oscillator.

If the plasma load is not generated in the whole vacuum container “12”, the vacuum container functions as a cylinder cavity resonator. If the plasma load is generated in the whole vacuum container, the vacuum container functions as a dielectric resonator. Therefore, electric power is efficiently absorbed at the load.

Shown in FIG. 36, even in the case that the high frequency wave “47” is guided through the plural high frequency wave transmission waveguides “44”, the standing wave is enclosed in the region equivalent to a ¼ wavelength impedance transformer matching circuit. Thus, the plural oscillators are able to supply electric power to the load without mutual interferences and the system is able to supply much power.

The specific sizes and capacities regarding to the system of this example are described below. The high frequency wave “47” has a frequency of 2.45 GHz. The electromagnetic mode is TM11. The maximum power of the wave is 1 kW. The high frequency wave coupling portion “42” is connected with the dielectric container Va “40” at the opening portion, which has a width of 70 mm, a height of 130 mm. The dielectric outer container Va “40” is formed of the quartz tube “54”, which has an outer diameter of 150 mm, a thickness of 3 mm and a length along Z axis of 200 mm, and the PTFE fluorine rosin membrane layer “53”, which has a thickness of 4 mm and covers the outer side face of the quartz tube “54”. The dielectric inner container Vbn “41” is formed of an inner container quartz tube “55”, which has an outer diameter of 115 mm, a thickness of 3 mm, and a length along Z axis of 200 mm. The aluminum covering conductive material “43” is formed of an aluminum plate with a thickness of 0.5 mm. Aluminum container walls “59” has a thickness of 20 mm and an outer diameter of 200 mm and is disk-shaped. The downside container wall “59” has a hole, which is closed by the door sample stage, with a diameter of 100 mm in the center of the wall. The vacuum exhausting port “56” is a tube with an inner diameter of 20 mm and an outer diameter of 1 inch. The port “56” is connected with a vacuum pipe with a joint and sealed with an O-ring. The cooling medium leading passage “71” is connected with a joint for ¼ inch gas pipe and supplies dry air for cooling at 30 psi.

A test example of plasma generation in this example is explained below. In a vacuum condition, a gas pressure was between 13 Pa and 1000 Pa. Led gas was N2, O2 and mixed gas of them. A gas current was between 50 cc/min and 300 cc/min. Two microwave electric power supplies were used. An electric power per one supply was 50 W-1000 W. A rotary pump with an engine displacement of 1000 L/min was used for vacuum exhausting system. A Pirani vacuum gauge was located on a vacuum exhausting line for measurement of vacuum. Hand-operating valves were located on vacuum exhausting line for pressure adjustment. In the condition described above, plasma discharge was caused instantly after supplying power. The ionized gas plasma was an emitting plasma uniform in the whole vacuum container. The magnetron oscillator did not have any trouble after a long operation of more than 1000 hours.

A test example on processing efficiency in the example is explained below. Object was organic photo resist with a thickness of 2 μm, which covered on the silicone basis with an area of 20 cm2. In the condition of the process, the basis was kept at normal temperature. The microwave power was 500 W. O2 was led for the process at 100 cc/min. The gas pressure was 150 Pa. The period of the process was 20 sec.

In this example, a detachment rate of the resist was 2.6 μm/min. The temperature of the basis measured after process was about 60° C., the organic material was quickly detatched without increasing the temperature of the basis.

If a common organic material detachment apparatus is used, a detachment rate increases with increase of the temperature of the basis. The detachment rate cannot be achieved more than 1 μm/min, unless the basis is heated at more than 140° C., which is a gas transformer point of the organic resist membrane. It is concluded that the temperature of the basis did not increase and the detachment rate was high because high dense excited plasma was generated on the plasma border plane “16” in the neighbor of the inner wall of the inner container Vbn “41”.

Quartz was used for a material of the dielectric inner container Vbn “41” in this example. Other dielectric materials with low dielectric constants also can be used. For example, all alumina-based ceramics can be used. All of dielectric material with a low dielectric constant can be used for the dielectric outer container Va “40”. Moreover, the outer container can be composed of plural different dielectric layers.

In this example, a quartz tube “54” is covered with a PTFE fluorine rosin membrane layer “53” and used as the dielectric outer container Va “40”. The function of the dielectric transmission surface can be made better by tuning a dielectric constant of the fluorine rosin layer so that the layer could have a depletion layer with a proper void constant. A quartz tube “54” covered with multilayer of thin mica film can alternatively be used. Porous ceramics can be used for the dielectric outer container Va “40” for the same purpose.

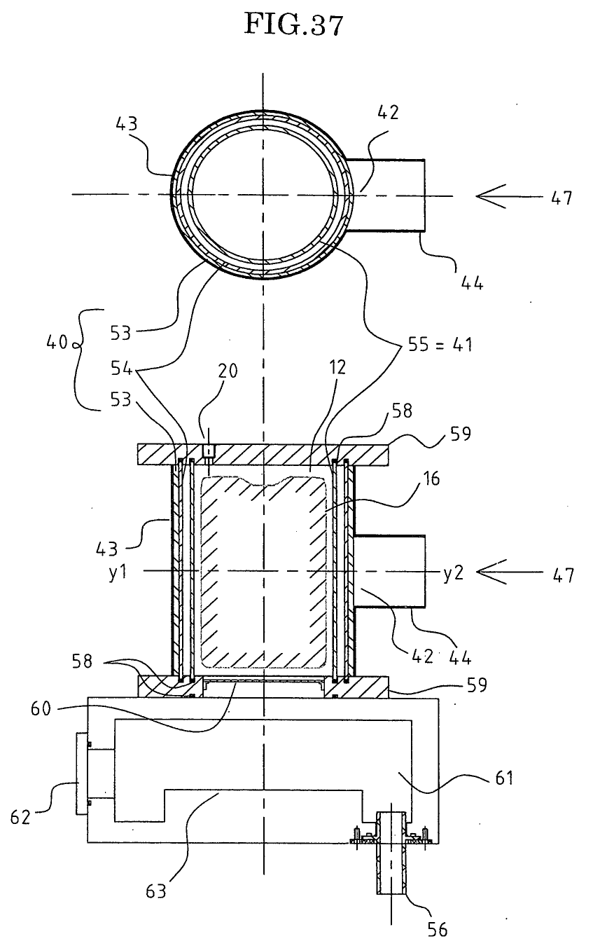

The second example shown in FIG. 37 is explained below. FIG. 37 shows a vertical sectional view and a horizontal sectional view on y1-y2 of a discharge portion of a high frequency wave ionized gas plasma generating system in the second example of the present invention.

This example is a modification of the first example. Shown in FIG. 37, the vacuum container “12”, which functions as an ionized gas plasma discharge portion, is composed of a cylindrical quartz tube “55” as the dielectric inner container, and upper side and down side aluminum vacuum container walls “59”. The vacuum container “12” is connected with a down flow processing chamber container “61” at the downside aluminum vacuum container wall. Thus, the whole container is formed.

High frequency wave ionized gas plasma with a plasma border plane “16” is separated from the down flow processing chamber “61” by a porous conductive plate “60”. In this example, the plasma discharge system is used as a plasma source of the plasma radical down flow processing system.

The process to radical surface treatment by the system is explained below. At first, an object is inserted through a door “62” to the down flow processing chamber “61” and placed on a sample stage “63”. After the door is closed, the chamber is vacuumed with the vacuum exhausting port “56” and gas for plasma is led through the processing gas leading passage “20” with controlling of the flow. Ionized gas plasma is formed in the vacuum container “12” by oscillation of a high frequency wave “47”. Generated reactive species are transported through pores of a porous conductive plate “60” along a vacuum direction toward the down flow processing chamber “61” and the radical surface treatment is carried out.

The structure of the vacuum container “12”, which functions as a discharge portion, is same as the one in the first example except the vacuum exhausting port. Though a single high frequency wave transmission waveguide “44” is located as shown in FIG. 37, plural waveguides can be located.

The specific sizes and capacities regarding to the system of this example are described below. The frequency of the high frequency wave “47” is 2.45 GHz. The electromagnetic mode is TM11. The maximum power of the wave is 1 kW. The high frequency wave coupling portion “42” is connected with the dielectric container Va “40” at the opening portion, which has a width of 70 mm, a height of 130 mm. The dielectric outer container Va “40” is formed of a quartz tube “54”, which has an outer diameter 150 mm, a thickness of 3 mm and a length along Z axis of 200 mm, and a PTFE fluorine rosin membrane layer “53”, which has a thickness of 4 mm and covers the outer side face of the quartz tube “54”. The dielectric inner container Vbn “41” is formed of a quartz tube “55”, which has an outer diameter of 115 mm, a thickness of 3 mm, and a length along Z axis of 200 mm. The aluminum covering conductive material “43” is formed of an aluminum plate with a thickness of 0.5 mm. The aluminum vacuum container walls “59” has a thickness of 20 mm, an outer diameter of 200 mm and is disk-shaped. The vacuum container walls “59” has holes with a diameter of 100 mm and connected with the aluminum down flow processing chamber container “61” with an O-ring seal. The porous conductive plate “60”, which is made of stainless, with a thickness of 2 mm, a diameter of 100 mm and mesh with 30% opening, is set on the hole with a diameter of 100 mm in the middle of the downside vacuum container wall. Ionized gas plasma, which is generated in the vacuum container, is separated from the down flow processing chamber container “61” by the porous conductive plate. The vacuum exhausting port “56” is a tube with an inner diameter of 20 mm and an outer diameter of 1 inch. The port “56” is connected with a vacuum pipe with a joint and sealed with an O-ring. The cooling medium leading passage “71” is connected with a joint for a ¼ inch gas pipe and supplies dry air for cooling at 30 psi.

In this example, a state of the operation for ionized gas plasma discharge and an impedance matching are same as the ones in the first example. A test example of plasma generation in this example is same as the one of the first example described above.

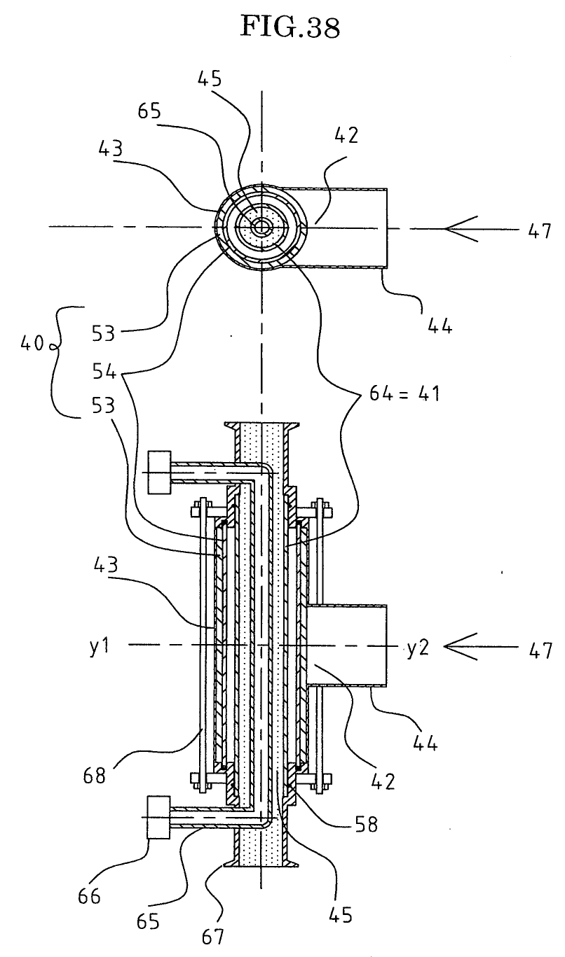

The third example shown in FIG. 38 is explained below. FIG. 38 shows a vertical sectional view and a horizontal sectional view on y1-y2 of a discharge portion of a high frequency wave ionized gas plasma generating system in the third example of the present invention.

Shown in FIG. 38, The high frequency wave “47” is oscillated from the microwave oscillator and guided through the high frequency wave transmission waveguide “44” into the discharge portion of the system of the present invention. An ionized gas plasma generating region “45” is formed as a vacuum plasma discharge portion. A cylindrical ceramics tube “64” as the dielectric inner container Vbn “41” is closed with stainless vacuum connecting flanges “67” fixed respectively on upper and down portions of tube with volts “68”, and sealed with the O-rings “58”. The vacuum connecting flange “67” on one side is connected with vacuum apparatuses. The gas for plasma flows through the other vacuum connecting flange “67” on the opposite side to the vacuum apparatuses. A stainless water cooling tube “15” is inserted in the center of the ionized gas plasma generating region “45”. A water cooling tube “65” is located through the side face of the vacuum connecting flange “67” and connects with a cooling joint “66”. Cooling water flows through the tube. The vacuum connecting flange “67” contacts to the outer face of the penetrating stainless water cooling tube with being sealed with a weld or an O-ring.

In order to cause a plasma decomposition of fluorine-containing gas and generate many fluorine radicals, the processing system is connected with vacuum apparatuses for decomposition of fluorine-containing gas and provision of fluorine radicals.

Shown in FIG. 38, a state of the operation for the ionized gas plasma discharge and a impedance matching in this example are same as the one in the first example.

The specific sizes and capacities regarding to the system of this example are described below. The frequency of the high frequency wave “47” is 2.45 GHz. The electromagnetic mode is TM11. The maximum power of the wave is 1 kW. The high frequency wave coupling portion “42” is connected with the dielectric container Va “40” at the opening portion, which has a width of 70 mm and a height of 130 mm. The dielectric outer container Va “40” is formed of a quartz tube “54”, which has an outer diameter of 100 mm, a thickness of 3 mm and a length along Z axis of 200 mm, and a PTFE fluorine rosin membrane layer “53”, which has a thickness of 4 mm and covers the outer side face of the quartz tube “54”. The dielectric inner container Vbn “41” is formed of the inner ceramics tube “64” made of high-purity alumina, which has an outer diameter of 50 mm, a thickness of 3 mm, and a length along Z axis 200 mm. The aluminum covering conductive material “43” is formed of aluminum plate with a thickness of 0.5 mm. The stainless vacuum connecting flange “67” is composed of the inner container ceramics tube “64” with an outer diameter of 60 mm and the NW50 vacuum flange portion. The both end portions of the flange can connect with vacuum apparatuses. The stainless water cooling tube “65”, of which an outer diameter is ⅜ inch, is located to penetrate the discharge portion and is connected with a NW50 vacuum flange portion with being sealed.

Modifications of the embodiment are explained below.

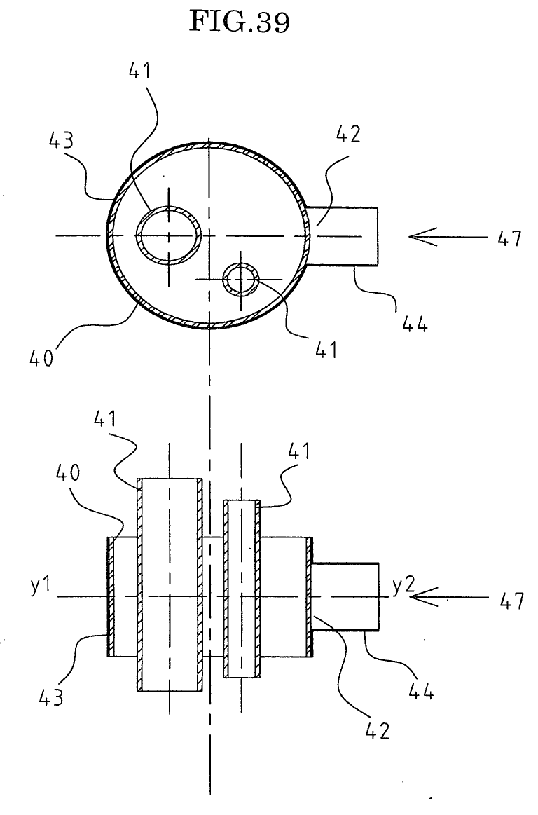

Shown in FIG. 39, a structure described below can be adopted in a modification of the first example. In the structure, two or more inner containers Vbn “41”, of which cavities are not duplicated, are located.

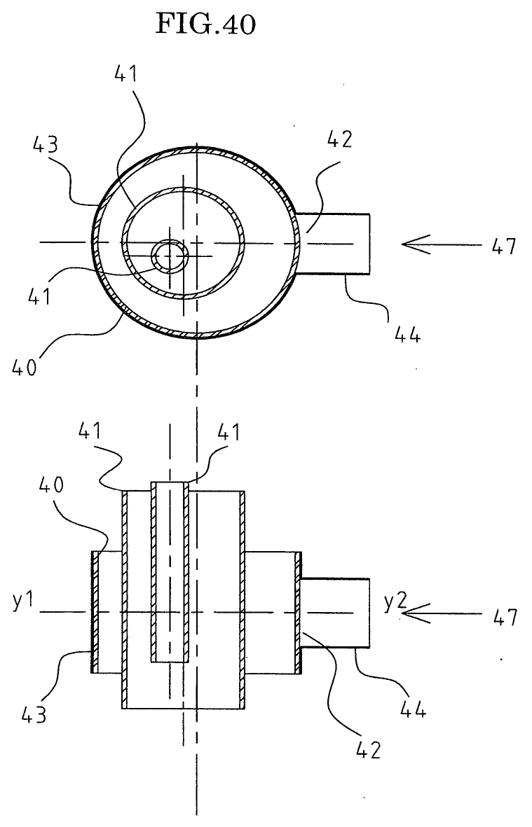

Shown in FIG. 40, a structure described below can be adopted in a modification of the first example. In the structure, two or more inner containers Vbn “41”, of which cavities are duplicated without touching the inner face of the walls mutually, are located in a modification of the first example.

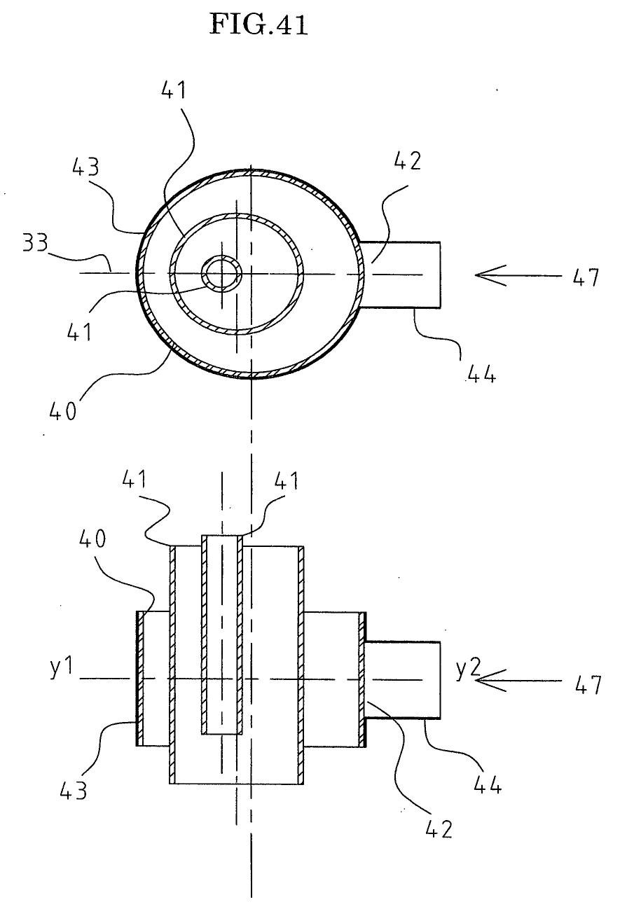

Shown in FIG. 41, a structure described below can be adopted in a modification of the first example. In the structure, two or more inner containers Vbn “41”, of which symmetry axis planes are same, are located in a modification of the first example.

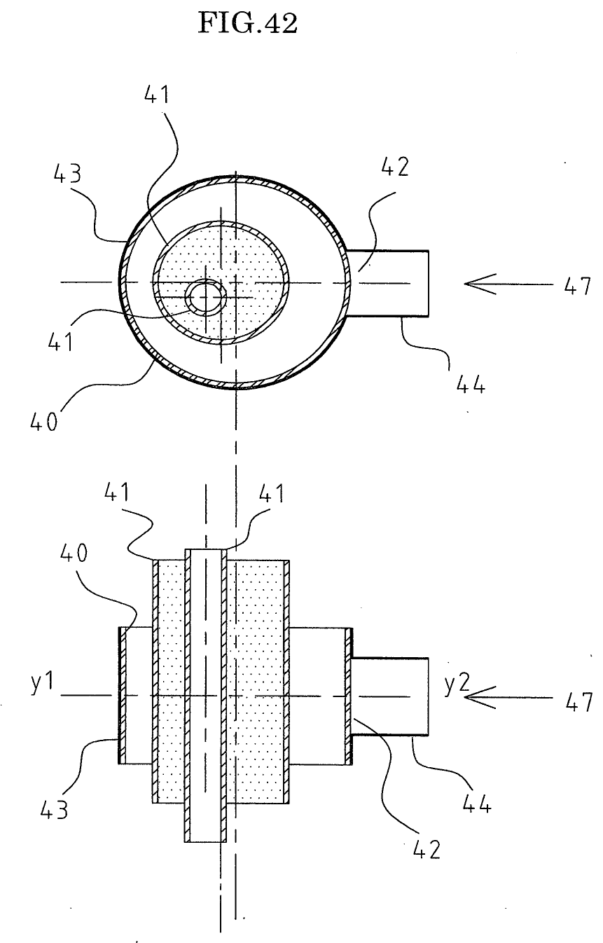

Shown in FIG. 42, a structure described below can be adopted in a modification of the first example. In the structure, two or more inner containers Vbn “41” are located and only a region, which is between an inner outline of an inner container Vb1 and an outer outline of an inner container Vb2, is vacuumed in a modification of the first example. The outlines are on the sections of the inner containers Vbn crossed by plane Sx1 “46”.

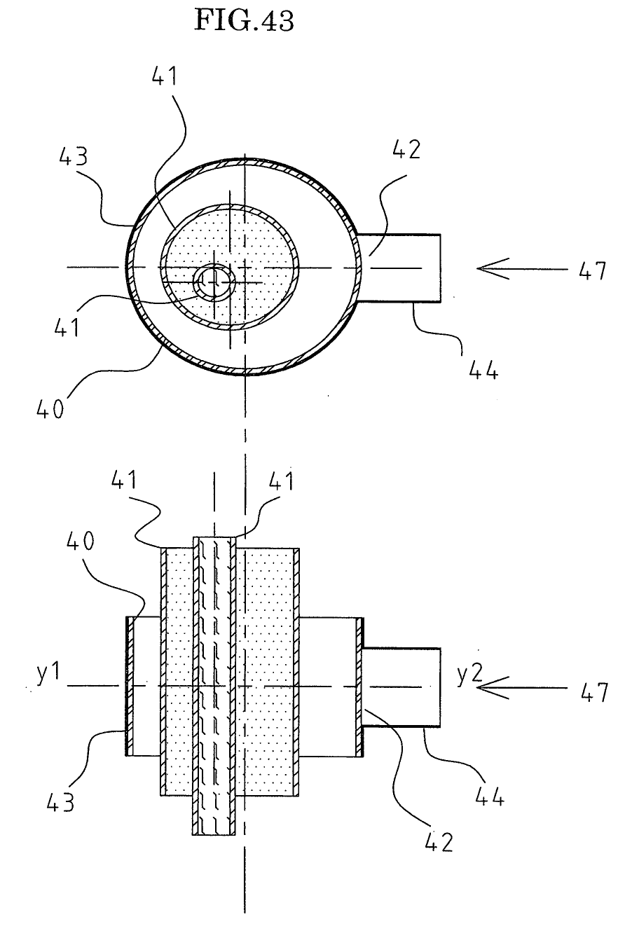

In a modification of the example described above, a structure described below can be adopted as shown in FIG. 43. In the structure, cooling medium like cooling liquid flows in the most inside inner container Vbn “41”.

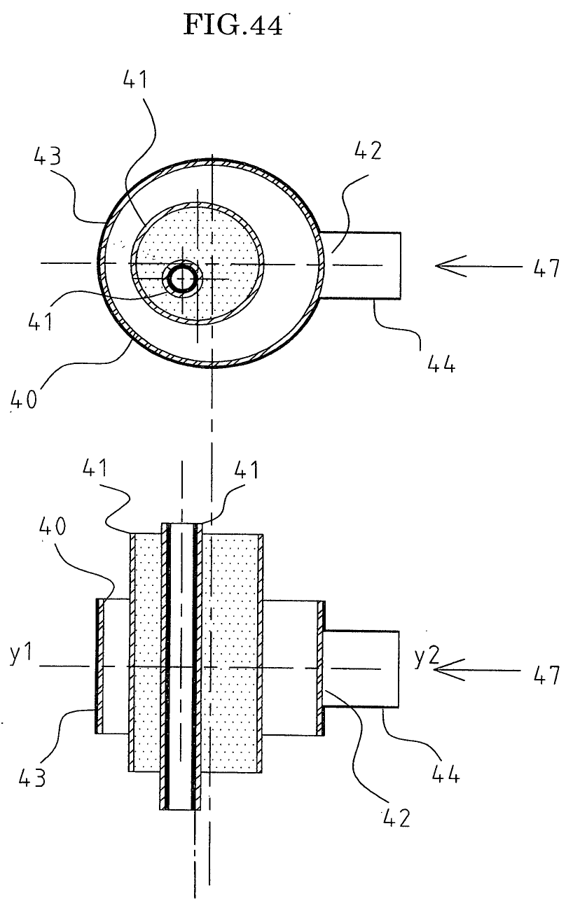

In a modification of the example described above, a structure described below can be adopted as shown in FIG. 44. In the structure, an inside portion of the most inside inner container Vbn “41” is covered with a conductive material.

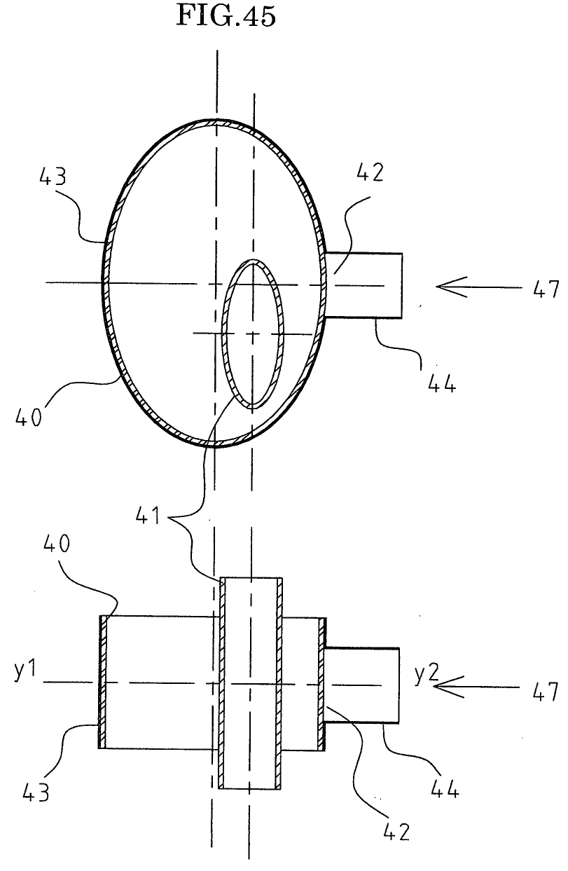

A structure described below can be adopted in a modification of the first example shown in FIG. 45. In the structure, the symmetry axis plane Sz1 “32” is parallel to the symmetry axis plane Sz2 “33”.

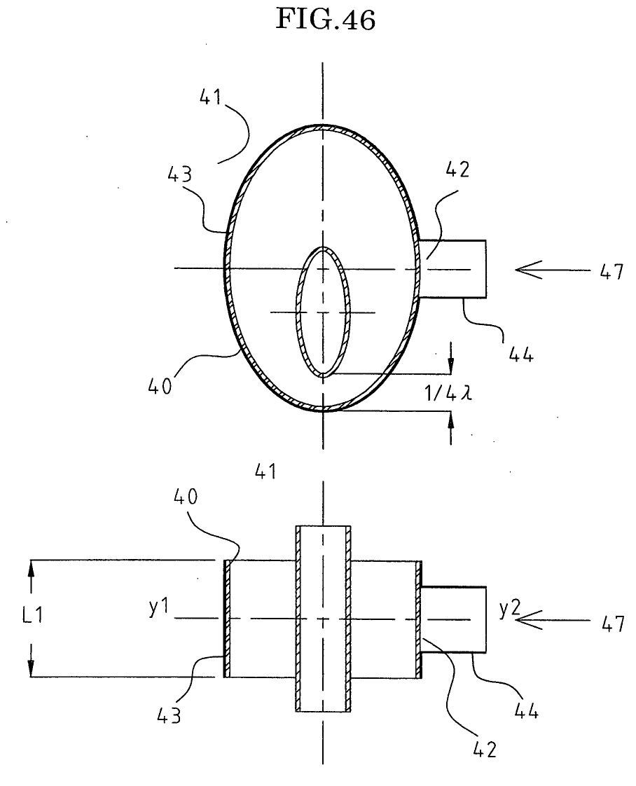

A structure described below can be adopted in a modification of the first example shown in FIG. 46. In the structure, the symmetry axis plane Sz1 “32” is equal to the symmetry axis plane Sz2 “33” and the shortest distance between any point of the outer side face of the outer container Va “40” and the inner face of the inner container Vbn “41”, which encloses the ionized gas plasma region, is an integer times ¼ of the wavelength of the guided high frequency wave and the distance L1 along Z axis is an integer times ¼ of the wavelength of the guided high frequency wave.

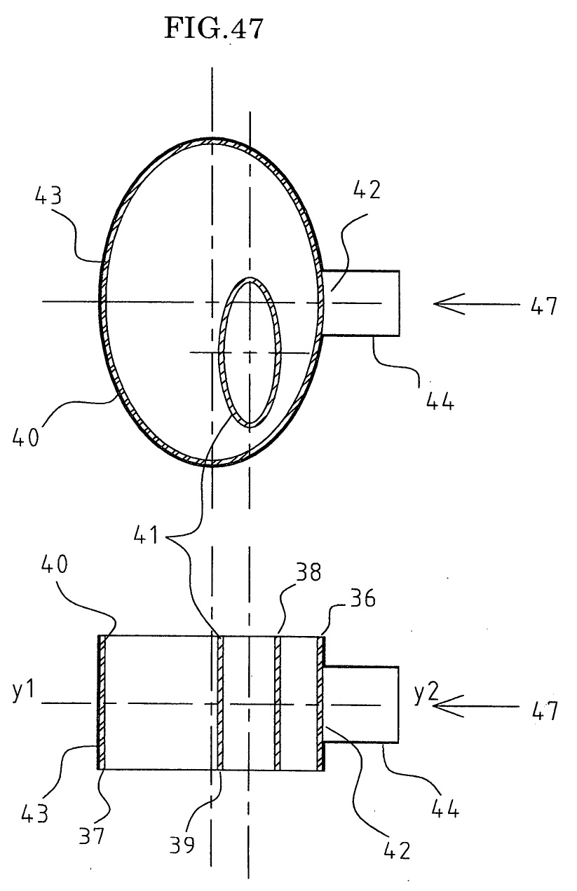

A structure described below can be adopted in a modification of the first example shown in FIG. 47. In the structure, a1 and b1 or a2 and b2 are on a common plane. a1 “36” is an end face or an end point of the outer container Va “40”. So is a2 “37”. b1 “38” is an end face or an end point of the inner container Vbn. So is b2 “39”.

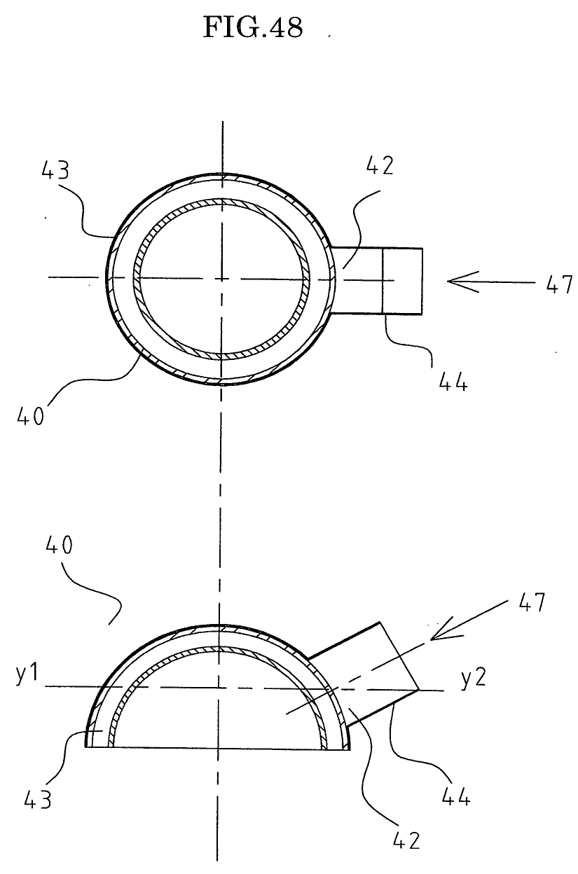

A structure described below can be adopted in a modification of the first example shown in FIG. 48. In the structure, an outer outline of the section of the outer container Va “40” crossed by a symmetry axis plane Sz1 “32” is a circle, an ellipse or a portion of the ones.

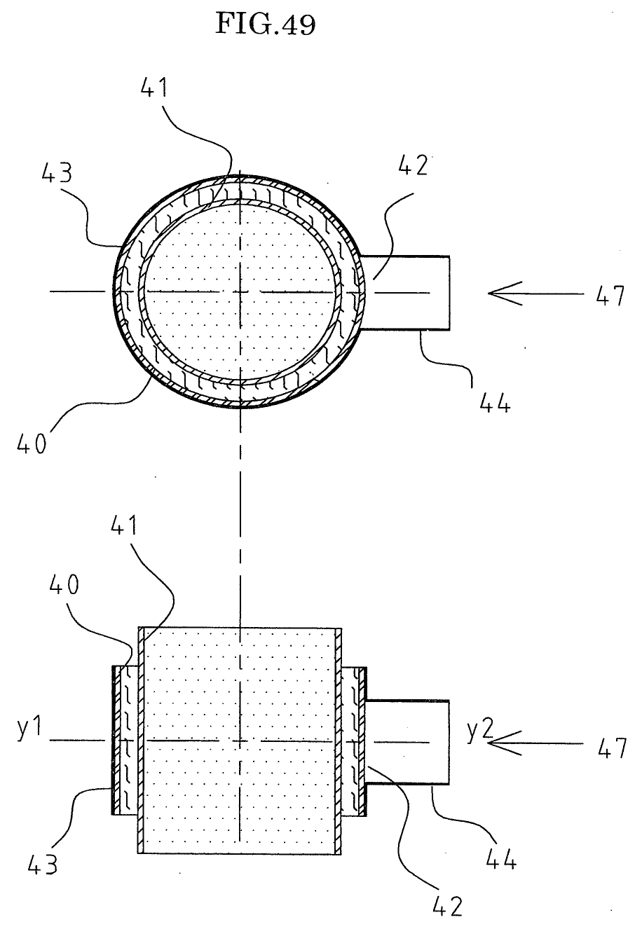

A structure described below can be adopted in a modification of the first example shown in FIG. 49. In the structure, gas or liquid with a low dielectric constant continuously flows in a region between an inner side face of the outer container Va “40” and an outer side face of the inner container Vbn “41”, which forms an outer face of an ionized gas plasma region, for the purpose of cooling.

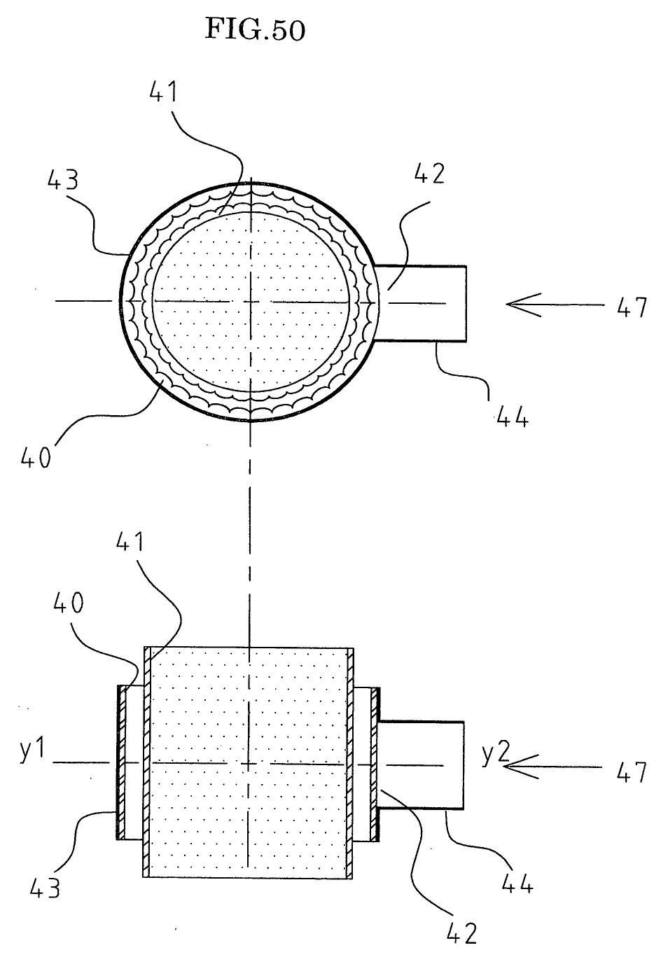

A structure described below can be adopted in a modification of the first example shown in FIG. 50. In the structure, an inner surface of the outer container Va “40” is made uneven-shaped for refraction of the electromagnetic wave and an outer surface of the inner container Vbn “41”, which encloses an ionized gas plasma region, is made uneven-shaped for refraction of the electromagnetic wave.

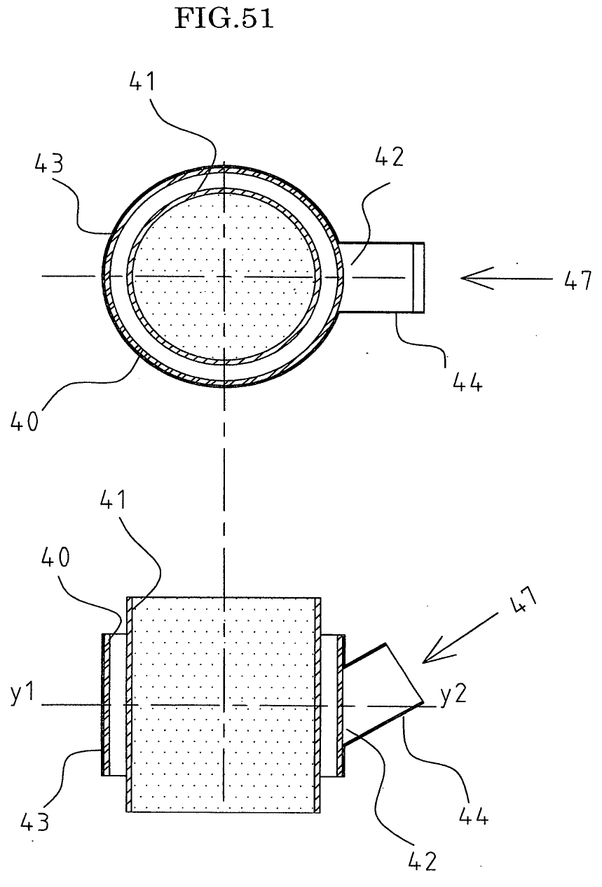

A structure described below can be adopted in a modification of the first example shown in FIG. 51. In the structure, a progressing direction of high frequency waves oscillated by the oscillator forms an angle optionally selected except 0 degree with Z axis of an outer side face of the outer container Va “40”,and a dielectric face of the high frequency wave coupling portion is not parallel to the direction that the electromagnetic wave oscillated by high frequency oscillator progresses, and the dielectric face forms a termination portion of the waveguide, and, at least, a portion of the termination is formed with the outer container Va “40” itself or the dielectric material contacting the outer container Va “40”.

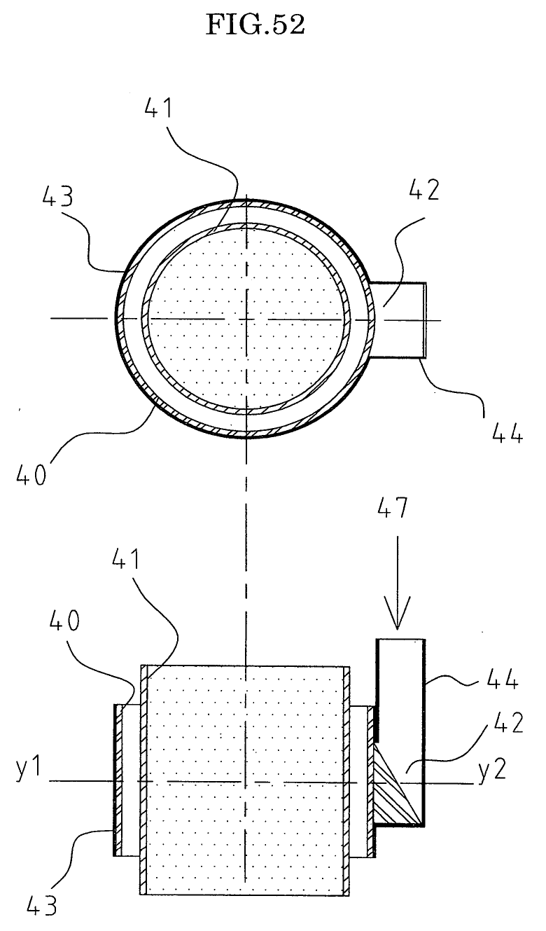

A structure described below can be adopted in a modification of the first example shown in FIG. 52. In the structure, the direction that the electromagnetic wave oscillated from a high frequency oscillator progresses is parallel to Z axis of the outer side face of the outer container Va “40”, and a dielectric face of the high frequency wave coupling portion is not parallel to the direction that the electromagnetic wave oscillated from the high frequency oscillator progresses, and the dielectric face forms the termination portion of the waveguide and, at least, a portion of the termination is formed by the outer container Va “40” itself or the dielectric material contacting the outer container Va “40”.

The high frequency reaction processing system of the second example is explained below.

As a specific example of the second embodiment, the fourth to the sixth examples and modifications of them are explained below.

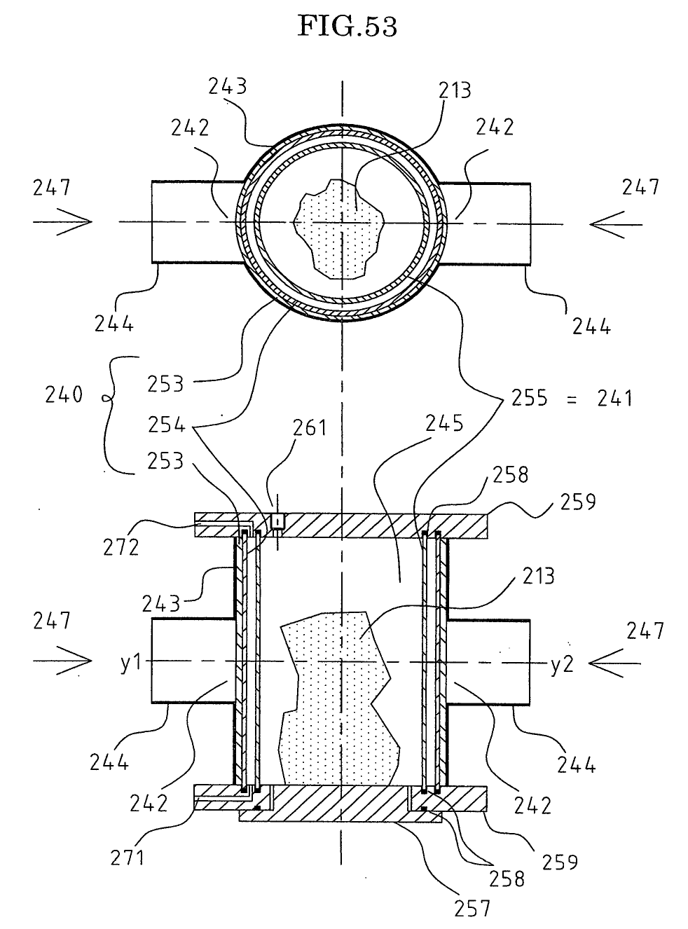

FIG. 53 shows a vertical sectional view and a horizontal sectional view on y1-y2 of a microwave reaction processing portion in the fourth example of the present invention.

Shown in FIG. 53, the high frequency waves “247” are oscillated from two microwave oscillators and respectively guided through waveguides “244” into a reaction processing portion of the system of the present invention. The processing container is composed of a cylindrical quartz tube “255” as the dielectric inner container Vbn “241” and an aluminum door sample stage “257” and sealed with an O-ring “258”. One or more gas exhausting port “261” is located on a container wall “259”, if the process needs gas exhausting. The gas exhausting port can be the gas leading port according to the process.

In the processing system, a solid object “213”, which is not conductive, is placed on the door sample stage “257” After that, the door sample stage “257” is raised and connected with the downside container walls “259” and sealed with the O-ring. The high frequency electromagnetic wave, which progresses along the high frequency wave progressing direction “247”, is guided and a necessary reaction is caused by exciting the object “213”. In the reaction that the gas contacts the solid, the gas for reaction is led through the gas leading port “261” and contacts the object “213”,and the process is carried out.

A high frequency wave transmission waveguide “244” is connected with the outer side face of the dielectric outer container Va “240”. The dielectric outer container Va “240” is formed with a quartz tube “254”, of which side face is covered with a fluorine rosin film layer “253”. The outer side face of the fluorine rosin film layer “253” except a portion connected with the high frequency wave transmission waveguide “244” is covered with the conductive material “243” that is aluminum and keeps same potential as the high frequency wave transmission waveguide “244”. Moreover, the covering conductive material “243” is electrically connected with aluminum vacuum container walls “259”.

In this example, the dielectric inner container Vb “241” is coaxially located in the dielectric outer container Va “240” so that the distance between the inner side face of the dielectric inner container Vb “241” and the outer side face of the fluorine rosin membrane layer “253” of the dielectric outer container Va “240” should be ¼ of the wavelength of the guided high frequency wave.

In the high frequency reaction processing system, on the purpose to cool the dielectric outer container Va “240” and the dielectric inner container Vb “241”, gas or liquid with a low dielectric constant flows into a region between the dielectric outer container Va “240” and the dielectric inner container Vb “241” from a cooling medium leading passage “271” and flows out through a cooling medium exhausting passage “272” on the vacuum container upper side wall “259”.

The high frequency wave “247” travels through the high frequency wave coupling portion “242”, which connects the high frequency wave transmission waveguide “244” with the dielectric outer container Va “240”, on the dielectric outer container Va “240”, a transmission surface. Commonly, the direction of the electric field depends on the electromagnetic wave mode of the high frequency wave “247”. The electromagnetic wave travels along the circumference direction of the cylindrical dielectric outer container Va “240”. Namely, the electromagnetic wave travels on the side face of the tube along the loop, an infinitely long dielectric transmission surface, by using TM11 mode in this example.

The length of the inner outline of the horizontal section of the dielectric outer container Va “240” is integer times ¼ of the wavelength of the guided high frequency wave. Thus the high frequency wave “247”, which travels along the circumference direction of the dielectric outer container Va “240”, a dielectric transmission surface, causes a transmission surface resonance. The outer side face of the dielectric outer container Va “240” is covered with the covering conductive material “243”. Thus, the electromagnetic wave cannot leak outside and surface waves forming the leaked electric field are generated in a wide rang along the radius direction of the dielectric outer container Va “240”. The covering conductive material “243” keeps the ground potential. Thus, many intense points of the electric field are on a loop in a wide range at every ¼ of the wavelength of the guided surface wave.

The side face of the dielectric inner container Vb “241”, which forms the wall of the processing container, is formed on the looped high electric field point. Thus, the dielectric inner container Vb “241” becomes a dielectric transmission surface by guiding the high frequency wave “247” and the infinitely long dielectric transmission surface is formed along the container wall.

If an electromagnetic wave enters from medium with a high dielectric constant to medium with a low dielectric constant at an angle of incidence over a certain value, a grazing incidence occurs. Therefore, a portion of the electromagnetic wave reflects on the inner side face of the inner container Vb “241”. Thus, consequently, a portion of the surface wave is absorbed in the inner container Vb “241” and the other portion is reflected on the inner side face of the inner container Vb “241”. The reflected wave travels mutually in the dielectric outer container Va “240” covered with the covering conductive material “243” and the region formed by a plasma border plane. An impedance of the high frequency wave transmission surface in this region changes with following the impedance of the load. The transmission surface is a ¼ wavelength impedance transformer matching circuit. Therefore, the impedance matching occurs between the transmission surface and the load. Finally, the energy of electromagnetic waves are efficiently absorbed to the plasma load.

Thus, the reflected wave cannot return to the high frequency wave transmission waveguide “244”, the system is in non-reflection state in viewing the load from the oscillator.

The whole processing container has a structure of a cylinder cavity resonator and can have a structure of a dielectric resonator. Therefore, electric power is efficiently absorbed at the load.

Shown in FIG. 53, even if the high frequency wave “247” is guided through the plural high frequency wave transmission waveguide “244”, the standing wave is enclosed in a region equivalent to a ¼ wavelength impedance transformer matching circuit. Thus, the plural oscillators are able to supply electric power to the load without mutual interferences and the system is able to supply much power.

The specific sizes and capacities regarding to the system of this example are described below. The high frequency wave “247” has a frequency of 2.45 GHz. The electromagnetic mode is TM11. The maximum power of the wave is 1 kW. The high frequency wave coupling portion “242” is connected with the dielectric container Va “240” at the opening portion, which has a width of 70 mm, a height of 130 mm. The dielectric outer container Va “240” is formed of a quartz tube “254”, which has an outer diameter of 150 mm, a thickness of 3 mm and a length along Z axis of 200 mm, and a PTFE fluorine rosin membrane layer “253”, which has a thickness of 4 mm and covers the outer side face of the quartz tube “254”. The dielectric inner container Vb “241” is formed of a quartz tube “255”, which has an outer diameter of 115 mm, a thickness of 3 mm, and a length along Z axis of 200 mm. The aluminum covering conductive material “243” is formed of aluminum plate with a thickness of 0.5 mm. The aluminum container walls “259” has a thickness of 20 mm, an outer diameter of 200 mm and is disk-shaped. The downside container wall “259” has a hole, which is closed by the door sample stage, with a diameter of 100 mm in the center of the wall. The cooling medium leading passage “271” is connected with a joint for a ¼ inch gas pipe and supplies dry air for cooling at 30 psi.

Quartz was used for the material of the dielectric inner container Vb “241” in the example described above. The other dielectric material with a low dielectric constant also can be used. For example, all alumina-based ceramics can be used. All of dielectric material with a low dielectric constant can be used for the dielectric outer container Va “240”. Moreover, the outer container can be composed of plural different dielectric layers.

In this example, a quartz tube “254” is covered with a PTFE fluorine rosin membrane layer “253” and used as the dielectric outer container Va “240”. The function of the dielectric transmission surface can be made better by tuning a dielectric constant of the fluorine rosin layer so that the layer could have a depletion layer with a proper void constant. A quartz tube “254” covered with a multilayer of thin mica films can alternatively be used. Porous ceramics can be used for the dielectric outer container Va “240” for the same purpose.

Object can be solid, liquid, gas and mixture of them, which is not conductive.

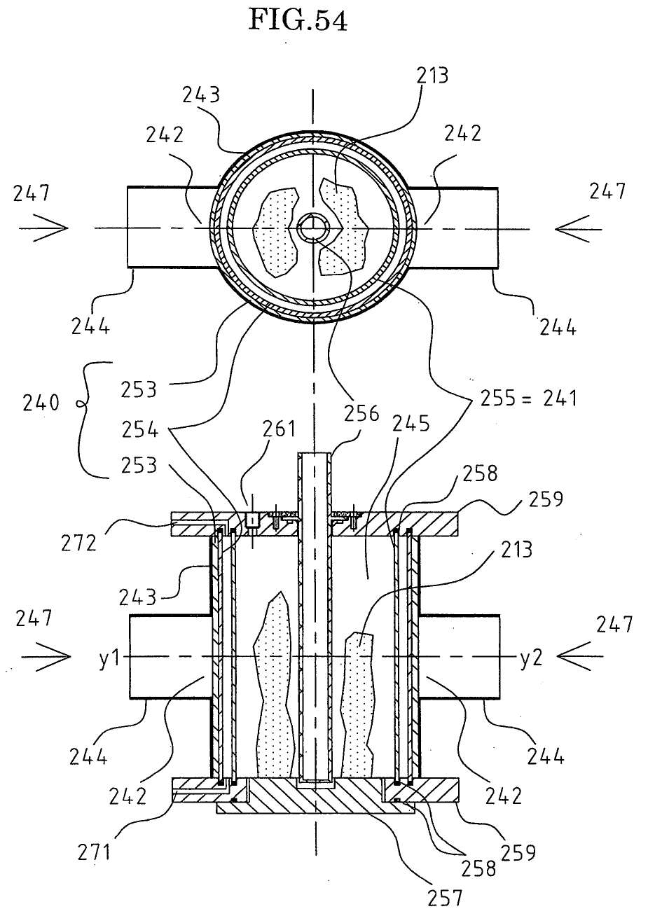

The fifth example shown in FIG. 54 is explained below. FIG. 54 shows a vertical sectional view and a horizontal sectional view on y1-y2 of a microwave reaction processing portion in the fifth example of the present invention.

This example is a modification of the fourth example. Shown in FIG. 54, a conductive tube which is formed as a inner container Vc “256” is located in the inner container Vb “241” without contacting the inner face of the inner container Vb “241”. A reaction processing region “245” is formed in the region between the inner container Vb “241” and the inner container Vc “256”.

Since the inner container Vc “256” is kept at an electric ground potential of the guided high frequency wave, the reaction processing region “245” becomes a termination reflection end of the high frequency wave guided into the inner container Vb “241”. Since an electromagnetic wave reflects on the border as if reflection occurred on a metallic face in the case that an electromagnetic wave enters from medium with a high dielectric constant to medium with a low dielectric constant at a proper angle of incidence, a reflected wave generated on the inner container Vc “256” progresses through the region between the inner container Vb “241” and the inner container Vc “256”, a reaction processing region. Then, the wave is reflected again on the inner container Vb “241” and circulates along the circumference direction in the region with reflections. Thus, the efficiency of energy absorption to the load increases in the reaction processing region.

A heat source like a resistance heater or a cooling source like a source with cooling medium can be set in the inner container Vc “256” and used for control of temperature in the reaction processing region in the reaction process.

The specific sizes and capacities regarding to the system of this example are described below. The inner container Vc “256” is a stainless tube with a length of 250 mm, an inner diameter of 20 mm and an outer diameter of 1 inch. The inner container Vc “256” is held with alumina container walls “259”. The other structure is same as the fourth example described above.

The operation state of the reaction system shown in FIG. 54 in this example is same as the one in the first example. Object can be solid, liquid, gas and mixture of them, which is not conductive.

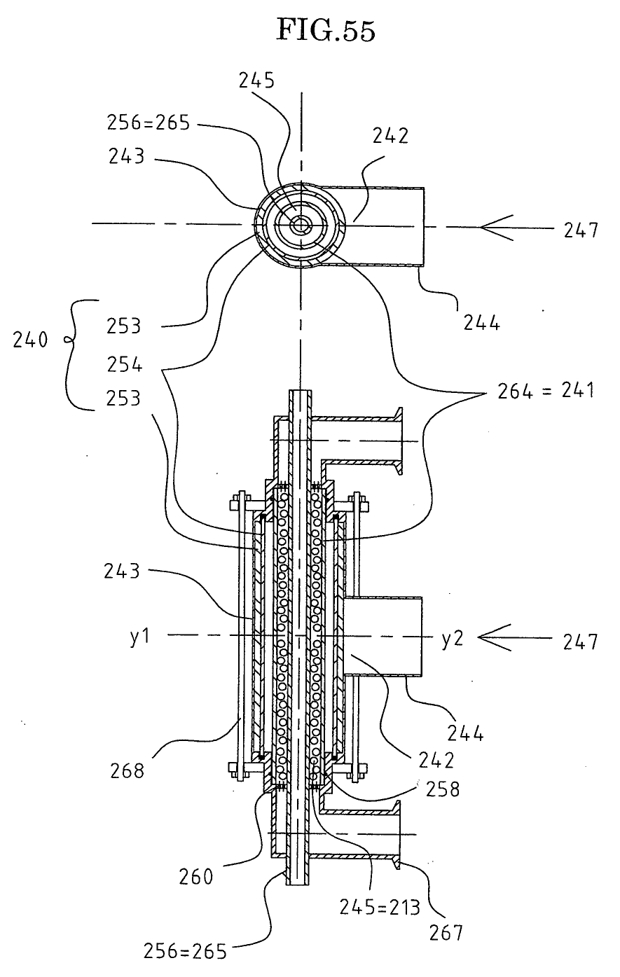

The sixth example shown in FIG. 55 is explained below. FIG. 55 shows a vertical sectional view and a horizontal sectional view on y1-y2 of a microwave reaction processing portion in the sixth example of the present invention.

Shown in FIG. 55, The high frequency wave “247” is oscillated from the microwave oscillator and guided through the high frequency wave transmission waveguide “244” into the reaction processing portion “245” of the system of the present invention. The reaction processing portion is formed as a cylindrical inner container ceramics tube “264” for the dielectric inner container Vb “241” is closed with a stainless vacuum connecting flanges “267” fixed respectively on upper and down portions of the tube with volts “268”, and sealed with the O-ring “258”. A member with a large specific surface area is placed in the reaction processing region and enclosed with a porous conductive plate “260” so that the gas could pass. Reactive gas or mixed gas is provided through the connecting flange “267” on one side. The member is, for example, materialic with a porous surface such as a layer of ceramics balls. The surface of the porous dielectric solid member, which is inserted into the reaction processing portion “245”, is used as a contact surface of reaction. A stainless water cooling tube “265” as the inner container Vc “256” is inserted in the center of the inner container Vb “241”. Cooling water flows through the water cooling tube “265” to control a reaction rate.

The processing system is mainly for the purpose of the decomposition and composition of provided reaction gas and the gas absorption to the sample.

The specific sizes and capacities regarding to the system of this example are described below. The frequency of the high frequency wave “247” is 2.45 GHz. The electromagnetic mode is TM11. The maximum power of the wave is 1 kW. The high frequency wave coupling portion “242” is connected with the dielectric container Va “240” at the opening portion, which has a width of 70 mm, a height of 130 mm. The dielectric outer container Va “240” is formed of a quartz tube “254”, which has an outer diameter of 100 mm in, a thickness of 3 mm and a length along Z axis of 200 mm, and a PTFE fluorine rosin membrane layer “253”, which has a thickness of 4 mm and covers the outer side face of the quartz tube “254”. The dielectric inner container Vb “241” is formed of an inner ceramics tube “264” made of high-purity alumina, which has an outer diameter of 50 mm, a thickness of 3 mm, and a length along Z axis of 200 mm. The aluminum covering conductive material “243” is formed of aluminum plate with a thickness of 0.5 mm. The stainless vacuum connecting flange “267” is composed of a coupling portion of a ceramics tube “264” with an outer diameter of 60 mm and a NW50 connecting flange portion. The both end portions of the flange can be connected with outer pipes. The stainless water cooling tube “265” with an outer diameter of ⅜ inch as the inner container Vc “256” is located to penetrate the processing portion. Cooling water flows through a water cooling tube. A region between the inner container Vb “241” and the inner container Vc “256” is enclosed with two punched aluminum plates, which have thicknesses of 3 mm and 35% openings as the porous conductive plates “260”, and forms the reaction processing portion “245”. In the region, aluminum balls, which have diameters of 3 mm and have been treated to support nickel-containing catalyst, are placed. Other porous ceramics or porous ceramics with catalysts can be used as a catalyst material. If the catalyst material is placed in the load and a microwave is radiated to the load with flowing gas or liquid, the catalyst material is able to be used for substance decomposition or substance transformation, such as toxic substance decomposition, detrimental object decomposition, deodorization processing, or scrubbing processing. As reaction gas, hydrogen gas is supplied through the connecting flange “267” on one side in pressure 15 Psi, and is exhausted through the opposite side.

The operation state of the reaction system shown in FIG. 55 in this example is same as the one in the first example. Object can be solid, liquid, gas and mixture of them, which is not conductive. The object can include metallic catalyst.

High-purity ceramics was used for the material of the dielectric inner container Vbn “241” in this example. Other ceramics also can be used. All of dielectric material with a low dielectric constant can be used for the dielectric outer container Va “240”. Moreover, the outer container can be composed of plural different dielectric layers.

In this example, quartz tube “254” covered with PTFE fluorine rosin membrane layer “253” is used as the dielectric outer container Va “240”. The function of the dielectric transmission surface can become better by tuning the dielectric constant of fluorine rosin layer. Porous ceramics can be used for the dielectric outer container Va “240” for the same purpose.

Modifications of the embodiment are explained below.

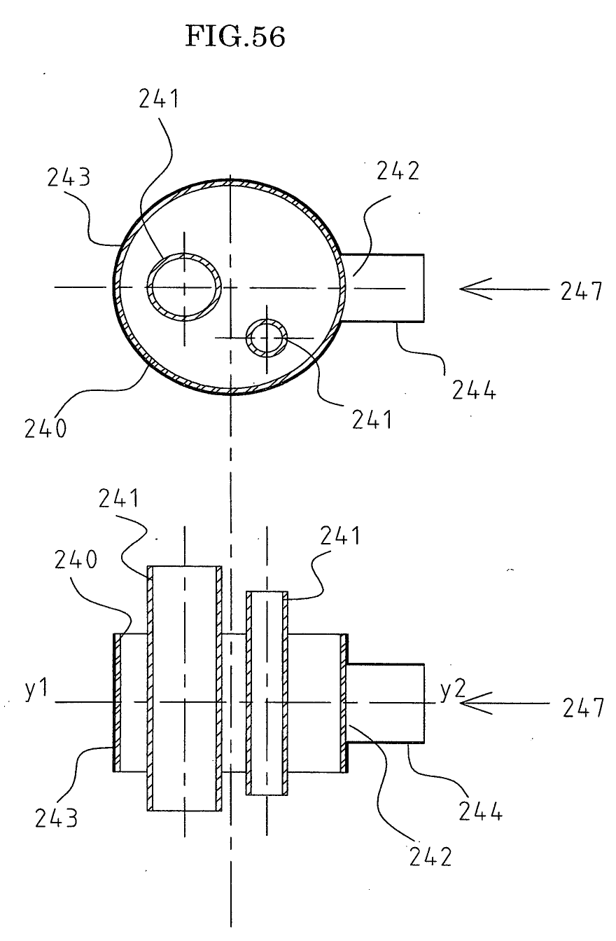

Shown in FIG. 56, a structure described below can be adopted in a modification of the fourth example. In the structure, two or more inner containers Vb “241”, of which cavities are not duplicated, are located.

Shown in FIG. 56, a structure described below can be adopted in a modification of the sixth example. In the structure, the inner container Vc “256” is dielectric and an inside portion of the inner container Vc “256” is covered with a conductive material.

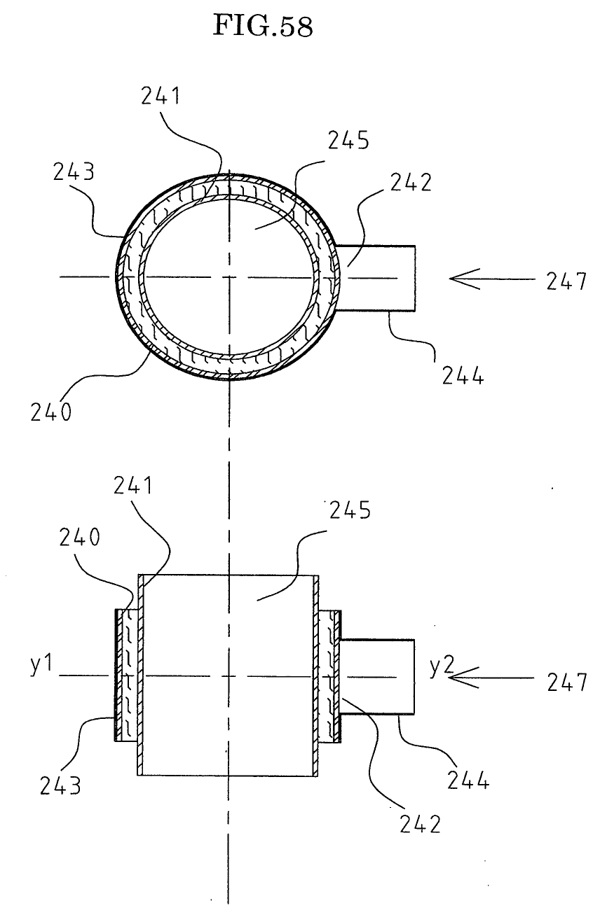

A structure described below can be adopted in a modification of the fourth example shown in FIG. 58. In the structure, gas or liquid with a low dielectric constant continuously flows in the region between the inner side face of the outer container Va “240” and the outer side face of the inner container Vb “241”, which forms the outer face of the reaction processing region, for the purpose of cooling.

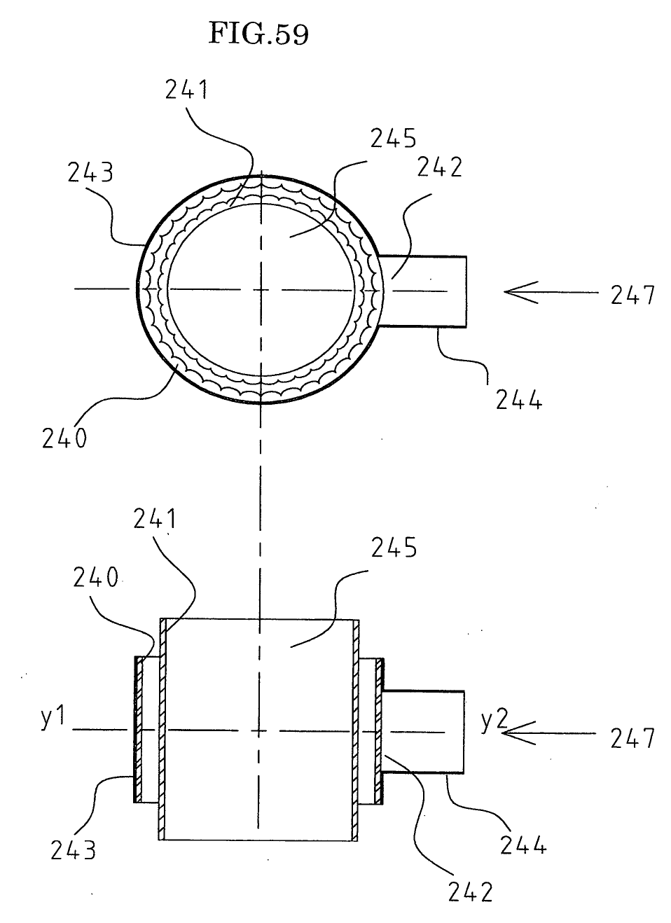

A structure described below can be adopted in a modification of the fourth example shown in FIG. 59. In the structure, the inner surface of the outer container Va “240” is made uneven-shaped for refraction of the electromagnetic wave and the outer surface of the inner container Vb “241”, which encloses the reaction processing region, is made uneven-shaped for refraction of the electromagnetic wave.

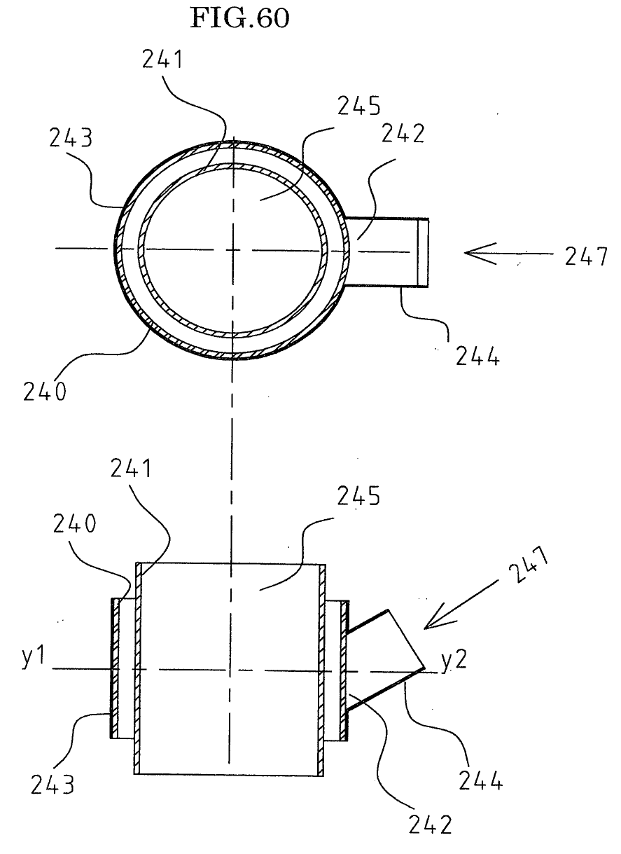

A structure described below can be adopted in a modification of the fourth example shown in FIG. 60. In the structure, the progressing direction of the high frequency wave oscillated by the oscillator form an angle selected except 0 degree with Z axis of the outer side face of the outer container Va “240”,and the dielectric face of the high frequency wave coupling portion is not parallel to the direction that the electromagnetic wave oscillated with a high frequency oscillator progresses, and the dielectric face forms the termination portion of the waveguide, and, at least, a portion of the termination is formed by the outer container Va itself or the dielectric material contacting the outer container Va.

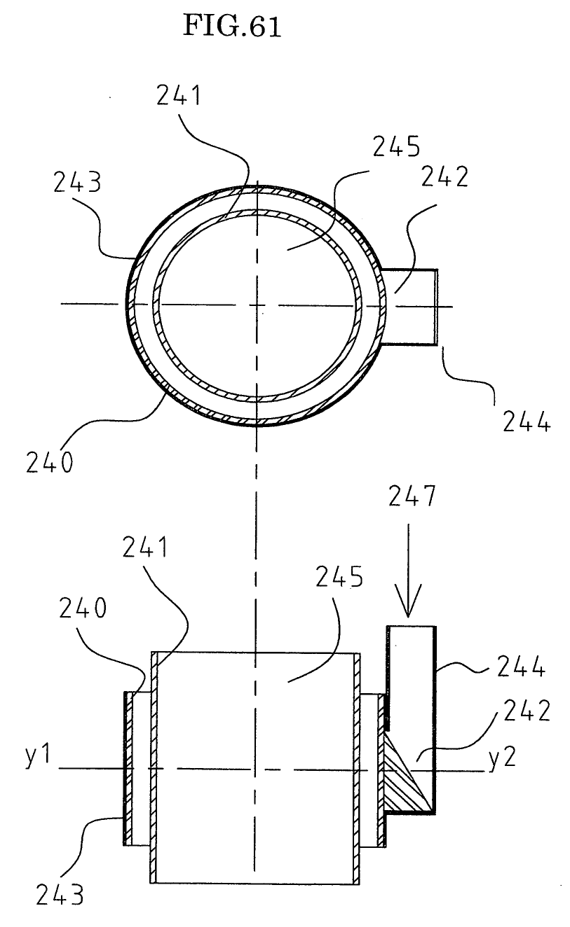

A structure described below can be adopted in a modification of the fourth example shown in FIG. 61. In the structure, the direction that the electromagnetic wave oscillated from high frequency oscillator progresses is parallel to Z axis of the outer side face of the outer container Va “240”, and the dielectric face of the high frequency wave coupling portion is not parallel to the direction that the electromagnetic wave oscillated from high frequency oscillator progresses, and the dielectric face forms the termination portion of the waveguide and, at least, a portion of the termination is formed by the outer container Va itself or the dielectric material contacting the outer container Va “240”.

The high frequency reaction processing system of the third embodiment as a ultraviolet ray excitation processing system is explained below according to the figures.

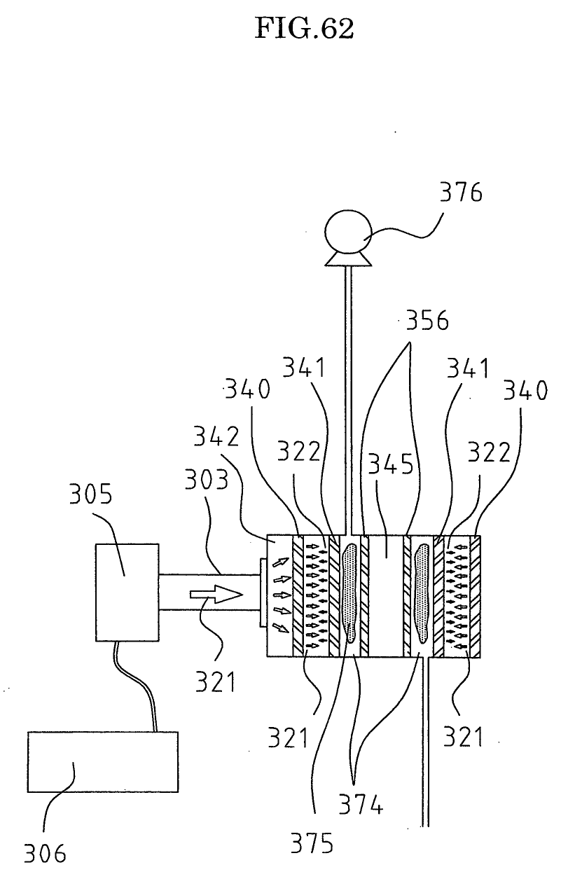

FIG. 62 shows a schematic diagram of the structure of the microwave reaction processing system with members for high frequency wave transmission system.

A high frequency oscillator “305” includes a magnetron and oscillates high frequency waves by electric power with a high voltage from a microwave power supply “306”. The electromagnetic wave travels through a waveguide “303” and is guided to a dielectric outer container Va “340”, a dielectric transmission surface, at the high frequency wave coupling portion. The outer side face of the outer container Va except the high frequency wave coupling portion is covered with the conductive material, which has the ground potential same as the waveguide. Thus, the guided electromagnetic waves spread and travel along the side face of the outer container Va “340”, an infinitely long dielectric transmission surface, and the leaked electric field is generated inside of the container by the surface wave.

The surface wave is guided into a region between the dielectric outer container Va “340” and an inner container Vb “341” as a side wall of the ionized gas plasma generating region. Thus, a standing wave is generated by a high frequency progressing wave “321” and a reflected wave “322”. The surface wave is also guided into the vacuumed ionized gas plasma generating region between the dielectric inner container Vb “341” and a dielectric inner container Vc “356” enclosing the object container.

The region between the dielectric inner container Vb “341” and the dielectric inner container Vc “356” enclosing the object container is vacuumed by a vacuum pump “376” and provided ionized plasma gas through an ionized plasma gas leading port “377”. Ionized gas plasma “375” is generated in a whole ionized gas plasma generating region “374”.

Ionized gas plasma “375” is generated with a certain impedance, if the conditions on a gas composition, pressure etc are satisfied. Thus, the ionized gas plasma functions as an antenna, the electromagnetic wave is able to travel in the whole inner container Vc “356”. Object in liquid, solid or mixture of them, which is led to the reaction processing region in the dielectric inner container Vc “356”, is processed by leaked electric field.

The object is processed with a reaction by receiving the radiation energy from the ionized gas plasma “375” through the dielectric inner container Vc “356”.

If the dielectric inner container Vc “356” made of optical permeable material is used, a ray with a natural spectrum of plasma emission, which is radiated if the condition on a gas component, pressure and high frequency power etc is satisfied, is able to be irradiated to the object. The ray with a natural spectrum is able to be used for light chemistry reaction processes.

Moreover, the dielectric inner container Vb “341” made of optical permeable material is used and the gas, which can be activated by vacuum ultraviolet rays etc radiated from the ionized gas plasma, flows through the region between the dielectric outer container Va “340” and the dielectric inner container Vb “341”. Thus, the gas is excited by the rays. This excited gas is led into the inner container Vc “356”, a processing region, for the object and used for contact reactions with the object.

A tube-shaped member for heating and cooling can be located in the inner container Vc “356”, which is the processing region for the object, and used for a sub reaction source.

Catalyst material can be located for the reaction processing in the inner container Vc “356”, which is the processing region for the object, and catalyst reactions can be caused.

The outer container Va “340”, the inner container Vb “341” and the inner container Vc “356” have multi layers composed of different dielectric materials for the wall.

If the inner container Vb “341” is made of the dielectric material permeable to ray including ultraviolet range and gas, which is activated by vacuum ultraviolet ray radiated from ionized gas plasma, flows through the region between the outer container Va “340”, which is not a processing region, and the inner container Vb “341”, light excited gas can be led into the inner container Vc “356” and used practically.

The magnetron oscillator do not have any damage even without impedance matching devices on the waveguide in the present invention shown in FIG. 62, because the whole system keeps matching against the load and no reflected wave exists in the waveguide “303”.

As a specific example of the third embodiment, the seventh to the ninth examples and modifications of them are explained below.

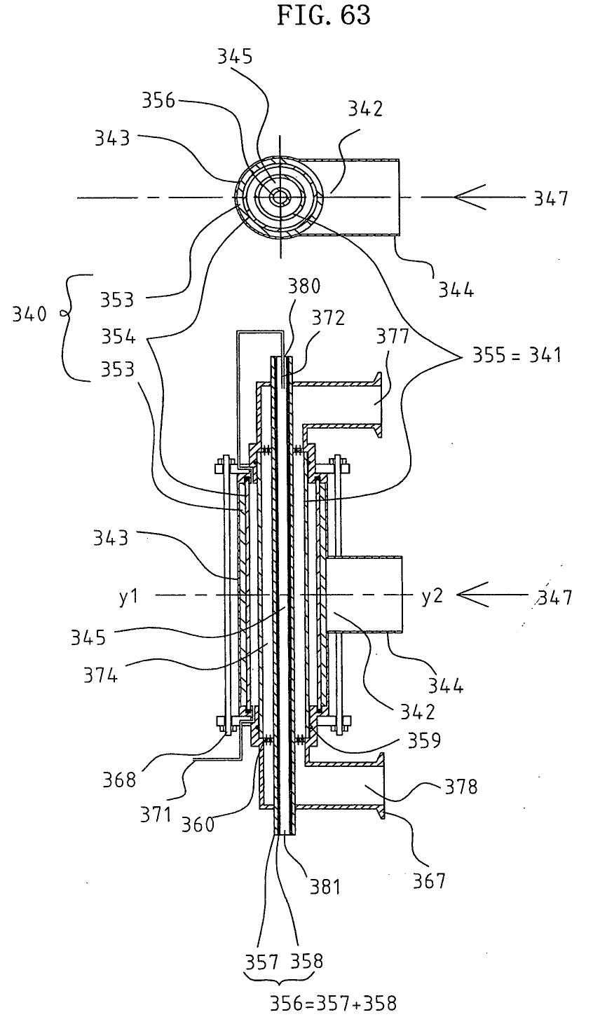

FIG. 63 shows a vertical sectional view and a horizontal sectional view on y1-y2 of a microwave reaction processing portion in the seventh example of the present invention.

Shown in FIG. 63, high frequency waves “347” are oscillated from the microwave oscillator and guided through a high frequency wave transmission waveguide “344” and travels to the dielectric outer container Va “340” through the high frequency wave coupling portion “342”. Then the wave is guided through the ionized gas plasma “375” into a reaction processing portion “345”. The ionized gas plasma “375” is formed in the region between the dielectric inner container Vb “341” and the dielectric inner container Vc “356”.

Commonly, the direction of the electric field depends on the electromagnetic wave mode of the high frequency wave “347”. The electromagnetic wave travels along the circumference direction of the cylindrical dielectric outer container Va “340”. Namely, the electromagnetic wave travels on the side face of the tube along the loop, an infinitely long dielectric transmission surface, by using TM11 mode in this example.

The dielectric outer container Va “340” is composed of an outer container Va (quartz tube) “354” and an outer container Va (mica), which covers the quartz tube, and contacts a covering conductive material “343” around itself. The dielectric inner container Vb “341” is composed of a cylindrical quartz tube “355”. The dielectric inner containers Vc “356” are composed of a dielectric inner container Vc (quartz tube) “357” and a dielectric inner container Vc (Teflon tube). The dielectric inner container Vb “341” is closed with stainless connecting flanges “367” fixed respectively on upper and down portions of the tube with volts “368”, and sealed with O-rings “359”. The dielectric inner containers Vc “356” is located through the connecting flanges “367” and the penetrated portion of the flange is sealed with the O-ring “359”.

The length of the inner outline of the horizontal section of the dielectric outer container Va “340” is integer times ¼ of the wavelength of the guided high frequency wave. Thus the high frequency wave “347”, which travels along circumference direction of the dielectric outer container Va “340” as a dielectric transmission surface, causes the transmission surface resonance. The outer side face of the dielectric outer container Va “340” is covered with the covering conductive material “343”. Thus, the electromagnetic wave cannot leak outside and surface waves forming the leaked electric field are generated in a wide rang along the radius direction of the dielectric outer container Va “340”. Since the covering conductive material “343” keeps the ground potential, many intense points of the electric field are on a loop in a wide range at every ¼ of the wavelength of the guided surface wave. Thus, ionized gas plasma “375” is generated in the ionized gas plasma generating region “374”. As described above, the ionized gas plasma, which is generated on the side of the outer surface of the dielectric inner container Vc “356”, the object container, become a dielectric transmission surface as an infinitely long dielectric transmission surface along the dielectric inner container Vc “356”. Moreover, the leaked electric field is generated in the reaction processing region “345” enclosed by the inner container Vc “356”.

If electromagnetic wave enters from medium with a high dielectric constant to medium with a low dielectric constant at the angle of incidence over a certain value, grazing incidence occurs. Therefore, a portion of the electromagnetic wave, which is reflected in the inner container Vc “356”, is reflected and travels by the ionized gas plasma “375” and is absorbed into an object. The impedance of the high frequency wave transmission surface in this region changes with following the impedance of the load. The transmission surface functions as a ¼ wavelength impedance transformer matching circuit. Therefore, an impedance matching occurs between the transmission surface and the load. Finally, the energy of the electromagnetic waves is efficiently absorbed to the plasma load.

Thus, the reflected wave cannot return to the high frequency wave transmission waveguide “344”, the system is in non-reflection state in viewing the load from the oscillator.

The whole processing container has a structure of a cylinder cavity resonator and can have a structure of a dielectric resonator. Therefore, electric power is efficiently absorbed by the load.

Shown in FIG. 63, in the case that the high frequency wave “347” is guided through the plural high frequency wave transmission waveguides “344”, the standing wave enclosed in the region, which is equivalent to a ¼ wavelength impedance transformer matching circuit. Thus, the plural oscillators are able to supply electric power to the load without mutual interferences and the system is able to supply much power.

The air is led into the ionized gas plasma generating region “374” through the ionized plasma gas leading port “377” and exhausted through an ionized plasma gas exhausting port “378” to the vacuum pump.

Water as object is led into the reaction processing portion “345” through a fluid object leading port “380” for the purpose of sterilization in the water. The water is exhausted through the fluid object exhausting port “380”.

Oxygen gas is led into the region between the dielectric outer container Va “340” and the dielectric inner container Vb “341” through a light excited gas leading port “371”. Vacuum ultraviolet rays, which are generated by the ionized gas plasma “375”, transmit the quartz tube “355”, the inner container Vb, and ozone gas is generated by ultraviolet rays. The ozone gas is led through a light excited gas exhausting passage “372” into the reaction processing portion “345” and contacts the object.

The reaction processing system in this example is a system for the efficient advanced oxidation process for water, in which heating sterilization reaction is caused by irradiation of vacuum ultraviolet rays oscillated by microwave ionized gas plasma. The system is also for oxidation reaction of ozone gas, which is caused with the same energy source.

The specific sizes and capacities regarding to the system of this example are described below. The frequency of the high frequency wave “347” is 2.45 GHz. The electromagnetic mode is TM11. The maximum power of the wave is 1 kW. The high frequency wave coupling portion “342” is connected with the dielectric container Va “340” at the opening portion, which has a width of 70 mm, a height of 130 mm. The dielectric outer container Va “340” is formed of a quartz tube “354”, which has an outer diameter of 100 mm, a thickness of 3 mm and a length along Z axis of 200 mm, and a mica layer “353”, which has a thickness of 4 mm and covers the outer side face of the quartz tube “354”. The dielectric inner container Vb “341” is formed of a quartz tube “355”, which has an outer diameter of 50 mm, a thickness of 3 mm in, and a length along Z axis of 200 mm. The dielectric inner containers Vc “356” are composed of dielectric inner containers Vc (quartz tube) “357”, which has outer diameters of 19 mm, thicknesses of 1.5 mm and lengthes of 360 along Z axis, and a dielectric inner container Vc (Teflon tube) “358”, which is located in the dielectric inner containers Vc (quartz tube) “357” with outer diameters of 16 mm. The aluminum covering conductive material “343” is formed of an aluminum plate with a thickness of 0.5 mm. The stainless connecting flange “367” is composed of the coupling portion, which is connected with the dielectric inner container Vb “341” with a diameter of 60 mm and the NW50 connecting flange portion. The both end portions can be connected outer vacuum pipes.

The region between the inner container Vb “341” and the inner container Vc “356” is enclosed with two punched aluminum plates, which have thicknesses of 3 mm and 35% openings as porous conductive plates “360”, and the ionized gas plasma generating region “374” is formed. The air is led into the ionized gas plasma generating region “374” through the ionized plasma gas leading port “377” with a pressure of 15 Psi and exhausted through the ionized plasma gas exhausting port “378” connected with the vacuum pump. Then the pressure in the ionized gas plasma generating region “374” is controlled at 80 Pa.

In the structure of the system of the present invention, the oxygen gas, which flows through the pipe made of SUS with an outer diameter of ¼ inch as a light excited gas passage “371” with a flow controlled at 50 sccm, is led into the region between the dielectric outer container Va “340” and the dielectric inner container Vb “341” with a pressure of 15 psi. Moreover, the oxygen gas is led into the reaction processing portion “345” through the light excited gas exhausting passage “372” and the T-union joint. Then the gas contacts the object.

The object water is led through the fluid object leading port “380” with a flow of less than 1 L/min and exhausted through the fluid object exhausting port “381”.

The test example of this example is described below. Object water is pure water. Its leading flow is 500 cc/min. The pressure of the ionized gas plasma region is 80 Pa. The flow of the air for the ionized gas plasma is 30 sccm. The flow of the oxygen gas for generating ozone gas is 50 sccm. The electric power for oscillating the microwave is 800 W.

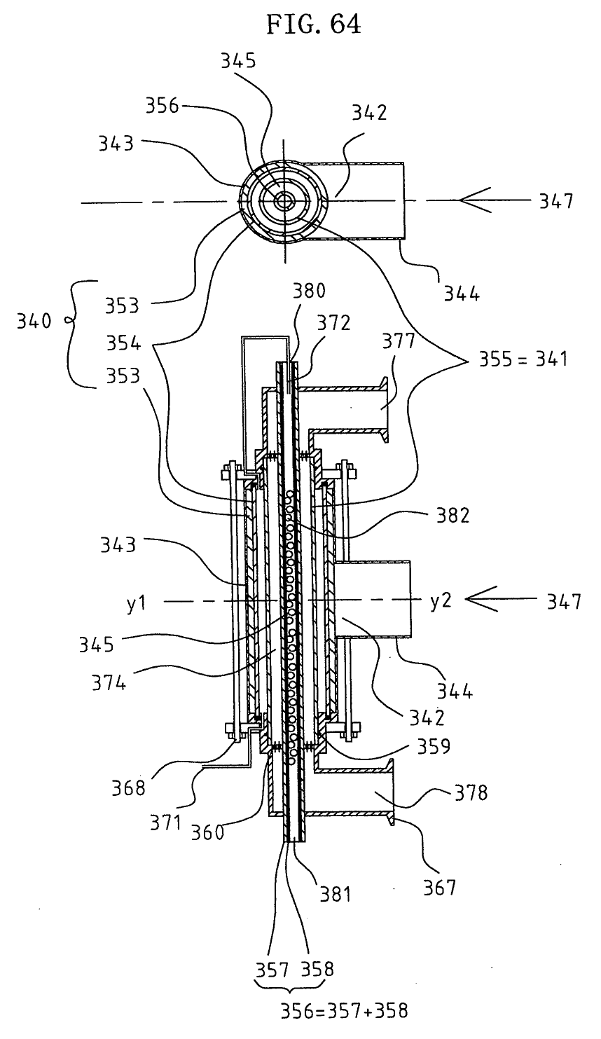

The eighth example shown in FIG. 64 is explained below. FIG. 64 shows a vertical sectional view and a horizontal sectional view on y1-y2 of a microwave reaction processing portion in the present invention.

This example is a modification of the seventh example. The inner container Vc “356” is filled with alumina grains, which are respectively coated with the titanium dioxide as a catalyst material “382”. Thus, a light chemical reaction is able to be caused in the reaction processing region “345”.

The ionized gas plasma “375”, which has the intensity peak of the plasma emitting spectrum in ultraviolet range, is generated with gas such as xenon gas. Thus, the reaction of the fluid object such as gas or liquid is stimulated by photo-catalyst, which is supported by the basis member or enclosed in the reaction processing region “345”.

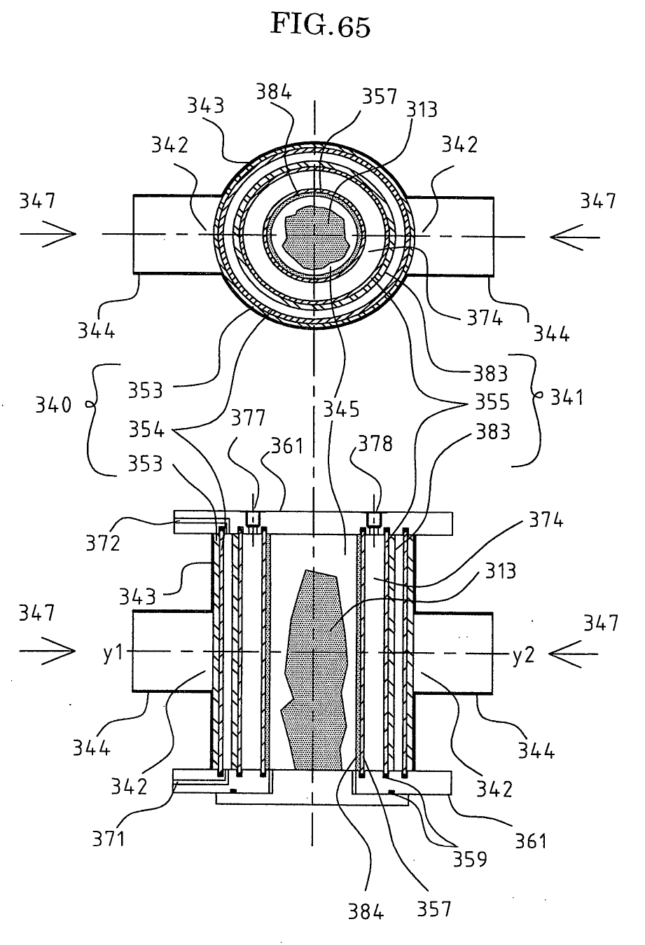

The ninth example shown in FIG. 65 is explained below. FIG. 65 shows a vertical sectional view and a horizontal sectional view on y1-y2 of a reaction processing portion of the reaction system for sintering ceramics green body in the present invention.

Shown in FIG. 65, the high frequency waves “347” are oscillated from two microwave oscillators and respectively guided through high frequency wave transmission waveguides “344” into the dielectric outer container Va “340” at the high frequency wave coupling portion “342”. Then the waves are guided through the ionized gas plasma “375” into the reaction processing portion “345”. The ionized gas plasma “375” is formed in the region between the dielectric inner container Vb “341” and the dielectric inner container Vc “356”. Commonly, the direction of the electric field depends on the electromagnetic wave mode of the high frequency wave “347”. The electromagnetic wave travels along the circumference direction of the cylindrical dielectric outer container Va “340”. Namely, the electromagnetic wave travels on the side face of the tube along the loop, an infinitely long dielectric transmission surface, by using TM11 mode in this example.

The reaction processing region “345” is composed of the dielectric inner container Vc “357”, the aluminum container walls in the upper and down side and aluminum door sample stage, and sealed with the O-ring “359”.

The high frequency wave transmission waveguide “344” is connected with the outer side face of the dielectric outer container Va “340”, which is composed of a quartz tube “354” covered with the mica layer. The outer side face of the mica layer except the area connected with the high frequency wave transmission waveguide “344” is covered with a covering conductive material “343” made of aluminum with an electric potential equal to the high frequency wave transmission waveguide “344”. Moreover, the covering conductive material “343” is electrically connected with aluminum container walls “361”.

In this example, the inner container Vb (quartz tube) “355” covered with a heat insulation dielectric layer (mica-layer) “383” is located outside the dielectric inner container Vc “341”. The dielectric inner container Vb “341” is coaxially located in the dielectric outer container Va “340” so that the distance between the side face of the dielectric inner container Vb “341” and the outer side face of the outer container mica layer “353” of the dielectric outer container Va “340” should be ¼ of the wavelength of the guided high frequency wave.

The inner container Vc (quartz tube) “357” and the inner container Vb (quartz tube) “355” are sealed with the O-rings “359” on the container walls “361”. The region enclosed with them is the ionized gas plasma generating region “374”. The gas for plasma is led through the ionized plasma gas leading port “377” formed between the container walls “361” with controlling of the flow. The gas is exhausted through the ionized plasma gas exhausting port “378” connected with the vacuum pump.

Both the mica layer of the outer container and the outer heat-insulation dielectric layer (mica layer) of the inner container Vb function as a dielectric transmission surface and also function as a heat insulator in a sintering process. Thus, the layers prevent energy loss by radiating the supplied energy to the outside. Moreover, the outer heat-insulation dielectric layer (mica layer) “383” of the inner container Vb prevents energy loss of light transmitting to the outside of the ionized gas plasma generating region “374” and functions to absorb the rays and hold the heat energy.

Since the ionized gas plasma “375”, which is generated outside the dielectric inner container Vc “356”, becomes a dielectric transmission surface, the infinitely long dielectric transmission surface is formed along the circumference of the dielectric inner container Vc “356”. Moreover, the leaked electric field is generated in the reaction processing region “345” in the inner container Vc “356” and used for sintering an object “313” in the region.

Even if high frequency wave is guided by the plural high frequency wave transmission surface waveguides “344” in examples such as this one, the standing wave is enclosed in the region, which is equivalent to a ¼ wavelength impedance transformer matching circuit. Thus, the plural oscillators are able to supply electric power to the load without mutual interferences and the system is able to supply much power.

In this example, an alumina tube as an uniformly-heat-dispersing dielectric material “384” is located on the inner face of the inner container Vc “356” to disperse the electric field uniformly. The alumina tube functions as an uniformly-dispersing line of the leaked electric field. Thus, a green body of ceramics is able to be sintered as a load with uniformly heating. Thus, the reflected wave cannot return to the high frequency wave transmission waveguide “344”. The system is in non-reflection state in viewing the load from the oscillator. Moreover, the system is able to be used for sintering ceramics uniformly and quickly sintered without energy loss.

The specific sizes and capacities regarding to the system of this example are described below. The frequency of the high frequency wave “347” is 2.45 GHz. The electromagnetic mode is TM11. The maximum power of the wave is 1 kW. The high frequency wave coupling portion “342” is connected with the dielectric container Va “340” at the opening portion, which has a width of 70 mm, a height of 130 mm. The dielectric outer container Va “340” is formed of a quartz tube “354”, which has an outer diameter of 100 mm, a thickness of 3 mm and a length along Z axis of 200 mm, and a mica layer “353”, which has a thickness of 4 mm and covers the outer side face of the quartz tube “354”. The dielectric inner container Vb “341” is formed of a quartz tube “355”, which has an outer diameter of 115 mm, a thickness of 3 mm, and a length along Z axis of 200 mm and a heat-insulation dielectric layer (mica layer) “383” of the inner container Vb, which covers the outer side face of the quartz tube “355” with a thickness of 4 mm. The dielectric inner container Vc “357” is formed of the quartz tube, which is an outer diameter of 80 mm, a thickness of 3 mm, and a length along Z axis of 200 mm. The aluminum covering conductive material “343” is formed of an aluminum plate with a thickness of 0.5 mm. The aluminum container wall “361” has a thickness of 20 mm, an outer diameter of 200 mm and is disk-shaped. The aluminum container wall is closed by the door sample stage. The uniformly-heat-dispersing dielectric material “384” is formed of an alumina tube with an outer diameter of 73 mm, a thickness of 2 mm and a length of 190 mm along Z axis. The object “313” is a block of green alumina with high purity.

Quartz is used for the material of both the inner container quartz tube “355” and the dielectric inner container Vc “357” in the example described above. The other dielectric material with a low dielectric constant also can be used. For example, all alumina-based ceramics can be used. All dielectric material with a low dielectric constant can be used for the dielectric outer container Va “340”. Moreover, the outer container can be composed of plural different dielectric layers.

In this example, a quartz tube is used as a uniformly-heat-dispersing dielectric material “384”. The function of the dielectric transmission surface can be made better by tuning the dielectric constant of ceramics so that the layer could have a depletion layer with a proper void content. Moreover, a uniformly-heat-dispersing dielectric material can be deformed to fit the object.

Object can be solid, liquid, gas and mixture of them, which is not conductive.

As a specific example of the fourth embodiment in the present invention, the tenth example and a modification of it are explained below with reference to the drawings.

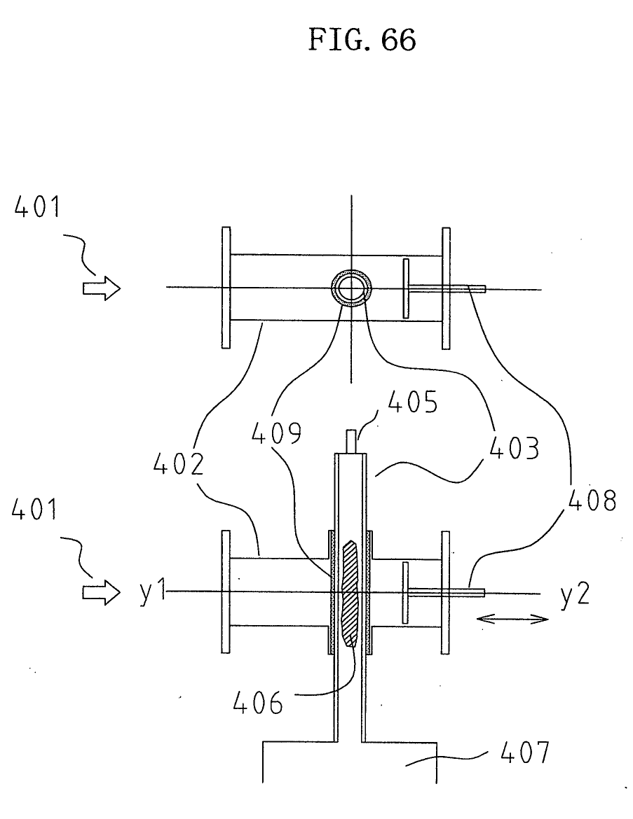

The tenth example is explained. FIG. 66 shows a vertical sectional view and a horizontal sectional view on y1-y2 of a microwave processing system of the present invention.

Shown in FIG. 66, microwave in a microwave traveling direction “401” is irradiated through a high frequency wave transmission waveguide “402” into a microwave transmission dielectric discharge tube “403”, which is connected with a vacuum sample chamber “407” and a plasma gas leading port “405”. On the side of the dielectric discharge tube “403” described above opposite to the microwave traveling direction “401”, a variable metallic termination tuning plate “408” is located in order to tune the termination for microwave matching. The dielectric discharge tube “403” is wrapped multiply on the outer circumference by a mica member “409”.

The process gas is led into the vacuumed dielectric discharge tube “403” through the plasma gas leading port “405”. The oscillated microwave is matched so that it could transmit the mica member “409” and form the high intensity portion of the electric field on the dielectric discharge tube “403”. The ionized gas plasma “406” is generated in the dielectric discharge tube “403” by the irradiation of microwave. The material is selected so that the dielectric discharge tube “403” could not be etched or corroded by the generated ionized gas plasma “406” according to the species of the generated ionized gas plasma.

It is necessary to generate the high intensity portion of the electric field in the discharge tube as a load and bias a high voltage enough to ionize the gas for the generation of microwave ionized gas plasma. Moreover, it is necessary to tune the system so that the high intensity portion of the electric field could be formed, at least, on an area of the inner face of the discharge tube by operating the metallic termination tuning plate “408” or the phase matching device located in the microwave waveguide etc.

The supplied microwave energy is consumed by the ionized gas plasma “406” and a portion of the energy is also consumed for heat because of the character of the dielectric loss angle. Moreover, the dielectric discharge tube “403” absorbs the irradiation energy by the ionized gas plasma and generates heat. Especially, the irradiated portion of the dielectric discharge tube “403” locally generates heat because of the energy concentration of microwave. Then, the portion expands.

Because the heat expansion rate of the irradiated portion of the dielectric discharge tube “403” is different from the other portion, damages such as cracks more easily occur in the dielectric discharge tube “403” with the supplied power increasing and the irradiation time increasing.

Moreover, in the case that the discharge tube is opened to the air pressure after the microwave irradiation is stopped after the process, damages such as cracks become to easily occur on the dielectric discharge tube “403” because the dielectric discharge tube “403” rapidly shrinks by the local decrease of the temperature.

The mica member “409” of the present invention is formed so that it could directly contact the outer circumference of the dielectric discharge tube “403”. Because a mica material functions as a heat-insulator and a heat-radiator, the heat generated in irradiation of microwave is insulated by a mica member “409” and the whole dielectric discharge tube “403” is uniformly heated. Thus, local expansions are prevented to be caused by local generations of heats and damages such as cracks are prevented. Moreover, the dielectric discharge tube “403” is prevented from being rapidly and locally cooled and shrinking by keeping heat of mica member “409”.

To be more specifically explained, the high intensity portions of the electric field in microwave locally heat the transmission window or the discharge tube made of dielectric material. The load in the processing chamber also locally heats them. However, the mica layer has the effect of the heat insulation and the layer with the heat radiation character radiates heat from the transmission window or the discharge tube made of dielectric material. Thus, local heats are reduced and the thermal expansion stresses, which are caused by the difference of temperatures among local portions of the transmission window or the discharge tube made of dielectric material, are reduced and the members hardly crack.

Regarding to shrinks of the transmission window or the discharge tube made of dielectric material by opening the vacuum atmosphere to the air, the transmission window or the discharge tube made of dielectric material is gradually cooled and shrinking stresses are reduced because of the heat insulation effect of the mica layer, whatever the state of the processing chamber is. Thus, the members hardly crack.

Moreover, the mica layer can be molded. The molded multi-layer made of mica is inexpensive and flexible if the layer is thin.

The plasma etching system for treating silicon-including material by ionized gas plasma generated from fluorine-including gas, is explained.

The specific sizes and capacities regarding to this example are described below. The microwave “401” guided from the microwave traveling direction has a frequency of 2.45 GHz. The electromagnetic mode is TE01. The maximum power of the wave is 2 kW. The high frequency wave transmission waveguide “402” is a WRJ-2 type aluminum waveguide of JIS (Japan Industrial Standards). The microwave transmission dielectric discharge tube “403”, a processing chamber, is formed of an alumina tube with an outer diameter of 25.4 mm, a thickness of 3 mm and a length of 300 mm. The discharge tube “403” is located through the high intensity portion of electric field in the high frequency wave transmission waveguide “402”. Moreover, the portion of the microwave transmission dielectric discharge tube “403”, which is formed as a processing chamber, in the high frequency wave transmission waveguide “402” is wrapped multiply on the outer circumference by mica films for a multilayer with a width of 100 mm and a thickness of 0.35 mm. The mica member “409” is formed with a thickness of 5 mm. The dielectric discharge tube “403” is connected to the aluminum vacuum sample chamber “407” with a union joint having a diameter of 1 inch and is vacuumed by the vacuum pump connected with the vacuum sample chamber “407”. Moreover, gas is led through the plasma gas leading port “405” on upper side of the dielectric discharge tube “403” with the flow being controlled by a joint with a transferable diameter of 1 inch to ¼ inch.

The test condition of this example is described below. The gas for ionized gas plasma is CF4. The leading flow of the gas is 60 cc/min. The pressure of the ionized gas plasma region is 80 Pa. The electric power for oscillating the microwave is 1500 W.

The result of the test in this example is described below. A discharge process by the ionized gas plasma was serially carried out without the mica member “409” in the test condition described above. The dielectric discharge tube “403” was cracked 15 minutes after the test started. It was hard to keep vacuumed in the discharge tube “403” because of the leak through the cracks. The system became disable to cause the discharge.

Then, after discharge was caused without the mica member “409” in the described condition for 3 minutes, the vacuumed discharge region was opened to the air and left for 1 minute. The dielectric discharge tube was vacuumed again and discharge was caused for 3 minutes repeatedly in the cycle. The dielectric discharge tube “403” cracked on opening to the air of the third cycle.

The discharge tube with the mica member “409” did not have any damage after continuously discharging for 1 hour. Moreover, a damage was not caused on opening to the air in the cycle of the process and the effect of the present invention was proved.

An alumina tube is used for the material of the microwave transmission dielectric discharge tube “403” as a processing chamber. The other all ceramics material also can be used. Multilayer mica films are used for the mica member “409”. However, a molded mica tube or a multilayer member, which is formed with combination of multilayer mica films and an insulation glass basis member with a low dielectric loss angle, can be used.

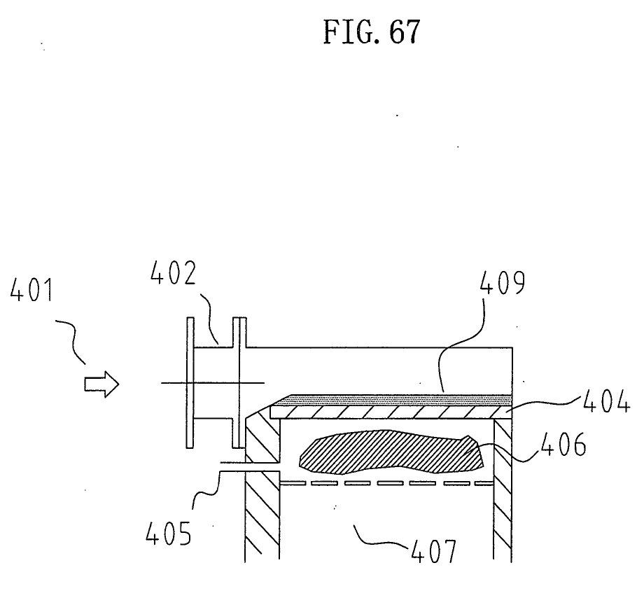

Shown in FIG. 67, in a modification of the tenth example, a molded mica member can be located on a microwave transmission dielectric window “404”, which is a portion of the processing chamber of the system using surface waves of microwave.

As a specific example of the fifth embodiment in the present invention, the eleventh example and a modification of it are explained below with reference to the drawings.

Sign or numbers in the figures is described with “ ” in order to be distinguished from other signs.

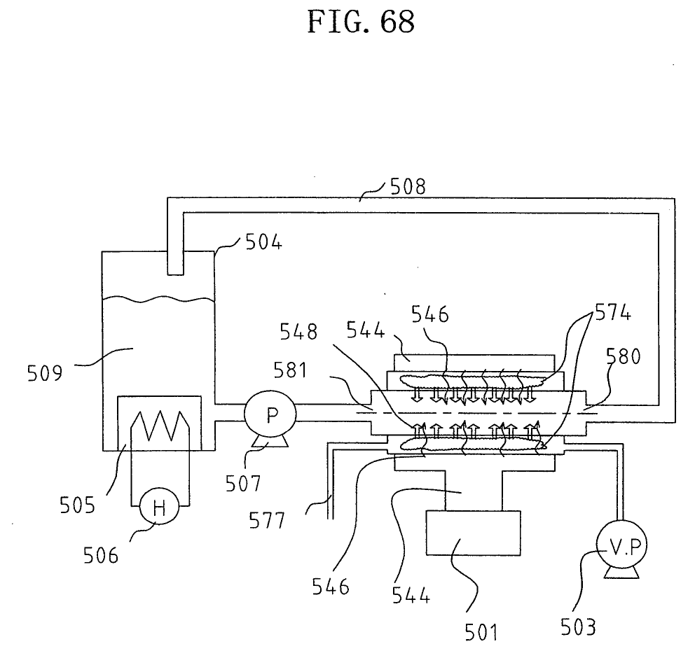

FIG. 68 is a diagram showing the eleventh example of the present invention. In the structure of the present invention, waste water “509” for the process is controlled to be heated at the temperature between 40° C. to 70° C. in a waste water container “504” with a constant temperature liquid heating container “505” by controlling a heat source “506”. Then, the waste water “509” is led into the processing portion of the system of the present invention through a waste water leading port “581” by operating a waste water transport pump “507”. In the waste water passage in the processing portion, all the portions contacting the waste water are composed of synthetic quartz tubes. Thus, transmission of a high energy photon ray “548” as vacuum ultraviolet ray and a microwave “546” are assisted. An ionized gas plasma generating region “574” is vacuumed by a vacuum pump “503”. The source gas for gas plasma is led into the ionized gas plasma region “574” through a gas leading port “577” for generating ionized gas plasma with flow controlled.

A high frequency microwave, which is oscillated by a microwave oscillator “501”, is guided through a high frequency wave transmission waveguide “544” into the ionized gas plasma generating region “574” for a high frequency resonation load. Then, ionized gas plasma is generated in the ionized gas plasma generating region “574” and the high energy photon ray “548”, a vacuum ultraviolet ray from the vacuumed ionized gas plasma, is irradiated to the waste water in the waste water passage. Then, the high frequency microwave “546” is leaked to spread in the whole plasma generating region because the plasma in the ionized gas plasma generating region “574” functions as a dielectric transmission surface. A portion of the microwave “546” is consumed for the energy of the ionized gas plasma and the other is irradiated to the waste water for a high frequency wave termination.

The waste water passing through the waste water passage is processed by the irradiation of the vacuum ultraviolet ray and the electromagnetic wave described above. The water is exhausted through a waste water exhausting port “580” and a waste water returning passage “508”. Then, the waste water is returned to the waste water container “504”. Then, the process is continued in the circulation.

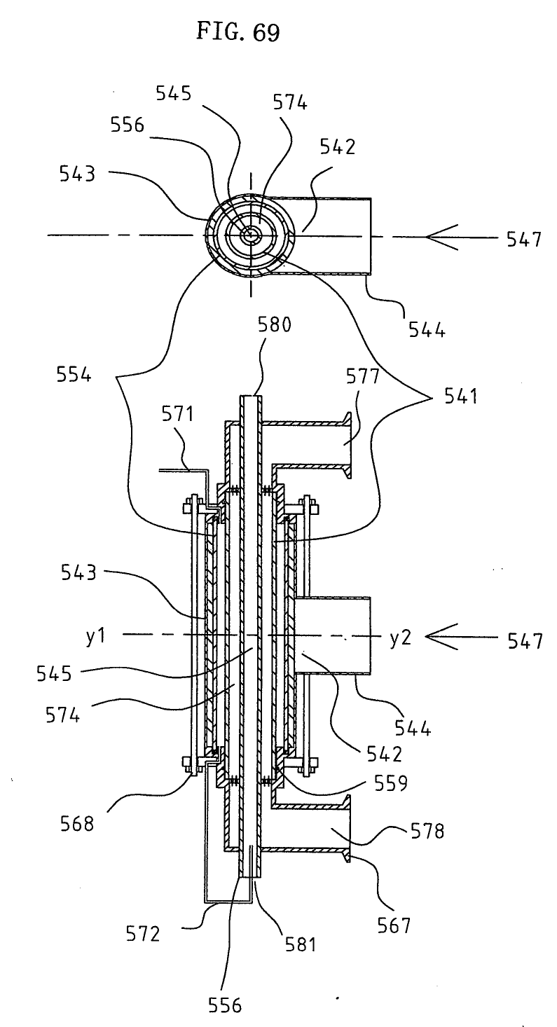

FIG. 69 shows a vertical sectional view and a horizontal sectional view on y1-y2 of a wastewater processing portion of the present invention.

Shown in FIG. 69 a high frequency wave “547” are oscillated from the microwave oscillator and guided through the high frequency wave transmission waveguide “544” and travels to the dielectric outer container Va “540” at a high frequency wave coupling portion “542”. Then the wave is guided through ionized gas plasma “575” into a reaction processing portion “545”. The ionized gas plasma is generated in the ionized gas plasma generating region “574” between a dielectric inner container Vb “541”, which is composed of an alumina tube, and a waste water processing tube “556”, which is composed of a synthetic quartz tube for a portion of the waste water passage. Commonly, a direction of the electric field depends on a mode of the high frequency wave “547”. The electromagnetic wave travels along a circumference direction of a cylindrical dielectric outer container Va “540” made of quartz. Namely, the electromagnetic wave travels on the side face of the tube along a loop, an infinitely long dielectric transmission surface, by using a TM11 mode in this example.

A dielectric outer container Va “554” is composed of the quartz tube and the mica layer, which covers the quartz tube. The dielectric outer container Va “554” contacts a dielectric material “543” on the circumference of the tube. The dielectric inner container Vb “541” is closed with stainless connecting flanges “567” fixed respectively on upper and down side with volts “568”, and sealed with O-rings “559”. The waste water process tube “556” is located through the connecting flanges “567” and the penetrated portion of the flange is sealed with O-rings.

The length of the inner outline of the horizontal section of the dielectric outer container Va “554” is integer times ¼ of the wavelength of the guided high frequency wave. Thus the high frequency wave “547”, which travels along the circumference direction of the dielectric outer container Va “554”, a dielectric transmission surface, causes a transmission surface resonance. Moreover, since the outer side face of the dielectric outer container Va “554” is covered with the covering conductive material “543”, the electromagnetic wave cannot leak outside and the surface wave forming the leaked electric field is generated in a wide rang along the radius direction of the dielectric outer container Va “554”. Since the covering conductive material “543” keeps the ground potential, many intense points of the electric field are on a loop in a wide range at every ¼ wavelength of the guided surface wave. Thus, the ionized gas plasma is easily generated in the ionized gas plasma generating region “574”.

As described above, ionized gas plasma, which is generated in the outside of the waste water tube “556”, an object container, becomes the dielectric transmission surface and forms an infinitely long dielectric transmission surface along the circumference of the waste water processing tube “556”. Then, the leaked electric field is generated in the waste water processing portion “545” in the waste water tube “556”.

If an electromagnetic wave enters from medium with a high dielectric constant to medium with a low dielectric constant at the angle of incidence over a certain value, a grazing incidence occurs. Thus, the wave reflected on the inner face of the waste water processing tube “556” is reflected and travels because of the ionized gas plasma. Then, the wave is absorbed in the object. The impedance of the high frequency wave transmission surface in this region changes with following the impedance of the load. The transmission surface is equevalent to a ¼ wavelength impedance transformer matching circuit. Therefore, the impedance matching occurs between the transmission surface and the load. Finally, the energy of electromagnetic wave is efficiently absorbed to the plasma load.

Thus, the reflected wave cannot return to the high frequency wave transmission waveguide “544”. The system is in non-reflection state in viewing the load from the oscillator.

The whole processing container has a structure of a cylinder cavity resonator and can have a structure of a dielectric resonator. Therefore, the electric power is efficiently absorbed at the load.

In the case that the high frequency wave “547” is guided through the plural high frequency wave transmission waveguides “544”, the standing wave enclosed in the region equivalent to a ¼ wavelength impedance transformer matching circuit. Thus, the plural oscillators are able to supply electric power to the load without mutual interferences and the system is able to supply much power.

Gas is led into the region between the dielectric outer container Va “554” and the dielectric inner container Vb “541” through a light excited gas leading port “571”. The gas is led through a light excited gas exhausting passage “572” into the waste water processing portion “545” and contacts the object.

The specific sizes and capacities regarding to the system of this example are described below. The high frequency wave “547” has a frequency of 2.45 GHz. The electromagnetic mode is TM11. The maximum power of the wave is 1 kW. The dielectric outer container Va “554” is formed of a quartz tube “554”, which has an outer diameter of 100 mm, a thickness of 3 mm and a length along Z axis of 200 mm. The dielectric inner container Vb “541” is formed of an alumina tube, which has an outer diameter of 50 mm, a thickness of 3 mm, and a length along Z axis of 200 mm. The waste water processing tube “556” is formed of a synthetic quartz tube, which has an outer diameter of 19 mm, a thickness of 1.5 mm, and a length along Z axis of 360 mm. The stainless vacuum connecting flange “567” is composed of a dielectric inner container Vb “541” with an outer diameter of 60 mm and a NW50 connecting flange portion. The both end portions of the flange can connect with outer vacuum pipes.

The region between the inner container Vb “541” and the waste water processing tube “556” is enclosed with two punched aluminum plates, which have thicknesses of 3 mm and 35% openings as porous conductive plates “560”, and forms the ionized gas plasma generating region “574”. The air is led into the ionized gas plasma generating region “574” through the ionized plasma gas leading port “577” with a pressure of 15 Psi and exhausted through an ionized plasma gas exhausting port “578” connected with the vacuum pump. Then the pressure in the ionized gas plasma generating region “574” is controlled at 100 Pa.

Hydrogen gas, which flows through the pipe made of SUS with a ¼ inch outer diameter as a light excited gas passage “571” with a controlled flow of 50 sccm, is led into the region between the dielectric outer container Va “554” and the dielectric inner container Vb “541” with a pressure of 15 psi. Moreover, the hydrogen gas can be led into the waste water processing portion “545” through the light excited gas exhausting passage “572” and a T-union joint. Thus, the structure enables the gas to contact the object according to the purpose of the process.

The flow of the waste water can be controlled under the maximum of 10 L/min. The practical maximum capacity of the waste water “504” container is 20 litters. The vacuum pump is a rotary pump with an engine displacement of 250 L/min.

The result of the test in this example is described below.

A volume reduction process experiment of excess sludge, a kind of processes for waste water was carried out. Waste water with a pH of 6.78, a TOC of 96.2, a MLSS of 2900, a COD of 2500, a BOD of 1000, a TN of 330, a TP of 54 and a volume of 5 litters was used. The waste water was heated at 40° C. before the process. The waste water was circulated in the system with a flow of 10 L/min. A purification process was carried out and values are measured after 30 minutes process.

The air is used for a source of ionized gas plasma. The conditions of plasma generation process were having a microwave power of 500 W, a pressure of 100 Pa. No hydrogen gas was led.

The values measured after 30 minutes process were a pH of 6.71, a TOC of 413.5, a MLSS of 770, a COD of 1900, a BOD of 880, a TN of 380 and a TP of 60. A reduction rate of a MLSS is 74% and it shows large volume reduction. Since the increases of a COD value and a BOD value caused by a solubilization of cytoplasm were not observed, it is seemed that an oxidation-decomposition reaction of organic compounds was simultaneously developed. The experiment shows a large effect in a volume reduction process and a decomposition process.

According to the result described above, if the system that makes processed waste water returned to a biologic process is composed, an amount of excess sludge generated is reduced much. Moreover, the running cost has only the cost for electric power supply and the cost in trial calculation based on the experiment result described above is about ⅓ of a cost in a former method.

It can be the purpose of the waste water process to remove inorganic nutrient salts.

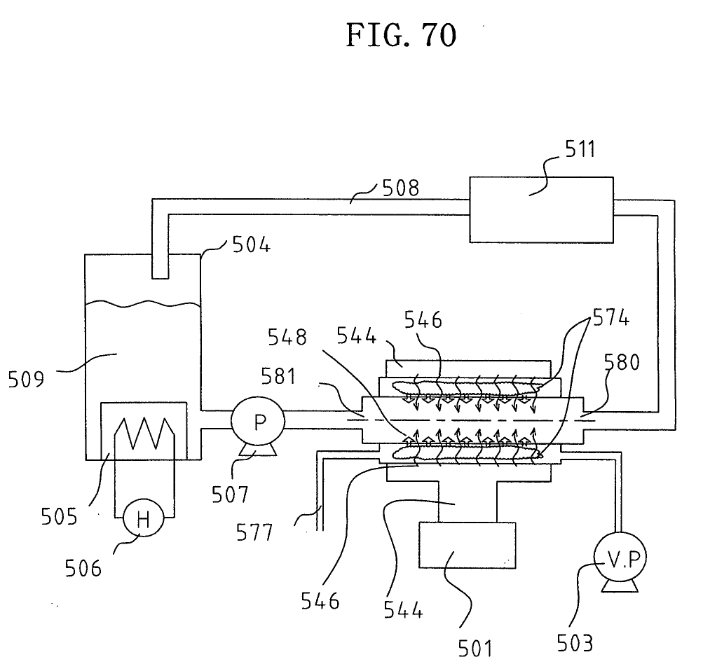

Shown in FIG. 70, an ion exchange process unit or a system of series connecting ionization apparatuses “511” can be located at the preparative or the following stage of the system of a modification of the tenth example. It can be the purpose to develop the ion exchange process or ionization at the following stage by ionizing polluted substances in the waste water with the method adopted in the present invention.

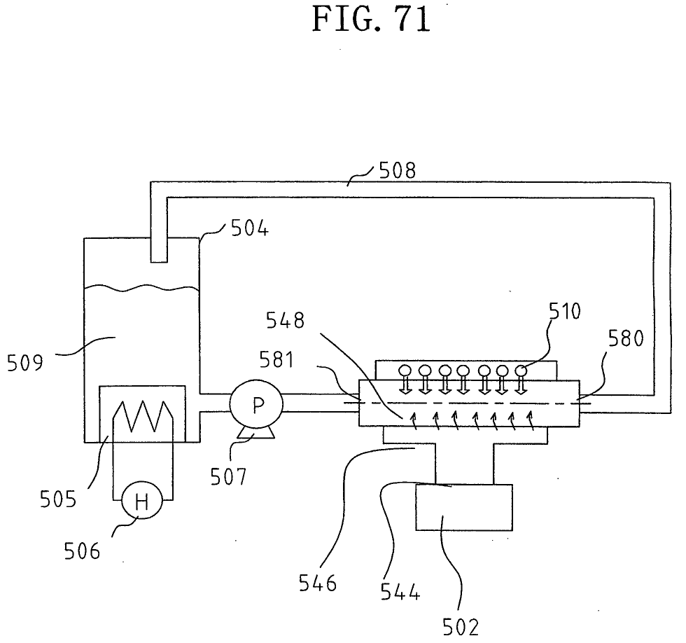

Shown in FIG. 71, a vacuum ultra violet light source can be different from a high frequency electromagnetic wave source in a modification of the eleventh example. In a structure of the processing system, a dielectric barrier discharge lump “510”, an exicimer light source, can be located so that the light could be irradiated to the waste water process container made of synthetic quartz. Then, high frequency wave between 1 kHz and 2450 MHz can be irradiated by a high frequency wave source “502”.

The present invention is related to processes, methods and systems including an operation process of a single unit in a waste water processing method, which has effects of oxidation-decomposition and sterilization and simplifies liquid-solid separation in the next process because of ionization of polluted substances. The methods and systems also includes a method to destruct, dissolve cells and develop degradation of polymers, of which a running cost is low and efficiency effects against supplied energy is high, and a processing system which is easily enlarged.

Because microwave vacuum gas plasma, which can be formed in a large region, becomes a vacuum ultraviolet ray source and also functions as medium of electromagnetic wave propagation line in the processing, the processing system is able to be downsized and have a large contacting portion on the waste water.

The polluted substances are vibrationally excited directly or with the medium of the water by electromagnetic microwaves irradiated and absorbed in the waste water processing portion. The polluted substances become more reactive. The reaction rate is able to be higher. Moreover, the ionization is developed by more intense vibrational excitation. For sludge cells, the transmission of high frequency wave causes direct excitation of solution in cells and an effect that cells are killed and expanded from inside. The transmission also spreads the netfunction of polymer that forms the cell walls and easily causes the decomposition reaction.

In the mechanism described above, polluted substances in the waste water are able to be directly decomposed by the photochemical reaction. Reactive oxygen is also generated for the dissolved oxygen and oxidation is developed. Moreover, the mechanism enables the sterilization by high energy photons for bacteria cells and the destruction of the cell walls by cutting molecular structures in the same way of organic matter decomposition. Moreover, a degradation of polymer is caused in the decomposition of a cytoplasm after the solubilization of a cytoplasm by oxidations and decomposition reactions. Hydrogen atoms isolated in the organic matter decomposition process by photochemical reaction contribute to phosphorus or nitrogen removals.

In a waste water process on a sterilization and an advanced oxidation process by oxidations and decompositions of organic matter or reducing materials, the mechanism described above causes reactions of photochemical oxidations, decompositions or sterilizations on polluted substances or bacteria cells, which are activated with vibrational excitations by energy of electromagnetic waves, by vacuum ultraviolet rays. Thus, the process becomes remarkably efficient even without a supportive advanced oxidation process.

In application to excluding toxic substances, reactions of liquid-solid separation in the polluted substances that are vibrationally excited and activated are developed in the mechanism described above. Moreover, ionizations of the sludge substances are developed by intense vibrational excitations. Thus, the waste water process is able to be efficient by adding an ion exchange process at the following stage. Moreover, hydrogen atoms isolated by the photochemical reaction process with vacuum ultraviolet rays are excited and activated by irradiation of electromagnetic waves and contribute to phosphorus or nitrogen removals. Thus the process becomes highly efficient.

In application to sludge processes and excess sludge processes, for sludge cells, the transmission of high frequency wave causes direct excitation of solution in cells and an effect that cells are killed and expanded from inside in the mechanism described above. The transmission also spreads the netfunction of polymer that forms the cell walls and easily causes the decomposition reactions. If organic matters that composes cell walls are photocatalytically decomposed by photochemical reactions with vacuum ultraviolet rays and portions of composed molecular structure in the mechanism are cut, solubilizations of cytoplasms are caused in expanded cells by the excitations with the electromagnetic waves described above and volume of the sludge is efficiently reduced in short time. Moreover, phosphorus and nitrogen removal reactions occur in the solubilized cytoplasms in the same mechanism with oxidations and decompositions of organic matters. Thus, the process becomes highly efficient without excess increases of BOD, COD, TN, TP and TOC values in the decomposition sludge reduction processes.

The waste water can be activated and the process time can be shortened to increase the efficiency if the waste water is heated from 40° C. to 70° C. in preprocess.

Moreover, the reduction effect can be intensified by injecting bubbles of hydrogen gas into the processing portion of the present invention in the process of inorganic nutrient salts such as phosphorus and nitrogen etc.

On the other hand, the process system does not have a problem on safety. The environment load is small and the energy efficiency is high in the system. The process in the system does not have a member for consumption. The running cost is able to be low in the process.

The present invention can be applied to the field of all the high frequency reaction processes and plasma processes for solid, liquid and gas for objects. It includes fields such as etching, ashing, CDV, surface treatment of semiconductor, light source, heating, sintering, composition, decomposition, washing, modification process, catalyst reaction, evaporation, sterilization and so on.

The present invention is not restricted by the examples and examples described above. It includes any modification unless being over the thought and the range clamed.

### INDUSTRIAL APPLICATION

In a high frequency reaction processing system of the present invention, an outer container is made of dielectric material. An inner container is made of dielectric material and located inside the outer container. A high frequency wave coupling portion is located on the outer surface of the outer container. A conductive covering portion covers the outer surface of the outer container except the high frequency wave coupling portion and keeps the ground potential.

Thus, many intense points of electric field are able to be generated in a reaction processing region inside the inner container, because a conductive material covers with the outer surface of the outer container except the high frequency wave coupling portion and keeps the ground potential.

Moreover, the high frequency wave coupling portion is located on the cylindrical or spherical side face. The cylindrical or spherical dielectric container is formed as a looped transmission surface of the high frequency wave. Thus, the large area of the infinitely long dielectric transmission surface is formed to travel the electromagnetic wave into the direction of the infinitely long dielectric transmission surface through the high frequency wave waveguide.

Because of formation of the infinitely long dielectric transmission surface, it is able to prevent guided high frequency wave from interfering each other and to amplify resonance in the same transmission surface by tuning the positions of the high frequency wave coupling portions. Much electric power is able to be supplied, since the method that electric power is supplied from plural high frequency wave coupling portions into the single same load, is adopted to increase electric power for supply as much as possible.

Moreover, high frequency wave spreads into the dielectric transmission surface from the waveguide. Thus a uniform and large plane of the electric field is able to be generated in the reaction processing region under the inner container, a dielectric transmission surface. The high frequency reaction processing system that can uniformly supply much electric power is able to be formed.

Moreover, in application to a plasma generating system, the character of a border plane of ionized gas plasma becomes close to the one of conductor by increasing supplied electric power to increase the electron density of the ionized gas plasma. Then the electromagnetic wave reflected in the region which is closed with a looped infinitely long dielectric transmission surface and the border planes of the ionized gas plasma. Thus it is able to increase the area, in which the electromagnetic wave travels, and generate electric field over a large area.

It is necessary to bias a voltage high enough to separate ionized gas to the termination of the circuit in order to generate plasma from non-plasma state in the plasma load portion. As a result of adopting the structure stated above, resonance circuit is formed, a high voltage is generated and it is becomes easy to trigger plasma on the side of the termination. Moreover, a stable circuit is able to be realized, since the high frequency wave coupling portion and the dielectric transmission surface are formed to be equivalent to the circuit-type matching device and the load circuit is separated away from the oscillating portion. Consequently, the structure of the circuit is durable against the reflected waves returning to the oscillator and enables to increase electric power supplied to the load.

1. A high frequency reaction processing system, comprising:
an outer container made of dielectric material, formed so that two end faces can close a cavity;
one or more high frequency wave coupling portion located at an optional position on the outer face of the outer container;
one or more inner containers made of a dielectric material and formed so that two end faces can close a cavity and located without contacting the inner face of the outer container at a position to receive a high frequency wave traveling through a high frequency wave coupling portion; and
a covering portion made of conductive material and covering the outer face of the outer container except the area covered with the high frequency wave coupling portion and keeping a potential equal to the ground potential of a high frequency waveguide,
and generating plasma in the cavity of the inner container.

2. A high frequency reaction processing system, comprising:
an outer container made of dielectric material, formed so that two end faces can close a cavity;
one or more high frequency wave coupling portion located at an optional position on the outer face of the outer container;
one or more inner containers made of a dielectric material and formed so that two end faces can close a cavity and located without contacting the inner face of the outer container at a position to receive a high frequency wave traveling through a high frequency wave coupling portion; and
a covering portion made of conductive material and covering the outer face of the outer container except the area covered with the high frequency wave coupling portion and keeping a potential equal to the ground potential of a high frequency waveguide,
and carrying out a reaction process with an electromagnetic wave guided through the high frequency wave coupling portion in the cavity of the inner container.

3. A high frequency reaction processing system according to claim 1, wherein the shape of the outer container or the inner container is ellipse column or oval
and the distance between the outer face of the outer container and the inner face of the inner container is constant.

4. A high frequency reaction processing system according to claim 1, wherein the distance between the outer face of the outer container and the inner face of the inner container is integer times ¼ of the wavelength of a guided high frequency wave.

5. A high frequency reaction processing system according to claim 1, wherein the length of the outer side face outline of the outer container is integer times ¼ of the wavelength of a guided high frequency wave.

6. A high frequency reaction processing system according to claim 1, wherein the length of the axis connecting the both end faces of the outer container is integer times ¼ of wavelength of a guided high frequency wave.

7. A high frequency reaction processing system according to claim 1, wherein cooling medium with a low dielectric constant continuously flows in a region between the outer container and the inner container.

8. A high frequency reaction processing system according to claim 1, wherein the inner side face of the outer container or the outer side face of the inner container is formed uneven-shaped.

9. A high frequency reaction processing system according to claim 1, wherein high frequency waves are guided through plural high frequency wave coupling portions and a wavelength of a specified high frequency wave is same as or integer times ¼ of the wavelength of the other guided high frequency waves.

10. A high frequency reaction processing system according to claim 1, wherein the outer container is composed of plural dielectric layers with different dielectric constants.

11. A high frequency reaction processing system according to claim 10, wherein a dielectric layer of the outer container is composed of a molded member or a multilayer member including mica.

12. A high frequency reaction processing system according to claim 1, wherein a magnetic field is traversed with an electric field of a high frequency wave and along an axis connecting the both end faces of the outer container or the inner container

13. A high frequency reaction processing system according to claim 1, wherein the inner containers comprise the first inner container located in the outer container without contacting the inner side face of the outer container and the second inner container located in the first inner container without contacting the inner side face of the first inner container, and the first inner container or the second inner container is made of dielectric material transmissive for ultraviolet rays.

14. A high frequency reaction processing system according to claim 1, wherein the inner containers comprise the first inner container located in the outer container without contacting the inner side face of the outer container and the second inner container located in the first inner container without contacting the inner side face of the first inner container, and ports for passage of process medium are located on end faces of the outer container on a region between the outer container and the first inner container.

15. A high frequency reaction processing system according to claim 1, wherein ports for passage of process medium are located on end faces of the inner container.

16. A high frequency reaction processing system according to claim 1, wherein porous ceramics material or catalyst material for decomposition or alteration process is located in the cavity of the inner container.

17. A high frequency reaction processing system according to claim 1, wherein a reaction process of liquid or solid is carried out in the cavity of the inner container by an electromagnetic wave guided through the high frequency wave coupling portion.

18. A high frequency reaction processing system according to claim 1, wherein a photochemical reaction process with vacuum ultraviolet rays generated in the high frequency wave ionized gas plasma or a process using exitation phenomenon by irradiation of a high frequency electromagnetic wave is carried out for the liquid or gas.

19. A high frequency reaction processing system according to claim 2, wherein the shape of the outer container or the inner container is ellipse column or oval
and the distance between the outer face of the outer container and the inner face of the inner container is constant.

20. A high frequency reaction processing system according to claim 2, wherein the distance between the outer face of the outer container and the inner face of the inner container is integer times ¼ of the wavelength of a guided high frequency wave.

21. A high frequency reaction processing system according to claim 2, wherein the length of the outer side face outline of the outer container is integer times ¼ of the wavelength of a guided high frequency wave.

22. A high frequency reaction processing system according to claim 2, wherein the length of the axis connecting the both end faces of the outer container is integer times ¼ of wavelength of a guided high frequency wave.

23. A high frequency reaction processing system according to claim 2, wherein cooling medium with a low dielectric constant continuously flows in a region between the outer container and the inner container.

24. A high frequency reaction processing system according to claim 2, wherein the inner side face of the outer container or the outer side face of the inner container is formed uneven-shaped.

25. A high frequency reaction processing system according to claim 2, wherein high frequency waves are guided through plural high frequency wave coupling portions and a wavelength of a specified high frequency wave is same as or integer times ¼ of the wavelength of the other guided high frequency waves.

26. A high frequency reaction processing system according to claim 2, wherein the outer container is composed of plural dielectric layers with different dielectric constants.

27. A high frequency reaction processing system according to claim 26, wherein a dielectric layer of the outer container is composed of a molded member or a multilayer member including mica.

28. A high frequency reaction processing system according to claim 2, wherein a magnetic field is traversed with an electric field of a high frequency wave and along an axis connecting the both end faces of the outer container or the inner container

29. A high frequency reaction processing system according to claim 2, wherein the inner containers comprise the first inner container located in the outer container without contacting the inner side face of the outer container and the second inner container located in the first inner container without contacting the inner side face of the first inner container, and the first inner container or the second inner container is made of dielectric material transmissive for ultraviolet rays.

30. A high frequency reaction processing system according to claim 2, wherein the inner containers comprise the first inner container located in the outer container without contacting the inner side face of the outer container and the second inner container located in the first inner container without contacting the inner side face of the first inner container, and ports for passage of process medium are located on end faces of the outer container on a region between the outer container and the first inner container.

31. A high frequency reaction processing system according to claim 2, wherein ports for passage of process medium are located on end faces of the inner container.

32. A high frequency reaction processing system according to claim 2, wherein porous ceramics material or catalyst material for decomposition or alteration process is located in the cavity of the inner container.

33. A high frequency reaction processing system according to claim 2, wherein a reaction process of liquid or solid is carried out in the cavity of the inner container by an electromagnetic wave guided through the high frequency wave coupling portion.

34. A high frequency reaction processing system according to claim 2, wherein a photochemical reaction process with vacuum ultraviolet rays generated in the high frequency wave ionized gas plasma or a process using exitation phenomenon by irradiation of a high frequency electromagnetic wave is carried out for the liquid or gas.
